(19) United States
(12) Patent Application Publication
(10) Pub. No.: US 2020/0349306 A1
(43) Pub. Date: Nov. 5, 2020

(54) General Scattered Field Simulator

(71) Applicants: Oscar Pablo Bruno, Pasadena, CA (US); Emmanuel Garza González, Studio City, CA (US)

(72) Inventors: Oscar Pablo Bruno, Pasadena, CA (US); Emmanuel Garza González, Studio City, CA (US)

(21) Appl. No.: 16/502,211

(22) Filed: Jul. 3, 2019

Related U.S. Application Data
(60) Provisional application No. 62/735,566, filed on Sep. 24, 2018.

(51) Int. Cl. G06F 30/23; G06F 30/10; G06T 17/20

(52) U.S. Cl. CPC G06F 30/23; G06F 2111/20; G06T 17/205; G06F 30/10

(57) ABSTRACT

A general field simulator for generating scattered fields arising from an incident field interacting with a physical body. A general field simulator generates a patch data structure from a logical representation of a physical object, generates an approximation mesh, deforms the approximation mesh to generate approximators associated with a target point, and generates a surface field component based on approximators and a guess density. A general field simulator may generate an edge deformed mesh based on an edge deformation change of variables when a patch includes an edge.

### CROSS-REFERENCE TO RELATED APPLICATIONS

This application claims priority to U.S. Provisional Patent Application No. 62/735,566, filed Sep. 24, 2018, entitled “General-Geometry Rectangular-Polar Scattering Solver.” which is incorporated herein by reference in its entirety.

### GOVERNMENT FUNDING

This invention was made with government support under through contracts DMS-1411876 and FA9550-15-1-0043 and HR00111720035 awarded by NSF, AFOSR, and DARPA, and under contract number N00014-16-1-2808 awarded by the NSSEFF Vannevar Bush Fellowship. The government has certain rights in the invention.

### FIELD

This disclosure is generally related to physical system simulation and more particularly to tools for modeling, measuring, or predicting the behavior of physical phenomena and physical systems.

### BACKGROUND

Modern design tools, like computer aided design systems, physical simulators, electronic simulators, electromagnetic simulators, acoustic simulators, and modern measurement tools, like imaging systems, radar systems, surveying tools, tomography systems, guidance systems, or SCADA systems, require a high degree of accuracy to support critical decisions making. In many systems, achieving a high degree of accuracy can be cost prohibitive within the context of an application. For example, if a physical simulation device is capable of obtaining a requisite degree of accuracy, but only by monopolizing a processing machine for long periods of time, it may be impracticable for a designer to make use of it. Or if decision making machines downstream from a physical system simulator must make decisions quickly, it would be impracticable to base such decision on the output of such a physical simulation device if it requires an extend period of time to complete a requisite simulation for creating the output to the downstream system. Thus, how a general purpose computer is configured to model, measure, or predict the behavior of physical phenomena determines how useful the resulting specific machine is for modelling, measuring, or predicting that physical phenomena within a given application.

### BRIEF DESCRIPTION OF THE DRAWINGS

FIG. 1 illustrates a source of an incident and a scattered field.

FIG. 2 illustrates approximation methods.

FIG. 3 illustrates a simulated field.

FIG. 4 illustrates simulated scattered fields and total fields in accordance with this disclosure.

FIG. 5 illustrates embodiments of a system including a field simulator in accordance with this disclosure.

FIG. 6 illustrates aspects of a process in accordance with this disclosure.

FIG. 7a illustrates a field simulator in accordance with this disclosure.

FIG. 7b illustrates a field simulator in accordance with this disclosure.

FIG. 7c illustrates a field simulator in accordance with this disclosure.

FIG. 7d illustrates a field simulator in accordance with this disclosure.

FIG. 8 illustrates a system in accordance with this disclosure.

FIG. 9 illustrates aspects of simulator results in accordance with this disclosure.

FIG. 10 illustrates aspects of a field simulator in accordance with this disclosure.

FIG. 11 illustrates aspects of a process in accordance with this disclosure.

FIG. 12 illustrates aspects of a process in accordance with this disclosure.

FIG. 13 illustrates aspects of surface patches in accordance with this disclosure.

FIG. 14 illustrates aspects of an approximation mesh in accordance with this disclosure.

FIG. 15a illustrates aspects of a process in accordance with this disclosure.

FIG. 15b illustrates embodiments of an edge change of variables for an edge deformation in accordance with this disclosure.

FIG. 16 illustrates aspects of a process in accordance with this disclosure.

FIG. 17 illustrates aspects of a field simulator in accordance with this disclosure.

FIG. 18 illustrates aspects of a process in accordance with this disclosure.

FIG. 19 illustrates aspects of an approximation mesh and a target point in accordance with this disclosure.

FIG. 20 illustrates aspects of a self-patch deformation change of variables for performing mesh deformation about a target node in accordance with this disclosure.

FIG. 21 illustrates aspects of a process in accordance with this disclosure.

FIG. 22 illustrates aspects of near patches in accordance with this disclosure.

FIG. 23 illustrates a proximity tolerance in accordance with this disclosure.

FIG. 24 illustrates aspects of a near-patch deformation change of variables for performing mesh deformation about a projection node in accordance with this disclosure.

FIG. 25 illustrates aspects of a process in accordance with this disclosure.

FIG. 26a illustrates aspects of a process in accordance with this disclosure.

FIG. 26b illustrates aspects of a process in accordance with this disclosure.

FIG. 27 illustrates aspects of a process in accordance with this disclosure.

FIG. 28 illustrates aspects of a process in accordance with this disclosure.

FIG. 29a illustrates aspects of a process in accordance with this disclosure.

FIG. 29b illustrates aspects of a process in accordance with this disclosure.

FIG. 30a illustrates aspects of a process in accordance with this disclosure.

FIG. 30b illustrates aspects of a process in accordance with this disclosure.

FIG. 31 illustrates aspects of a process in accordance with this disclosure.

FIG. 32 illustrates aspects of a process in accordance with this disclosure.

FIG. 33 illustrates aspects of a data structure in accordance with this disclosure.

FIG. 34 illustrates aspects of a data structure in accordance with this disclosure.

FIG. 35 illustrates aspects of a data structure in accordance with this disclosure.

FIG. 36 illustrates generated fields in accordance with this disclosure.

FIG. 37 illustrates generated fields in accordance with this disclosure.

FIG. 38 illustrates generated fields in accordance with this disclosure.

FIG. 39 illustrates generated fields in accordance with this disclosure.

FIG. 40 illustrates generated fields in accordance with this disclosure.

FIG. 41 illustrates comparative simulation results.

FIG. 42 illustrates comparative simulation results.

FIG. 43 illustrates comparative simulation results.

FIG. 44 illustrates simulation performance plots.

FIG. 45 illustrates simulation performance plots.

FIG. 46 illustrates simulation performance plots.

FIG. 47 illustrates simulation performance plots.

FIG. 48 illustrates aspects of a field simulation in accordance with this disclosure.

FIG. 49 illustrates aspects of a field simulation in accordance with this disclosure.

FIG. 50a illustrates a computing environment in accordance with this disclosure.

FIG. 50b illustrates a computing environment in accordance with this disclosure.

### DETAILED DESCRIPTION

Disclosed are one or more embodiments that incorporate features of this invention. The disclosed embodiment(s) merely exemplify the invention. The scope of the invention is not limited to the disclosed embodiments. Rather, the invention is defined by the claims hereto.

A particular problem arises in simulating the physical response of an incident wave when it strikes a physical body. In general, when an incident wave strikes a body it is scattered. How the wave is scattered is a function of the shape of the object and its material, among other things. In a simplest case, a wave is a plane wave. But in practice, what is experienced by physical bodies is a field that exists as the superposition of many waves originating from many sources and scattering off many bodies, or off of many portions of a single scattering body, or off of many portions of many scattering bodies.

In the presence of an incident field a scattering body scatters the incident field creating a scattered field. The resulting total field is a superposition of both the incident field and the scattered field. In the presence of multiple scattering bodies, or a scattering body with multiple scattering surfaces, the total field is the superposition of the incident field and all of the incident field and the scattered fields arising from each scattering surface of each scattering body. Further complicating matters, there is rarely a single source of an incident field. An incident field often arises from multiple sources, or sources, such that the total field is the superposition of each incident field from each source with the scattered field of each scattering surface of each scattering object. This is true in the case of electromagnetics (EM), acoustics, elastics, and electrostatics, to name some non-limiting examples.

While EM fields, acoustic fields, elastic fields, electrostatic fields are distinct phenomena, each field shares common features that allow their simulation in accordance with this disclosure according to common techniques with only minor changes as explained herein or as will be appreciated.

As a general matter, waves and fields play a central role in present-day technology—and they provide the basis for an extremely wide range of technical domains. For example, in the case of electromagnetic waves (EM waves), applications dependent on EM wave fields include wireless communications, remote sensing, remote control, remote identification, proximity detection. In one example, a driverless car may rely on EM waves to facilitate driverless navigation in multiple aspects including detecting the proximity to obstacles or pedestrians, communicating with remote location services, remote sensing of markers and the environment, and remote identification of objects.

EM waves were first introduced for public use in the form of radio waves. Radio waves are invisible to the eye, yet they can transport information, e.g., information configured to represent sound, including voice, music, data, etc., over very long distances and with extremely high quality. Using radio waves not only provide news in the morning, but also communications with, and instructions to, spacecraft in space or on other planets. Instructions may be provided to satellites in earth orbit or to spacecraft on route to other planets. RF engineers may configure satellites to retransmit information to various points on earth using radio waves, thereby avoiding the barrier arising from the Earth's curvature. This then enables wireless communication between any two points on earth. These are but a few select examples of the use of EM waves, which vastly exceeds radio technology. The spectrum of applications of electromagnetism is wide and includes varied exemplary technologies such as microscopy, laser technology, medical imaging, microwave ovens, radar, optics and television. The use of EM waves itself is a subset of the many applications of technologies associated with fields, e.g. acoustic waves, elastic waves, electrostatic fields, and the like.

Like waves on the surface of a pond, EM waves move in space and are able, upon their travel, to create a disturbance at a distance from the source that originates the wave. Consider the simple situation in which water waves are created on the surface of a pond by throwing a rock into the water. The resulting waves travel away from the rock-water contact point—and they therefore give rise to motion in regions away from the contact point. Water waves are embodied in the water motion: as the wave travels on the water surface, water moves up and down, and it is the sequence of up and down movements of water that actually is the wave. The water itself does not travel from the contact-point towards the edge. It is the wave that travels-by propagating its upward-downward motion from the contact point towards the water edge. In a similar fashion, acoustic waves are travelling variations in pressure traveling through a medium (e.g., air). Acoustic waves arise from and also give rise to motion, as is readily seen when a low pitch bass sound arises from a vibrating speaker element to rattle a window at a distance.

EM waves are analogous to water waves and acoustic waves in some ways, but they also differ in other ways. EM waves also travel and can give rise to motions away from the source. Unlike water waves, however, EM waves cannot be equated with the motion of either water or any other fluid or solid material. EM waves are waves in space—and they can therefore travel in vacuum. EM waves can penetrate certain types of materials but not others. For example, EM waves can traverse glass (e.g., light is visible across glass) as well as many types of “dielectric” materials. But EM waves cannot penetrate a metallic enclosure, and they can be significantly distorted by structures that contain large amounts of metal, such as buildings or bridges.

EM waves are essential elements in science, technology, and engineering. In fact, EM waves include light we see, X-rays that are used in medical practice, radio waves that enable wireless communications, infrared signals emitted by stars. EM waves also give rise to technological problems, e.g., ultraviolet radiation is both responsible for the creation of vitamin D in our bodies and for burning our skin. Additionally, generation and transmission of electricity is negotiated by EM waves, and currents that are conducted, for example, via overhead power lines supported by series of steel lattice towers. Management of this transmission of energy by electrical engineers powers homes, but if improperly managed these same EM waves may be harmful to humans or may interfere with other technologies.

EM waves permeate the environment and underlie technologies people use every day. In all cases, the functional principle is the same: electrical currents (that is, motion of charged particles), induce EM fields: the presence of an electrical current creates an EM field in the surrounding space, which may remain detectable up to very large distances from the source and may induce physical phenomenon in both near and far distances.

The reverse is often also true: EM fields induce electrical currents in materials. Since EM waves travel through space in a manner akin to the propagation of water-waves in a pond, EM signals can be used to encode and transmit information. In communications, for example, a structure (e.g., an antenna) as simple as a few metallic rods attached by means of a few pieces of insulating material can be designed to support electrical currents, which generate EM waves that can be detected by a similarly shaped antennas and made, thus, to receive information from distant sources. This same system that supports communications at a distance, however, may also create interference for other technologies that rely on EM waves, e.g. remote detectors or wireless communicators.

Thus, techniques managing propagation of EM waves give rise to significant technological industries. These industries rely heavily upon simulators for understanding and predicting physical phenomenon arising from EM wave scattering. For example, there are many commercial field simulators on the market, marketed by an equally many technology companies. For example, Mentor Graphics markets IE3D and Fidelity; National Instruments markets Analyst, Axiem, EM Socket, Microwave Office; Keysight markets ADS and EMPro, Altair markets FEKO, Ansys markets Savant and HFSS, Dassault Systemes markets Studio Suite; Cadence markts Allegro Sigrity; COMSOL markets Multiphysics; Faustus Scientific markets MEFiSTo; IMST markets Empire XCcel 3D; Mician markets uWave Wizard; MiG markets WASP-NET; Remcom markets XFdtd; Sonnet markets Blink; Tech-x markets VSim and Vorpal; and WIPL-D. These products are marketed into a number of advanced technology industries providing technological solutions to the technological problem of managing scattered fields by simulation. These industries include aerospace, telecommunications, government laboratories, IoT companies, RFID, military, medical, power, optics, photonics, and EM compatibility applications. For example, rockets, aircraft, and spacecraft may contain tens or hundreds of antennas that may be transmitting and receiving simultaneously. If the impact of these transmissions is not well understood costly redesigns may be necessary, or sensitive equipment may be rendered useless. In a similar fashion, many industries rely on simulations of other field-based phenomena, such as acoustic applications, elastic applications, and electrostatic applications.

Despite substantial industry efforts, field engineering (e.g., EM, acoustic, electrostatic, elastic field engineering) known simulators remain inaccurate. Absent accurate simulation, costly errors arise. In one publicized example, a CV-ITT aircraft received upgraded SIRFC antennas, but when installed in the location of the previous antennas, the new antennas experienced interference caused by scattering off of a tail structure of the aircraft. This sort of error has long been unavoidable, because known techniques for modeling and simulating EM fields scattering from complicated geometries are both expensive and inaccurate. With an accurate simulator, these sorts of costly errors may be avoided.

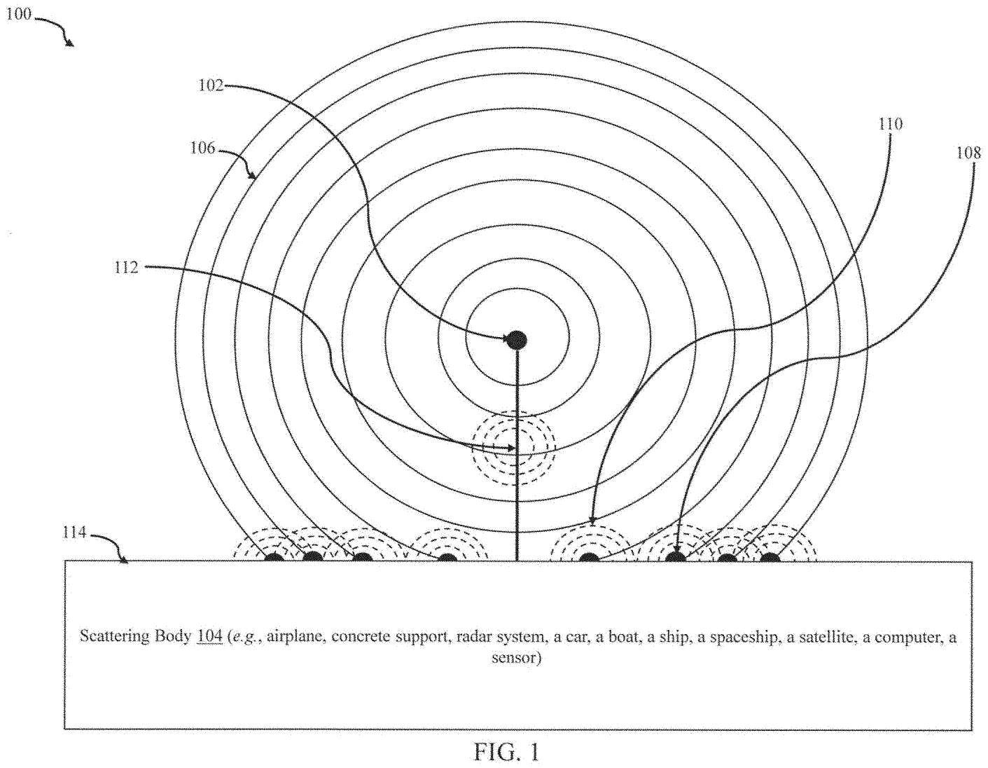

Aspects of a field are illustrated in FIG. 1. An incident field 106 extends from an exemplary source 102 and scatters off of scattering body 104. An incident field, e.g., 106 in reality is continuous over all space, including at the surface 114 of the scattering body 104. Nevertheless, accurate models of a scattered field, e.g. 110, may be realized by treating a surface as a finite set of points and treating each finite set of points as a point source 108. A total field then is obtained as the superposition of the scattered field 110 and the incident field 106. Additional scattering objects, e.g., a structure 112 supporting the source 102, however, will distort the incident field around them as well further scattering the incident field.

Thus, a solution to the total field becomes increasingly complicated as the geometries of scattering objects become increasingly complex. In various embodiments, a source may be, in the EM case, an antenna, or in the acoustic case, a speaker or horn or a sonar emitter. One will appreciate the many sort of field sources that arise in various technological fields.

Known field simulators fail to provide sufficient accuracy and generality. In an EM antenna example, design of an antenna in isolation may be effectively handled by previously available software, but a significant problem arises as the antenna is “mounted” on another structure: a car, a boat, an aircraft, a spacecraft, etc. For example, it is well known that the presence of a large metallic structure, or a bridge or building, or the like, can garble the radio signal reception and result in undesired noise or distortion of the transmitted voice, music, etc. Similarly, as an antenna is mounted on a structure, the structure itself becomes part of the electromagnetic problem, as the electromagnetic waves transmitted or received by the antenna bounce off or penetrate the structure, as dictated by the properties of the materials that make up the structure, this bouncing, or scattering, distorts the antenna's transmitted wave.

Problems of field propagation and scattering concerning devices mounted on structures are significantly more complex and challenging than when treating such a device alone, in the absence of interference. Thus, known simulators require very detailed mathematical descriptions, requiring very large amounts of computer memory and require significant time periods even to obtain inaccurate results. Known solutions are also not robust, because they are incapable of handling all scattering situations in a uniformly fast and accurate manner, often requiring ad hoc solutions for many conditions. Known solutions are not fast, because they are computationally taxing and not optimized for solution using modern computational systems, like multi-core parallel processors or GPUS. This is in part because they are not robust, and require handling of different models for different situations. And known solutions are not able to achieve highly accurate solutions from which confident decisions can be made, whether it be by a human (e.g., a design engineer designing a wing, a physician analyzing tomographic survey, an oil well engineer evaluating the corrosion in a well bore, or a surveyor analyzing a reconstruction of subsurface material) or a decision making system (e.g., a design tolerance evaluator, a current simulator, a vibrational simulator, a radar system, a guidance system, an image reconstruction system, or an image analysis system).

The techniques disclosed herein provide users, e.g., engineers, scientists, and industry, with a robust, scalable capability of unmatched accuracy, efficiency, and ease of use for simulation of scenarios including fields scattering off physical object. In accordance with the present techniques, all surfaces may be treated in a same manner, using a single uniform solution that is readily parallelized for use in parallel, distributed, and GPU computing devices. Also, the techniques disclosed herein are readily compatible with accelerators including those disclosed in O. P. Bruno and L. A. Kunyansky, A Fast, High-Order Algorithm for the Solution of Surface Scattering Problems: Basic Implementation, Tests, and Applications. Journal of Computational Physics, 169(1):80-110, may 2001.

Known simulation devices employ techniques that rely on volumetric solvers for computing solutions to scattering problems in order to model physical phenomena. This approach often relies on a finite element representation of a physical object. Achieving a useful degree of accuracy employing volumetric solvers, however, becomes intractable in medium to high frequency problems, because modern computer systems lack sufficient memory or sufficient computational power to perform these techniques in a manner that obtains sufficient accuracy within the time requirements of applications. This problem arising in volumetric solvers becomes compounded as a ratio of a volume to surface scattering becomes very large.

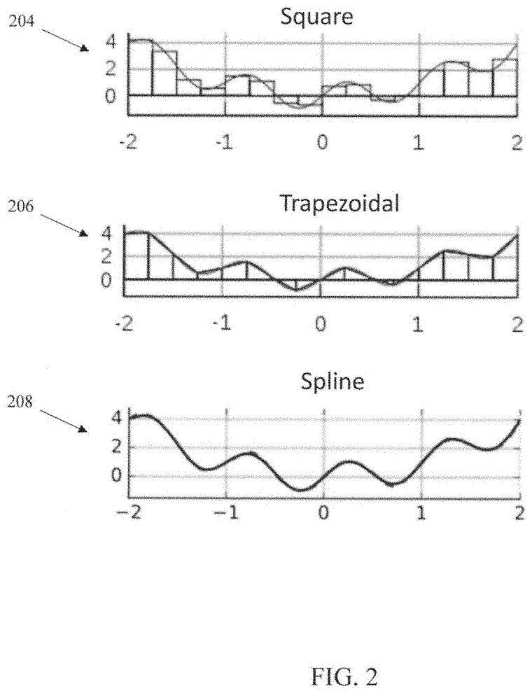

FIG. 2 illustrates a necessary tradeoff in volumetric or other known approaches, that is speed is achieved primarily by reducing accuracy, but achieving requisite accuracy is often too costly. FIG. 2 illustrates a square approximation technique 204 which may be both simple and fast, but provides inaccurate results. Slightly better accuracy is achieved using a more refined trapezoidal approximation 206, yet this technique requires longer processing times and accuracy remains low. A spline approximation 208 provides much better accuracy, but can be highly complicated and highly costly. Various other technologies provide highly improved accuracy even over spline-like methods in a range of speeds. Embodiments in accordance with this disclosure are able to achieve much higher accuracy than any known technologies, at speeds faster than tools employing square approximation techniques.

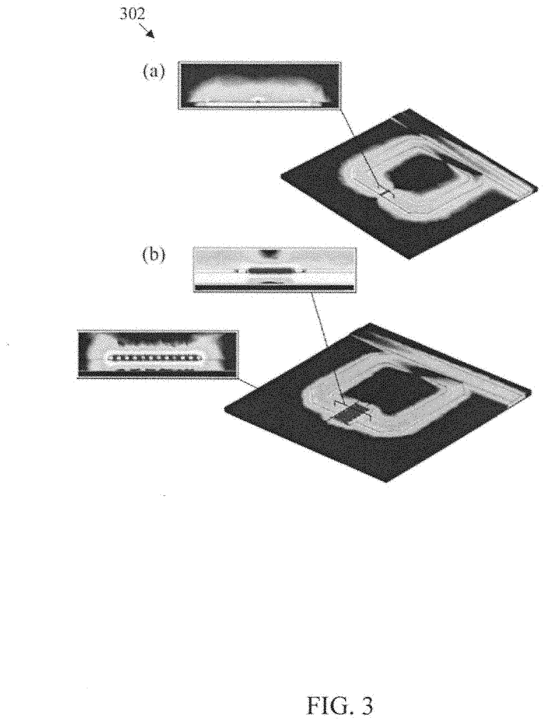

Importantly, known simulators performing volumetric approximations are immediately impacted in terms of time, cost, and accuracy by the need to generate an approximation of the physical body itself. For example, a finite element approach used in many volumetric problems approximates a physical body, or a surface, as a set of discrete elements that together make up a whole. But in this process substantial information about the object, or surface, is immediately lost. FIG. 3 illustrates field simulations using known simulators. Illustration 302 shows a representation (as it may be displayed to a user via a user interface, such as a display) of an EM field around a patch antenna generated using a leading field simulator.

Simulators in accordance with the present disclosure improve over known simulators by operating directly on accurate representation of physical objects. For example, simulators in accordance with this disclosure are able to operate directly on computer aided design (CAD) data, rather than first necessitating generating approximations of a CAD design. A CAD data structure (e.g., 514), which may be a file, includes accurate surface data describing a physical objects surface over the entire surface, rather than an approximation of that surface. Embodiments of simulators in accordance with this disclosure, differently, operate directly on CAD surface data without approximations.

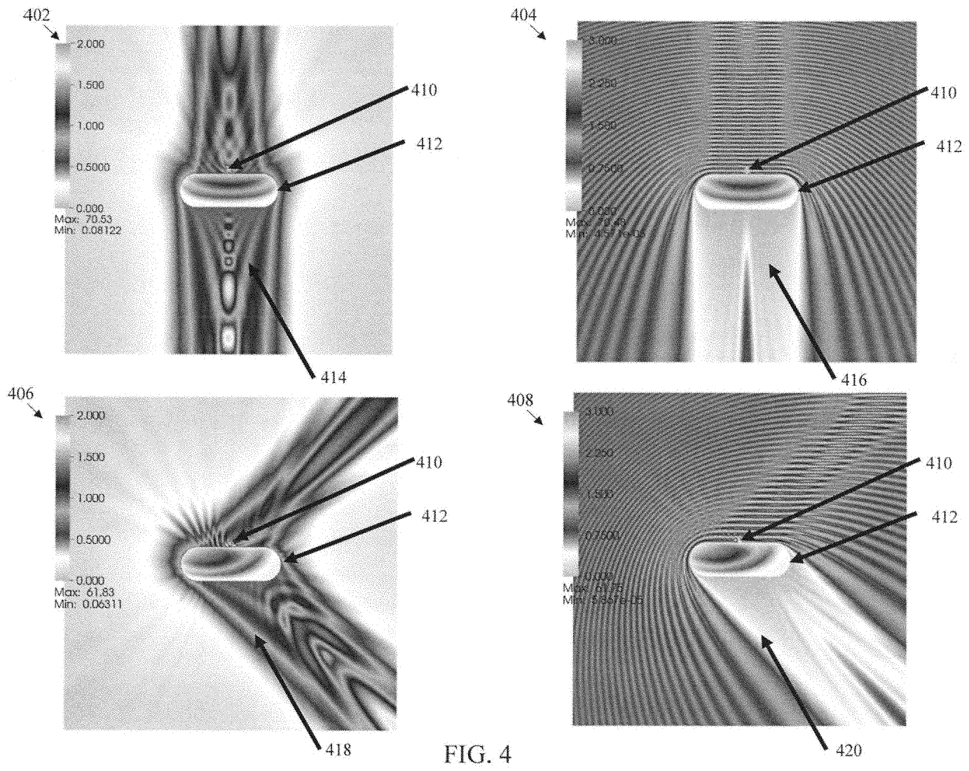

By comparison with the fields illustrated in FIG. 3, FIG. 4 illustrates aspects of an EM field simulated in accordance with the present disclosure. Illustration 402 shows a scattered field 414 arising from an incident field as it is scattered by a sphere 410 and a wheel shaped object 412. A total field 416, shown in illustration 404, is illustrated as a superposition of the incident field and scattered field 414. Each of sphere 410 and object 412 are scattering objects. Illustration 406 shows a scattered field 418 arising from a second incident field as it is scattered by sphere 410 an wheel shaped object 412. In this case the source of the incident field has shifted. A total field 420 is illustrated, in 408, as a superposition of the incident field and scattered field 418. The detail and accuracy afforded by simulators in accordance with the present disclosure is far greater than any previously known simulators and, as explained further below, obtained far faster using far less computational resources.

An alternative to volumetric solver devices is a device configured to solve scattering problems based on boundary integral representations. Such a device is configured to perform a methodology for solving boundary integral equation (BIE), in other words such a device comprises a BIE solver. In contrast with numerical methods employed by volumetric solvers, a quantitative simulator directly generates simulations of physical behavior by employing techniques for obtaining solutions in accordance with physics equations that accurately describe physical behavior.

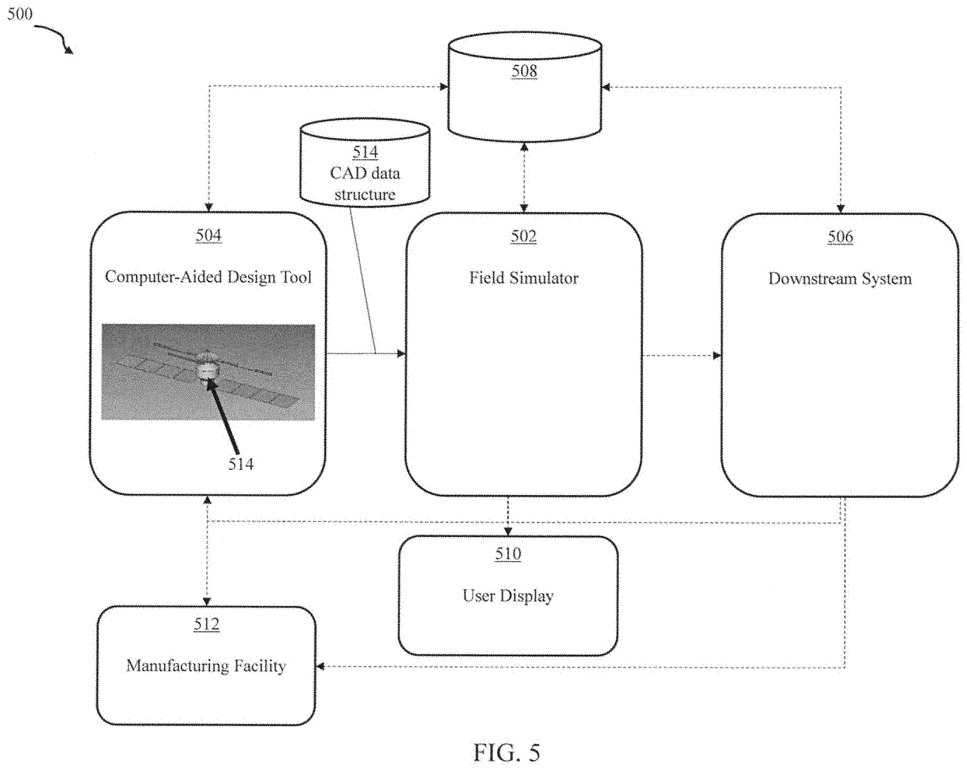

FIG. 5 illustrates aspects of a system in accordance with this disclosure. A system 500 relies on a field simulator 502 in accordance with this disclosure. An engineer designing a physical object 514, such as a satellite, defines the physical object using a computer aided design tool 504. This design tool accurately describes the physical object, includes all of its surfaces. Such a physical object may include one or more sources, e.g., EM sources. In a case of satellite technology, such a physical object may include tens or hundreds or EM sources (e.g., antennas) as well as equally many sensitive EM components, such as receivers and detectors of various sorts. As will be appreciated, functionality of such a technology depends heavily on proper placement and design of such EM sources in spatial relationship with each other and with the many other EM sensitive components disposed on its surface. To understand the impact of EM source placement, engineers necessarily must use computational simulators to have an understanding of how EM will propagate around a physical object. It is often the case that new EM sources may be introduced to an environment that includes sensitive EM components (like a satellite); again, to understand how such a new EM source will impact existing EM components it is necessary to simulate a total field within such an environment when such a new EM source is introduced. This, again, necessarily requires computational simulators to simulate such a total field.

Thus, a CAD design tool 504 generates a design of a physical object 514 that will be built, or will be modified, through various engineering and manufacturing processes, and passes a resulting CAD data structure 514 to field simulator 502, which generates an accurate total field simulation of fields scattered by such a physical object 514. Generating such a total field necessarily requires generating a scattering field in accordance with this disclosure. A field simulator 502 may be integrated directly with a CAD tool 504 or it may be a standalone tool 502. A CAD tool 504 may send a CAD data structure 514 directly to a field simulator 502, or it may first store a CAD data structure in a memory 508, where is then retrieved or accessed by field simulator 502. A CAD tool 504 may alternatively pass filed simulator 502 a reference to a CA) data structure, which may be stored in memory, e.g., memory 508. Memory 508 may be a transitory memory structure, e.g., RAM, or memory 508 may be a non-transitory data store such as a hard drive. In either case memory 508 may be a shared by many processes, including CA) tool 504 and field simulator 502, or it may be a distributed memory. Once field simulator 502 generates a total field including a scattered field, an illustrative representation of such a field may be displayed to a user on a user display 510 for observation. Alternatively, such fields may be provided or accessed by a downstream system, which may include further simulations, e.g., simulating an impact of such generated fields on electric circuits using an electric circuit simulator. One will appreciate that the technological application of accurate fields generated by a general simulator 502 are many and varied. In any case, once generated a scattered field, or subsequent downstream simulators or systems 506 may lead to redesign of a CAD design of a physical object 514, e.g., to obtain better placement of, e.g, one or more antennas, receivers, or other sensitive components. Once physical object 514 is redesigned, a subsequent simulation may be generated by simulator 502 to confirm such placement obtains a desired field. Ultimately, these processes feed into a manufacturing process in a manufacturing facility 512 for manufacturing or modifying a physical object represented by a CAD design 514 of such a physical object.

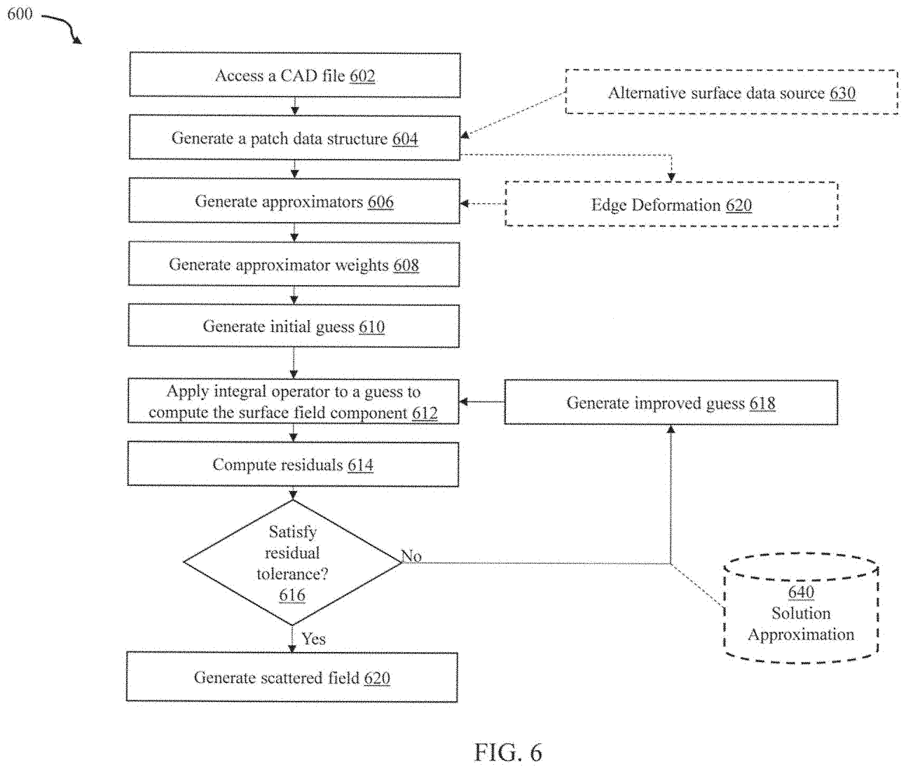

FIG. 6 illustrates one exemplary process 600 in accordance with this disclosure. For exemplary purposes, this process is discussed in a context of acoustic waves. It will be appreciated by one having skill in the art upon reading this disclosure that this process is generally applicable to many field simulators. Also, while exemplary process 600 is explained as a fixed number of individual steps, one of skill in the art will appreciate upon reading this disclosure that aspects of process 600 may occur in a variety of orders. One will also appreciate upon reading this disclosure that, while expressed in terms of equations, embodiments of this invention are embodied in computer readable instructions which when executed by one or more processors cause one or more processor to perform a series of interrelated operations in accordance with relationships expressed in the terms set forth herein.

An exemplary process 600 proceeds in accordance with the following principles. For a physical object, e.g., 514, identified by D in three-dimensional space, a surface, Γ, of the object is a scatting surface. A total field U is a superposition of a scattered field, U^{scat}, and an incident field, U^{inc}, such that a total field is a superposition of a scattered field and an incident field, i.e., U=U^{scat}+U^{inc}. This physical relationship between an object, an incident field, and a scattered field is a physical phenomena that obeys this relationship:

ΔU(r)+k²U(r)=0,r∈ [symbol] ³\Γ̅

(i.e., the Hemholtz equation) with k being a wavenumber, such that k=2π/λ. And U^{scat} satisfies the Sommerfeld radiation condition and a physical boundary condition:

U^{scat}(r)=−U^{inc}(r), where r∈Γ,

in other words, for any point r on a surface of any physical object, a scattered field at that point is equal to a negative of an incident field observed at that point r, i.e., an observation point. When provided with information, in accordance with this disclosure, about a physical object, an incident field, and certain parameters, a computer processor configured in accordance with this disclosure is able to automatically predict and model behavior of a scattered field away from a surface, e.g., both near and far from a scattering object surface.

U^{scat}(r) may be accurately represented in terms of layer potentials, and by doing so U^{scat} may be generated using techniques in accordance with principles associated with boundary integral equations having singular kernels. A single-layer and a double-layer potential respectively accords a relationship the following form:

$$ℱ [ \tilde{ϕ} ] ( r ) = {\int }_{Γ} G ( r , {r}^{′} ) \tilde{ϕ} ( {r}^{′} ) d σ ( {r}^{′} ) , r ∈ {ℝ}^{3} \backslash \overline{Γ} , \\ 𝒟 [ \tilde{ϕ} ] ( r ) = {\int }_{Γ} \frac{\partial G ( r , {r}^{′} )}{\partial n ( {r}^{′} )} \tilde{ϕ} ( {r}^{′} ) d σ ( {r}^{′} ) , r ∈ {ℝ}^{3} \backslash \overline{Γ} ,$$

where G(r,r′)=exp(ik|r−r′|)/(4π|r−r′|) is a free space Green function of the Hemholtz equation, n is an outwards-pointing normal vector, and \tilde{φ}(r′) is a surface density at r′, a point on a surface away from an observation point. As will be appreciated a Green function may describe a field arising at an infinitely small point source. As used herein r is an observation point or target point on a surface Γ. Relying on the principles above, in embodiments a scattered field at a surface, e.g. a surface Γ, may be simulated in accordance with the following relationships, expressed in mathematical terms as indicated in what follows.
For a closed surface a scattered field at a surface may be logically represented in a manner that satisfies a relationship of the following form:

U^{scat}(r)= [symbol] [\tilde{φ}](r)−ik [symbol] [\tilde{φ}](r),r∈ [symbol] ³\Γ̅,

provided that a relationship at a scattering surface may be expressed in the following form:

$$\frac{1}{2} \tilde{ϕ} ( r ) + D [ \tilde{ϕ} ] ( r ) - ikS [ \tilde{ϕ} ] ( r ) = - {U}^{inc} ( r ) , r ∈ Γ , \\ S [ \tilde{ϕ} ] ( r ) = {\int }_{Γ} G ( r , {r}^{′} ) \tilde{ϕ} ( {r}^{′} ) d σ ( {r}^{′} ) , r ∈ \overline{Γ} , \\ D [ \tilde{ϕ} ] ( r ) = {\int }_{Γ} \frac{\partial G ( r , {r}^{′} )}{\partial n ( {r}^{′} )} \tilde{ϕ} ( {r}^{′} ) d σ ( {r}^{′} ) , r ∈ \overline{Γ} ,$$

and for an open surface, a scattered field at a surface may be represented in a manner that satisfies a relationship at a scattering surface may be expressed in the following form:

U^{scat}(r)= [symbol] [\tilde{φ}](r),r∈ [symbol] ³\Γ̅,

such that:

S[\tilde{φ}](r)=−U^{inc}(r),r∈Γ.

In other embodiments, similar forms of equations may be relied upon including direct and indirect formulations, magnetic field integral equations, electrical field integral equations, combined field integral equations, single layer formulations, double layer formulations, combined single- and double-layer formulations, and the like.

Many physical phenomena may be expressed in these forms, e.g., in acoustics, EM, electrostatics, elasticity, and the like, similar field-based phenomena may be described in these forms. For example, in an acoustic case, a scattered field may be obtained by means in accordance with the equations above. In an EM case, where an object may be penetrated by EM fields, a bounded integral equation based solution requires six integral equations, one for each component of the electric field and one for each component of the magnetic field, and where φ(r) represents a surface current density at a point r on a surface of a scattering body, i.e., on Γ. For simplicity of explanation embodiments in accordance with this disclosure are expressed in terms of acoustics, but one having ordinary skill in the art of scattered field simulators upon reading this disclosure will immediately recognize general applicability of the scattered field simulation techniques described herein.

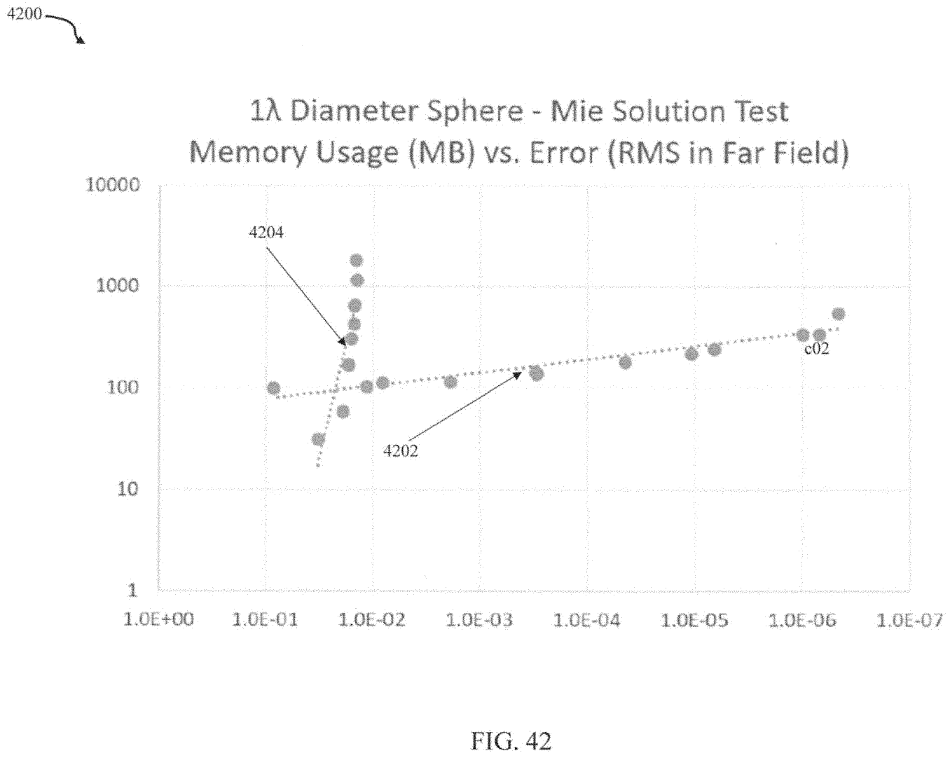

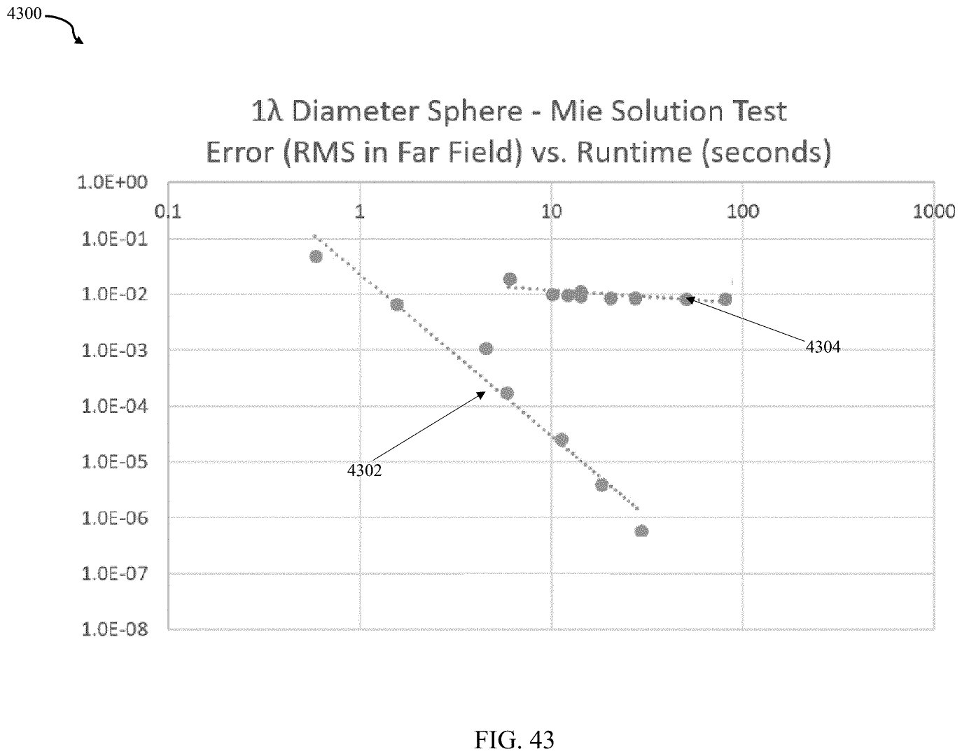

In general, known simulators have adopted volumetric approaches to simulating scattered fields because dealing with scattering fields in a manner accurately expressed according to the relationships above is difficult, because singularities arise near and at any observations point r. Other known simulators implement integration by utilizing triangulations on a surface, and approximating surface densities in a manner akin to 204 or 206 discussed above, and thus achieve accuracy of lower orders. Techniques in accordance with this disclosure are obtained by improving over a spline method 208 by continuing an improvement process, demonstrated by an improvement between 204 and 206 and then from 206 to 208, approximately 10 to 20 times. This improvement is quantitatively illustrated in reference to FIGS. 42-48 below.

Techniques in accordance with this disclosure, however, allow generation of highly accurate approximations of these exact relationships. These highly accurate approximations are sufficiently accurate that they present a significant improvement over known simulators and thus allow designers and engineers to accurately understand an impact of changes to a physical object's geometry or materials, or alterations to an incident field operating on a physical object.

First in step 602, a CAD file is accessed. The behavior of a field when a device, e.g., physical object 514, is present depends on geometric arrangement of materials and structures within a field, including a physical object, which generates or receives electromagnetic fields, e.g., for purpose of transmission, illumination, detection, electronic warfare, or the like, as well as materials and geometric arrangements of surrounding structures. The overall structure and material composition of, e.g., a satellite, including the precise type of metal, dielectric or composite materials it contains, significantly affects reception and sensing. Thus, a computational electromagnetic prediction tool, e.g. a simulator, must necessarily rely on a highly detailed description of geometry and material composition of all relevant structures. This type of information is generally available in the form of a CAD data structures, which may be organized in one or more computer files or stored in a database.

In another exemplary case of aircraft, e.g., CAD files used for engineering precisely detail positions and shapes of aircraft walls, wings, engine, and the like. When visualized in a computer screen, a CAD description looks precisely as a three-dimensional depiction of the aircraft. Using CAD data, a structure can be viewed under every possible angle (e.g., by simulating rotating the aircraft using point and click operations using an input device like a mouse). A user may also penetrate surfaces and view an interior of an aircraft, and, if provided in a CAD file, view various details such as seats, doors, windows, and the like. CA) data structure descriptions, e.g., 514, apply not only to aircraft, but, to all engineered structures. Thus, this example applies equally as well to CAD data structures modeling cell phones, buildings, computers, cars, highways, bridges, ships, satellites and the like. In all cases, a CA) data structure description allows a user to visualize, rotate, and determine precisely materials positions and shapes of every portion of the given structure. Thus a CAD file describes surfaces of physical objects in accurate detail and may include related information, such as materials information, normal vectors, tangential vectors, or curvatures.

Generally, CAD data structures, e.g., 514, are available in a variety of formats. Typical commercial CAD software (e.g., AutoCad, ProEngineer, Catia, and the like.) utilize a distinct data structure to organize a corresponding CAD file. For compatibility, however, there are two formats, IGES and STEP, employed by all CAD software for both input and output. Thus, a majority of CAD software can transform or export a CAD file for a given geometry of a physical object to either of IGES or STEP, and these formats may be used to translate proprietary CAD formats into new formats. Additionally, IGES or STEP geometries can be input into a majority of CAD software packages and then be further manipulated and subsequently output again in either IGES or STEP.

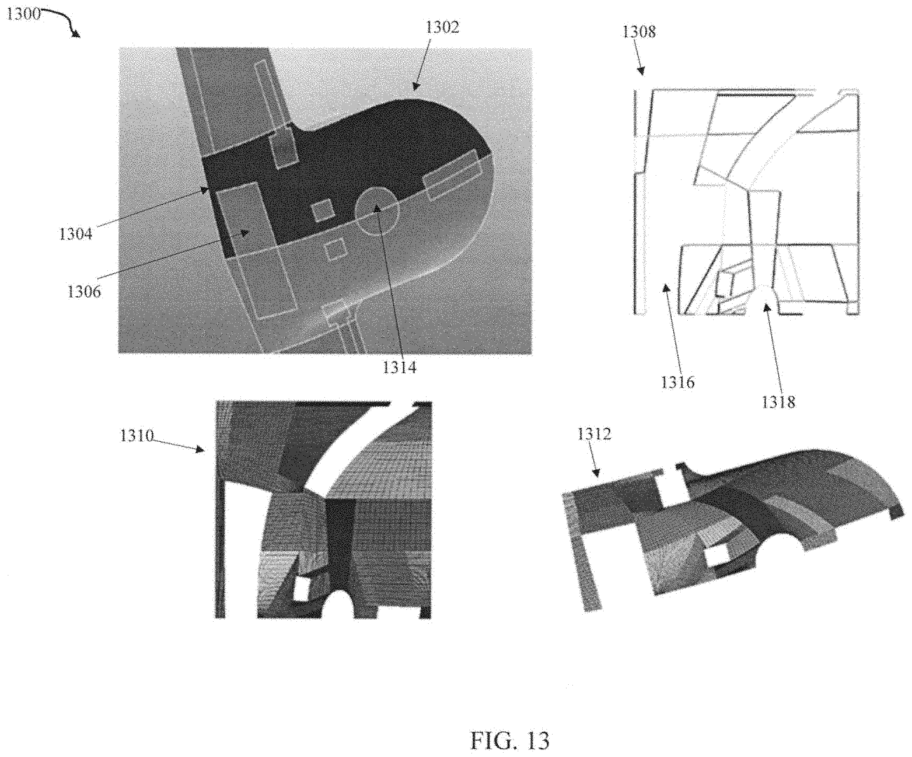

A geometrical description of a physical object in either IGES or STEP format can be used as input for a field simulator, e.g. 502, in accordance with this disclosure. CAD data structures, including IGES or STEP data structures, often represent geometry in terms of surface patches (see e.g. 1304, 1306, 1314 in FIG. 13). A surface patch is a portion of a surface in a three-dimensional space ( [symbol] ³) bounded by a number of curves defined in three-dimensional space.

At step 604, a patch data structure is generated. Thus, at step 604, if not already, CAD surface patches are logically quadrilateralized to obtain a set of logically quadrilateral (LQ) patches that are subsequently parametrized. These parametrized patches are preferably non-overlapping patches. In certain embodiments, parametrized patches must be overlapping. The operations of step 604 abide by relationships such that for a scattering surface Γ, a number M of parametrizations are performed such that each qth patch such that surface Γ satisfies a relationship expressed as follows:

$$Γ = {{⋃}_{q = 1}}^{M} \{ {\tilde{r}}^{q} ( s , t ) \vert ( s , t ) ∈ {[ - 1 , 1 ]}^{2} \}$$

$$where$$

$${\tilde{r}}^{q} : {[ - 1 , 1 ]}^{2} \to {ℝ}^{3} ( q = 1 , 2 , … , M ) ,$$

and in this way, each parametrizations maps a reference patch defined over unit square satisfying [−1, 1]² in an (s,t)-plane onto an a LQ patch within Γ.

In accordance with this disclosure, an LQ patch is a patch bounded by four curves. Each LQ patch is mapped by a one-to-one correspondence from points in a LQ patch and points of a square. Such a mapping is referred to as smooth mapping. For exemplary purposes, such a process is similar to a mapping between a real portion of the earth surface (which is curved an approximates a sphere) and a representation of that portion on a two-dimensional map which is flat. Thus, logical quadrilateral patches may be smoothly mapped onto a square. It will be appreciated upon reading this disclosure that such a mapping may be obtained by many known techniques.

A simulator, e.g., 502, logically quadrilateralizes CAD surface data using parametrization data from CAD data structures, e.g., 514. While a CAD surface may be complicated and involve patches having many sides, or fewer than four sides, a quadrilateralization may be effected by repartitioning CAD patches into patches having exactly four sides. This may be accomplished in some cases by logically drawing lines through vertices. In some embodiments, a user may impose a user defined subdivision of a CAD surface into a set of logically quadrilateral subsurface patches. This may be imposed using, e.g., a parameter file restricting quadrilateralization or through a user-interface allowing a user to directly operate on a geometry. Upon reading this disclosure, one will appreciate there are many methods of subdividing a surface patch to obtain logically quadrilateral surface patches.

Once obtained, logically quadrilateral surface patches may be smoothly mapped to a reference patch, which may be a unit square. In embodiments, CAD data, e.g., parameter data, materials data, surface normal data, curvature data, or the like, associated with CAD surfaces may be re-allocated to data structures associated with each LQ patch. Alternatively, a LQ patch data structure may reference CAD surface data in a CAD file. In embodiments, a patch data structure includes sub-data structures for each quadrilateral patch, each sub-data structure containing or referencing CAD data associated with a portion of a CAD surface corresponding to a respective sub-patch.

By approaching scattered field simulation in accordance with the principles discussed above, a set of logical relationships may be generated by a computer processor using techniques in accordance with this disclosure, such that the relationships between LQ patches that may be expressed as a linear equation that describes a scattered field component, where a surface field component is a data structure comprising data satisfying this form (in an acoustic case):

I(r)=D[\tilde{φ}](r)−ikS[\tilde{φ}](r)(r)

Generating a patch data structure further may include discretizing a reference patch and generating parameter data (if not directly obtained from a CAD data structure associated with a surface represented a patch data structure). A patch data structure may be further configured to store additional data in accordance with this disclosure, such as: field subcomponents, values of first derivatives and second derivatives of changes of surface variables, Jacobian, coordinates, parameters.

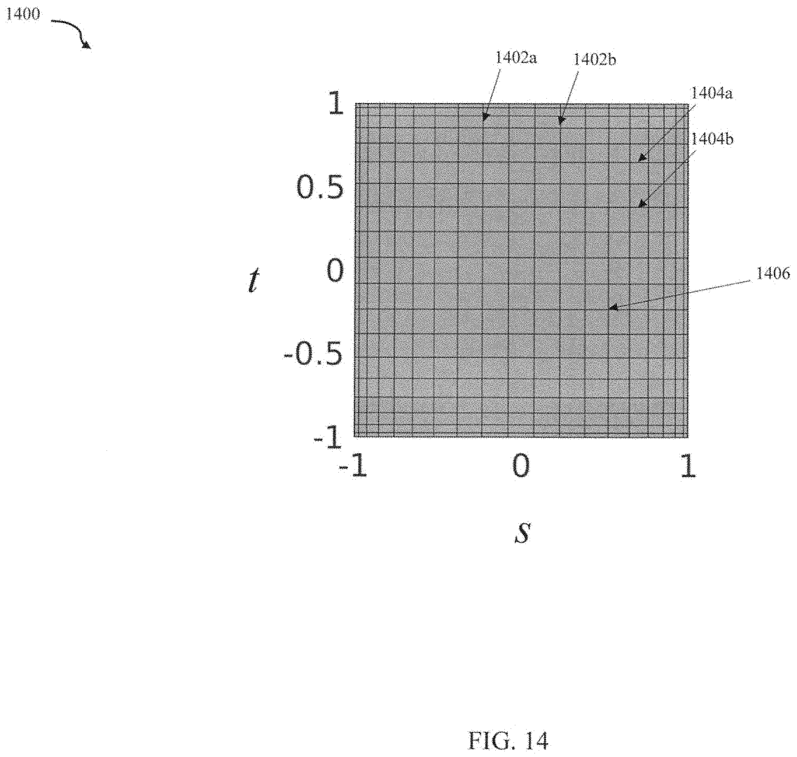

In embodiments, each reference patch in an s,t-plain is discretized according to an approximation mesh, i.e. a two dimensional logical mesh structure, defining a set of discrete approximation nodes (an exemplary approximation mesh 1400 having approximation nodes 1406 defined by intersecting single-dimensional mesh lines 1402a, 1402b, 1404a, 1404b is illustrated in FIG. 14). Each such two dimensional approximation mesh is defined as a set of discrete points s,t-plane. An approximation node, e.g. 1406, is a logical intersection at a s,t, between lines of two orthogonal single-dimensional meshes at a point, e.g., 1406, in parameter space. Each intersection in parameter space is referred to as an approximation node and may be identified by a pair of parameter index values s,t. The meshes defining the intersections, i.e., the approximation nodes, may be any suitable meshes, e.g., equi-spaced meshes, Gauss meshes, Gauss-Legendre, or the like. In a preferred embodiment they are Chebyshev meshes. A number of parametrizations, referred to above as M, may be determined in accordance with a node number parameter, which in embodiments is a pair of parameters Rₛ, Rₜ, which describes a number approximation mesh lines, e.g., 1402a, 1402b, 1404a, 1404b, in each orthogonal direction in each reference patch. In embodiments, R=Rₛ*Rₜ.

Each approximation node is associated with a point in three-dimensional space on an LQ patch. The data structure(s) describing approximation meshes may include (i.e., stores, contains, or references) the CAD data information, the parametrization information associated with a reference patch, real space coordinates (e.g, x,y,z for each point on a patch), Jacobian data, derivatives associated with changes of variables, curvatures.

As described above, surface data is obtained from CAD files, but other sources 630 of inputs may be accessed. For example, alternative surface sources may include data obtained from point cloud models or 3D scanners. In any case, in some embodiments, surface data may be logically quadrilateralized during step 604.

Referring back to FIG. 6, in step 606, approximators, e.g., 1720, are generated. In embodiments, an approximator, e.g., of 1720, is a product of a pair of discrete function approximators. Generating approximators, e.g., 1720, is done in accordance with principles expressed as follows. Because Γ is a set of M non-overlapping patches, an integral with respect to any variable over Γ may be expressed as a sum of M integrals each taken over each respective qth patch. In accordance with the principles discussed above, and described here a surface field component I(r), also called an integral operator applied to a given surface density, may be described in a form as follows:

$$I ( r ) = {\sum }_{q = 1}^{M} {I}^{q} ( r ) .$$

where each I^{q}(r) is a surface field sub-component for an LQ patch satisfying a relationship for any observation point r in a q^{th} patch expressed as:

I^{q}(r)=∫_{Γ}_{^{q}}\tilde{H}(r,r′)\tilde{φ}(r′)dσ(r′)

where (for an exemplary acoustic case) \tilde{H}(r, r′) may satisfy one of two relationships depending on whether I^{q}(r) is associated with a closed surface or an open surface respectively expressed as follows:

$$\tilde{H} ( r , {r}^{′} ) = \{ \begin{matrix}\frac{\partial G ( r , {r}^{′} )}{\partial n ( {r}^{′} )} - ikG ( r , {r}^{′} ) , & ( Closed surface ) , \\ G ( r , {r}^{′} ) , & ( Open surface ) .\end{matrix}$$

One of skill will appreciate that \tilde{H}(r, r′) will have a different form depending on the application (e.g., EM, elastic, electrostatic, etc.), or may have different forms for a single application. In an exemplary acoustic case, a forward map may be obtained for a given density φ, by adding I(r) and ½φ. Similarly, one of skill will appreciate that a forward map may be generated for any application including EM, elastics, electrostatics, and the like.

In the expressions above, \tilde{H}(r, r′) is referred to as a kernel and \tilde{φ}(r′) refers to a density at a point r′ on a scattering surface away from an observation point r. This kernel provides a linking relationship between the surface field component I(r) and those relationships above expressed in terms of layer potentials. One will appreciate that a similar approach applies in other field cases. For example, because both EM fields and acoustic fields are phenomena that may be accurately expressed using interrelated governing equation (and with different boundary conditions), both situations may be simulated using same techniques, where particular differences are addressed by employing different kernel functions.

It will be appreciated that in relationships above, all of the information encompassed by kernel \tilde{H}(r, r′) is contained within a CA data structure describing a physical object, or may otherwise be pre-supplied from a description of a scattering objected. In embodiments, this data is also stored or referenced by a patch data structure, which may be constructed, e.g., in step 604. What is unknown for any r′ is a density, which is expressed in terms above as \tilde{φ}(r′), where r′ is a point on a surface of a scattering object away from an observation point r. Thus, a surface field subcomponent, I^{q}(r), at a point r is determined based on contributions arising at every other point r′ on such a surface. However, not knowing \tilde{φ}(r′) for any r′, techniques in accordance with this disclosure are employed to first guess each density component \tilde{φ}(r′), and subsequent additional techniques are employed to rapidly improve such a guess to obtain highly accurate simulation data describing a relationship between a physical body, e.g., 514, an incident field and a scattered field.

In accordance with this disclosure, techniques are employed that accurately determine each unique density, while doing so in a form that is both readily parallelized and also ensures that a surface field component, I(r), may be obtained and utilized in conjunction with a linear system engine performing a bounded iterative process. As used here, density refers to an acoustic case, where in an EM case density refers to a current density, or generally may also simply be referred to as currents or densities or current densities.

Embodiments in accordance with this disclosure, or simply embodiments, may employ one of three techniques for obtaining density approximations of surface field sub-components I^{q}(r) depending on a distance between a point r and a q^{th} patch. Each of the three techniques performs operations in order to approximate a surface field sub-component I^{q}(r). Because a computer cannot evaluate a continuous integral over any non-trivial surface, each reference patch may be discretized using approximations meshes, each forming a set of approximation nodes within each reference patch (discussed further in reference to FIG. 14). Embodiments, then, approximate a surface component, I^{q}(r), sufficiently such that a total surface scattered field at a scattering surface of a physical object is accurate to a degree not previously attainable by known techniques employed by known simulators.

Thus, in order to generate each surface field sub-component, I^{q}(r), a series of operations may be performed to deal with contributions to a surface field component at an observation point arising from any patch. These operations are referred to as self-patch operations, near-patch operations, and far-patch operations. Self-patch and near-patch operations address issues arising in relation to Green function problems, one reason which has historically made volumetric methods a standard approach, namely a Green function singularity arising at or near an observation point. And far-patch techniques employ a quadrature engine that performs quadrature techniques which behave well at sufficiently far distances. An additional technique is employed in cases of physical objects having open geometries, which give rise to additional singularities when employing any known numerical technique.

In each case, by parametrizing each q^{th} patch, processes may be employed based on the parametrization \tilde{r}^{q} discussed above in order to obtain a surface field sub-component in accordance with the following relationship:

I^{q}(r)=∫₋₁¹∫₋₁¹\tilde{H}^{q}(r,s,t)\tilde{J}^{q}(s,t)\tilde{φ}^{q}(s,t)ds dt,(r∈Γ),

where \tilde{J}^{q}(s,t) denotes a surface Jacobian, and where each kernel may satisfy \tilde{H}^{q}(r,s,t)=\tilde{H}(r,\tilde{r}^{q}(s,t)) and each surface density may satisfy \tilde{φ}^{q}(s,t)=\tilde{φ}(\tilde{r}^{q}(s,t)). In embodiments, techniques employed to obtain Ĩ^{q}(r) depend on a proximity of a point r to a q^{th} patch, which may be determined by a proximity tolerance parameter, whose values are referred to as proximity parameters. A proximity tolerance parameter may be supplied in a parameter file, a parameter setting, via a user interface, or the like. While data necessary for determining a kernel function value, i.e., \tilde{H}^{q}(r,s,t) for a given r, s, t, and for determining a Jacobian value, i.e., \tilde{J}^{q}(s,t) for given s, t, is readily available from known data, e.g., from a patch data structure, other data, such as density, \tilde{φ}^{q}(s,t) for any given s,t is initially unknown. In embodiments, \tilde{φ}^{q}(s,t) is approximated processes as follows.

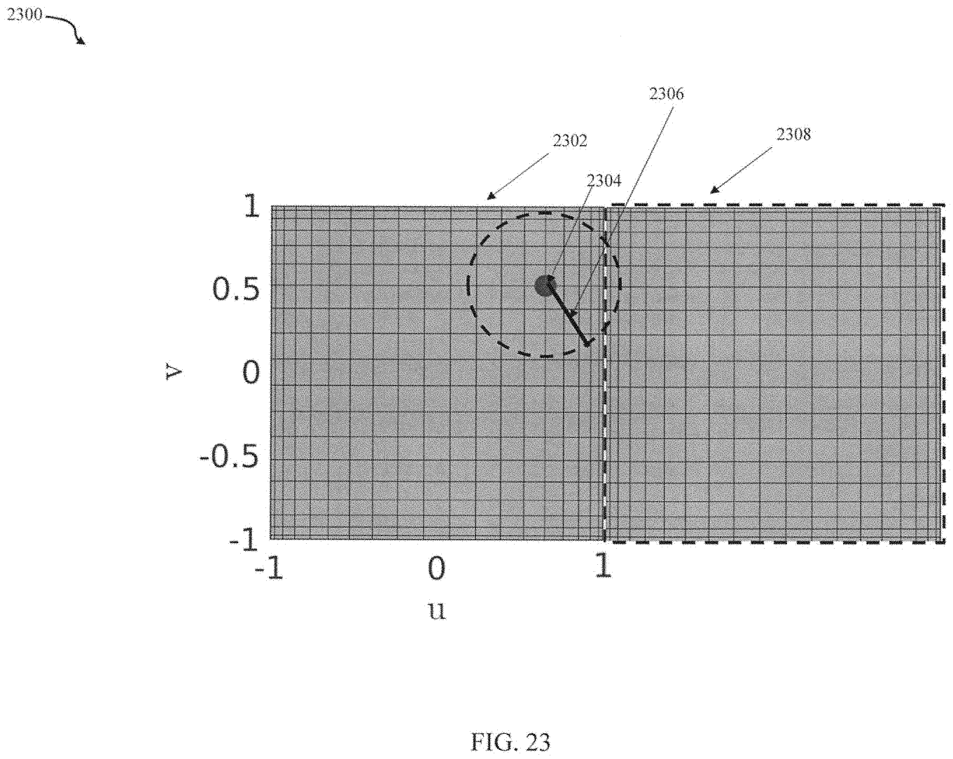

For a q^{th} patch, for an observation point r, in embodiments all self-patch points and all near-patches are identified. A proximity parameter is accessed, and each patch within a distance of the observation point r less than or equal to the proximity parameter is identified. Each patch greater than a distance equal to a proximity parameter is a far patch. This process is discussed further in reference to FIG. 23 below. A distance from an observation point to a patch in which an observation point lies is always within a proximity parameter distance; in embodiments such a distance is defined as zero. Having identified all near and far patches, a set of all near points Ω_{q}^{c} and a set of all far points Ω_{q}^{f} from an observation point r in a q^{th} patch is obtained.

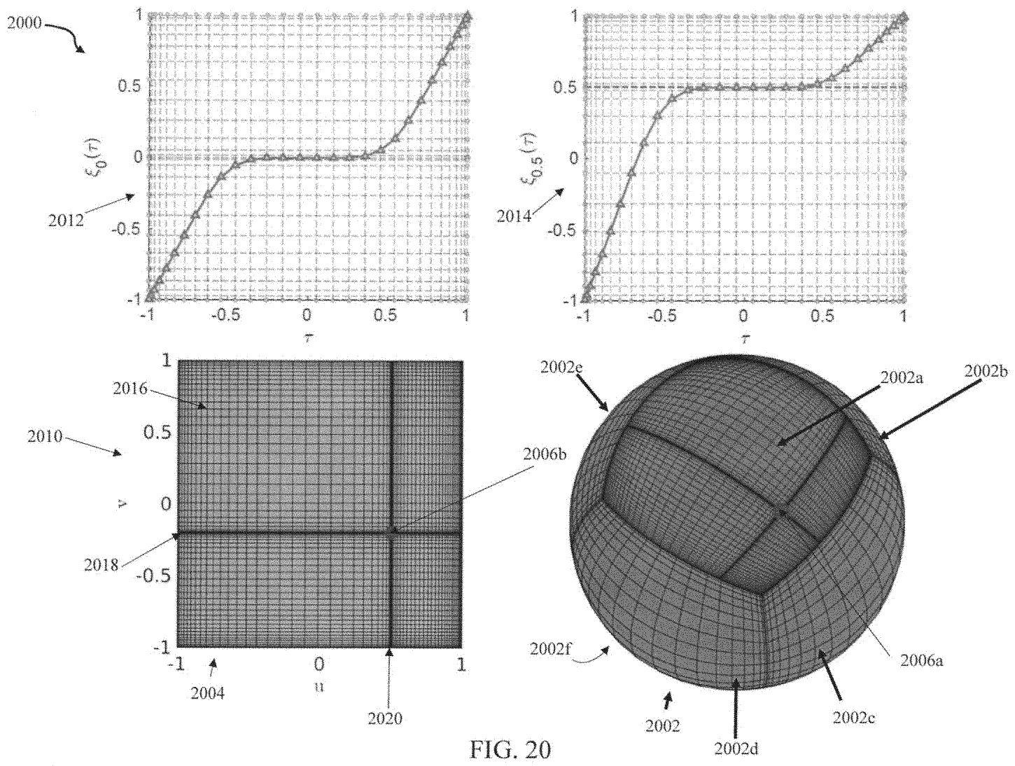

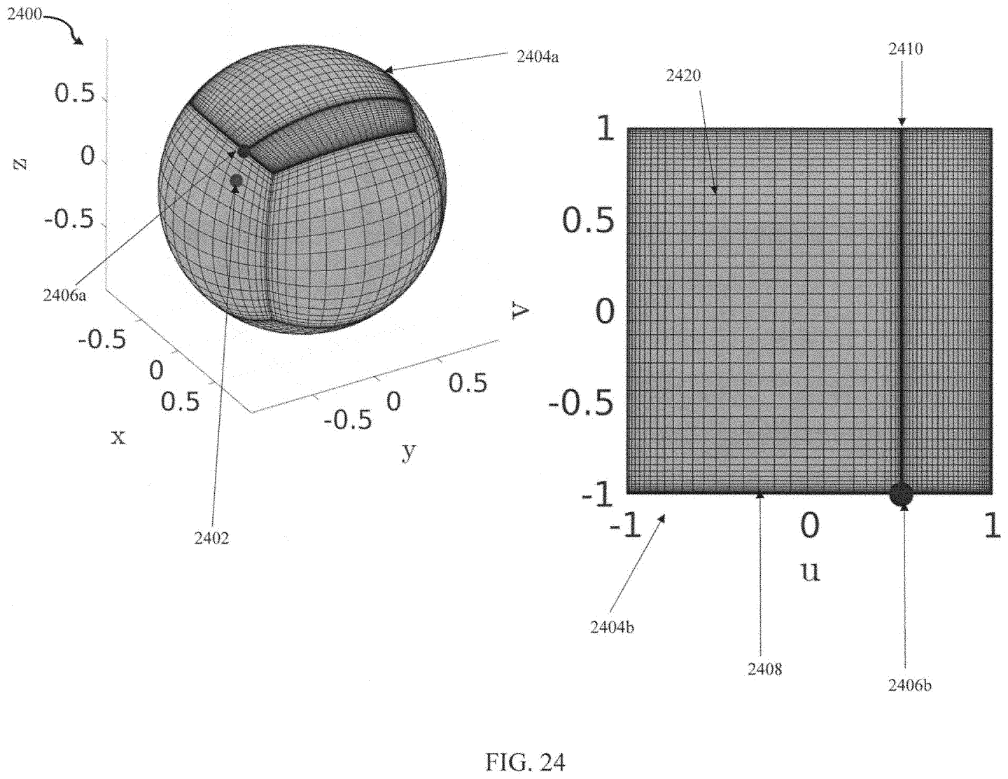

Evaluating I^{q} for r★Ω_{q}^{c} is difficult due to a singularity arising in a kernel at points r=r′. Thus, for r′ near r, self-patch and near-patch techniques are employed to approximate I^{q}(r) for each r∈Ω_{q}^{c}. In each case, a deformation an approximation is performed using a smoothing change of variables having a derivative that vanishes at a singularity in a self-patch case (see FIG. 20), and in a near-patch case, a smoothing change of variables having a derivative that vanishes at a point in a near-patch that is closest to a singularity (see FIG. 24).

In a self-patch case, in step 606, a deformation of an approximation node about observation point r is performed, e.g., by performing a deformation change of variables (as further discussed in reference to FIG. 20 below), thereby deforming an approximation mesh about r in order to generate a deformed mesh defined at points u,v as change of variables on s,t. A deformed mesh may have a same number or different number of deformed mesh nodes as an approximation mesh has approximation nodes, but a deformation change of variables in accordance with this disclosure causes each node (u,v) in a same patch to be drawn towards an observation point r. In embodiments, a self-patch deformation change of variables is a one-dimensional change of variables applied to both s and t for every r within a same qth patch in which an observation point r is found, i.e. a self-patch case. In embodiments, a same change of variables is applied to both s and t to obtain u,v parameters. Having obtained self-patch deformed meshes by performing a self-patch deformation change of variables, in embodiments a first derivative of a self-patch change of variables is obtained in both u,v and then stored in a memory.

Once deformed, for each self-patch deformed node an approximator is generated as a product of one-dimensional approximators for each deformed node u, v and stored in a memory. One-dimensional approximators, and thus approximators, e.g., 1720, are independent of density and can readily be evaluated at any point within a domain of definition. Exemplary one dimensional approximators are Legendre polynomials, complex exponentials (Fourier), Gegenbauer polynomials, Jacobi polynomials, and Chebyshev polynomials. In a preferred embodiment, approximators, e.g., 1720, are products of Chebyshev polynomials, Tₙ(u)Tₘ(v), in connection with approximation meshes that are Chebyshev meshes. One will appreciate that depending on the one-dimensional function approximators used in a given embodiment, corresponding approximation meshes (as generated above in 604) are determined accordingly, e.g., a Legendre mesh would be employed in an embodiment using Legendre polynomials as one-dimensional function approximators, and in an embodiment relying on complex exponentials a uniform approximation mesh would be used.

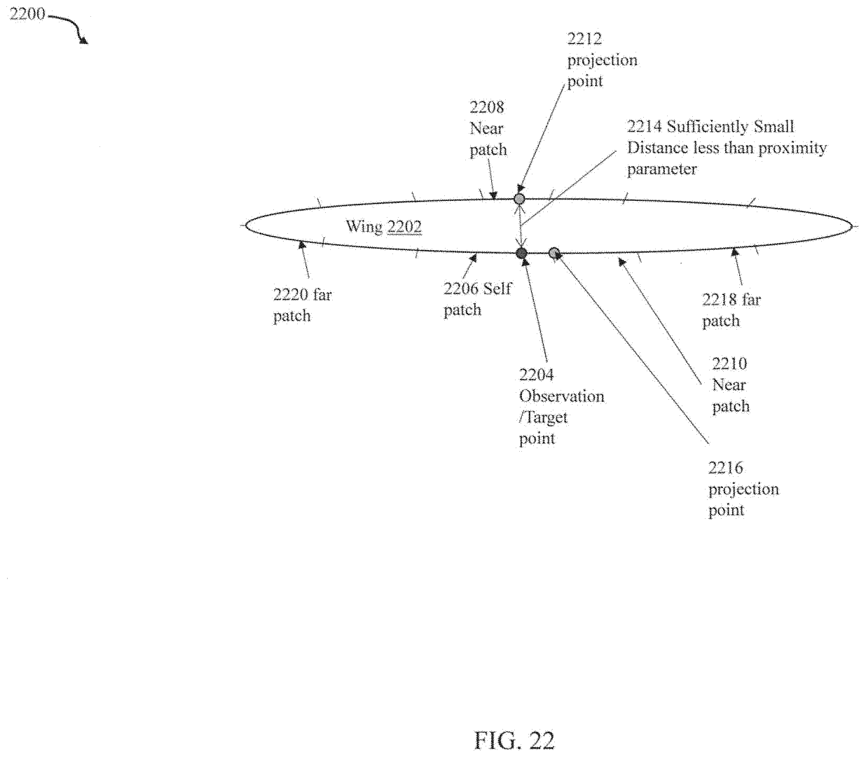

In a near-patch case, in step 606, rather than deform a mesh about observation point r, a mesh is deformed about a projection node. A projection node is a node in a near-patch closest to observation point r (discussed further in relation to FIG. 24). A projection point in a q^{th} patch nearest observation node r is identified by nodes ūₗ^{q}, v̅ₗ^{q} in a q^{th} reference patch that satisfy this relationship: ūₗ^{q}, v̅ₗ^{q}=argmin|r−r^{q}(u,v)| where argmin is taken over u,v in [−1,1]². A projection node need not be an approximation node. A projection node may be determined by any suitable minimization algorithm. In embodiments, Newton's method is employed. In a preferred embodiment, a golden section search algorithm is employed due to its robustness and its simplicity. Having identified a projection node, a change of variables is performed about a projection node to obtain a near-patch deformed mesh comprising near-case deformed mesh nodes. One will appreciate upon reading this disclosure that depending on a geometry of a scattering surface, a projection node may be at an edge of a near-patch or in an interior portion of a near-patch (FIG. 22).

A near-patch deformed mesh may have a same number or different number of deformed mesh nodes as an approximation mesh has approximation nodes, but a deformation change of variables in accordance with this disclosure causes each node (u,v) in the near-patch to be drawn towards projection node r^{q}(ūₗ^{q}, v̅ₗ^{q}). In embodiments, a near-patch deformation change of variables is a one-dimensional change of variables applied in both directions s and t. In embodiments, a change of variables is applied to both s and t to obtain near-patch deformed mesh u, v parameters. Having obtained near-patch deformed meshes by performing a deformation change of variables, in embodiments a first derivative of a near-patch change of variables is obtained in both u,v and then stored in a memory. In embodiments, a near-patch change of variables may be a same change of variables as a self-patch change of variables.

Once deformed, for each near-patch deformed node an approximator, e.g., 1720, is generated as a product of one-dimensional approximators for each near-patch deformed node u,v and stored in a memory. One-dimensional approximators, and thus approximators, e.g., 1720, are independent of density and can readily be evaluated at any point within a domain of definition. Exemplary one dimensional approximators are Legendre polynomials, complex exponentials (Fourier), Gegenbauer polynomials, Jacobi polynomials, and Chebyshev polynomials. In a preferred embodiment, approximators, e.g., 1720, are products of Chebyshev polynomials, Tₙ(u)Tₘ(v), in connection with approximation meshes that are Chebyshev meshes. One will appreciate that depending on the one-dimensional function approximators used in a given embodiment, corresponding approximation meshes (as generated above in 604) are determined accordingly, e g, a Legendre mesh would be employed in an embodiment using Legendre polynomials as one-dimensional function approximators, and in an embodiment relying on complex exponentials a uniform approximation mesh would be used.

Preferably, in embodiments, each one-dimensional functional approximator is generated according to a known method associated with a selected form of one-dimensional functional approximators, e.g., Legendre polynomials, complex exponentials (Fourier), Gegenbauer polynomials, Jacobi polynomials, and Chebyshev polynomials, and the like. Thus, values of one-dimensional functional approximators may be generated and stored in a memory. In a preferred embodiment, values of Chebyshev polynomials are generated for each Tₙ(uᵢ) and Tₘ(vⱼ). And accordingly, products Tₙ(uᵢ)Tₘ(vⱼ) may be generated for each n,m pair, where in embodiments n=0, 1, . . . , Nᵤ^{q}−1 and m=0, 1, . . . , Nᵥ^{q}−1.

At step 608, approximator weights, e.g., 1722, are generated for self-patch and near-patch cases. Approximator weights, e.g., 1722, are generated based on each approximator for each target point by generating for each r in accordance with this relationship:

∫₋₁¹∫₋₁¹H^{q}(r,u,v)J^{q}(u,v)Tₙ(u)Tₘ(v)du dv.

for each n,m pair. Each aspect of this relationship is independent of density, and may be generated based on available information as discussed above. An approximator, here, e.g., Tₙ(u)Tₘ(v), as previously discussed is readily generated, and where each Jacobian at each u,v, e.g., J^{q}(u,v) and each kernel, e.g., H^{q}(r,u,v) may be retrieved from, or generated from data retrieved from, a patch data structure.

In embodiments, in step 608, each approximator weight is computed and stored in a memory.

In step 610, an initial q^{th} patch density guess is generated, φᵢₙᵢₜᵢₐₗ^{q}(u,v), for each u,v in a q^{th} patch for each q, to obtain an initial density guess, φᵢₙᵢₜᵢₐₗ(u,v). An initial surface field sub-component I^{q}(r) for a given initial density guess, φᵢₙᵢₜᵢₐₗ(u,v) is generated, which may satisfy a relationship expressed as:

$${I}^{q} ( r ) = {\sum }_{m = 0}^{{N}_{v}^{q} - 1} {\sum }_{n = 0}^{{N}_{v}^{q} - 1} {\text{?}}_{n , m}^{q} {\int }_{- 1}^{1} {\int }_{- 1}^{1} {H}^{q} ( r , u , v ) \text{?} ( u , v ) {T}_{n} ( u ) {T}_{m} ( v ) d u dv . \\ \text{?} \text{indicates text missing or illegible when filed}$$

As one will appreciate an initial surface field sub-component in the form above, may be generated independently of a true density φ(u,v). A true density φ(u,v) and associated true approximator coefficients a_{n,m}^{q} must be determined. Initial approximator coefficients based on initial density guess, φᵢₙᵢₜᵢₐₗ(u,v), are generated according to techniques as follows.

In embodiments, approximator coefficients, a_{n,m}^{q}, for each q^{th} density guess, φᵢₙᵢₜᵢₐₗ^{q}(u,v), are generated according to these relationships:

$$\text{?} ( u , v ) = {\sum }_{m = 0}^{{N}_{v}^{q} - 1} {\sum }_{n = 0}^{{N}_{v}^{q} - 1} \text{?} {T}_{n} ( u ) {T}_{m} ( v ) , \\ \text{?} ( u , v ) = \frac{d \text{?}}{du} ( u ) \frac{d \text{?}}{dv} ( v ) \text{?} ( u , v ) , \\ {\text{?}}_{n , m}^{q} = \frac{\text{?}}{{N}_{u}^{q} {N}_{v}^{q}} {\sum }_{j = 0}^{{N}_{v}^{q} - 1} {\sum }_{i = 0}^{{N}_{v}^{q} - 1} \text{?} ( {u}_{i} , {v}_{j} ) {T}_{n} ( {u}_{i} ) {T}_{m} ( {v}_{j} )$$

$$\text{?} \text{indicates text missing or illegible when filed}$$

where

$$\frac{d {η}_{s}^{q}}{du} ( u ) and \frac{d {η}_{t}^{q}}{dv} ( v )$$

are derivatives with respect to changes of variables and may be obtained from a patch data structure.

An initial q^{th} patch density guess φᵢₙᵢₜᵢₐₗ^{q}(u,v) may be pre-supplied for a given application, or an initial guess may be supplied by a user, or an initial guess may be a default guess contained within instructions describing an embodiment in accordance with this disclosure. Any initial density guess will suffice. In various embodiments an initial guess may be set to zero. In preferred embodiments, an initial density guess for φ^{q}(u,v) may be the incident field, U^{inc}(u,v), at a surface of a scattering body. In embodiments, having generated an initial density guess for each φ^{q}(u,v), each intermediate guess value ψ^{q}(u,v) may be generated, in order to obtain an initial approximator coefficient guess for a_{n,m}^{q}, in accordance with the relationships above, where

$$\text{?} = \{ \begin{matrix}1 , & n = 0 , \\ 2 , & n \neq 0.\end{matrix} \\ \text{?} \text{indicates text missing or illegible when filed}$$

Thus, an initial guess φᵢₙᵢₜᵢₐₗ(u,v), generated in step 610, may be used to generate an initial surface field sub-component I^{q}(r) for each q including self-patch and near-patch contributions, in accordance with

$$\text{?} ( r ) = \text{?} {\text{?}}_{n , m}^{q} {\int }_{- 1}^{1} {\int }_{- 1}^{1} \text{?} ( r , u , v ) {J}^{q} ( u , v ) {T}_{n} ( u ) {T}_{m} ( v ) du dv . \\ \text{?} \text{indicates text missing or illegible when filed}$$

Each initial surface field sub-component in step 610 is generated based on approximator weights generated, e.g., in step 608, and corresponding initial approximator coefficients a_{n,m}^{q}. In embodiments, step 610 retrieves precomputed approximator weights, e.g., 1722. It will be appreciated that while, in a preferred embodiment, approximators, e.g., 1720, and approximator weights, e.g., 1722, may be precomputed, they need not be an may be generated on demand as needed.

In step 610, far patch contributions to I^{q}(r) may also be generated using a suitable quadrature technique to obtain far-patch contributions satisfying

$${I}^{q} ( r ) \approx \text{?} {H}^{q} ( r , {u}_{i} , {v}_{j} ) {J}^{q} ( {u}_{i} , {v}_{j} ) \frac{d \text{?}}{du} \frac{d \text{?}}{dv} {w}_{i} {w}_{j} {ϕ}^{q} ( {u}_{i} , {v}_{j} )$$

$$\text{?} \text{indicates text missing or illegible when filed}$$

where φ^{q}(ui, vj) is φᵢₙᵢₜᵢₐₗ^{q}(ui, vj).

For a far point, of points in Ω_{q}^{f}, far from an observation point r in a qth patch, an integrand containing a Green function is smooth. Thus, such an integral can be can be accurately evaluated utilizing any suitable high-order quadrature rule. In a preferred embodiment Fejér's first quadrature rule is utilized to generate far-field contributions, because Fejér's effectively exploits a discrete orthogonality property satisfied by Chebyshev polynomials in a Chebyshev mesh, and Fejér's also allows straightforward computation of two-dimensional Chebyshev transforms relied upon in a preferred embodiment of self-patch and near-patch techniques described above. Thus, in embodiments a set of quadrature nodes and weights are generated in accordance with relationships as follows:

for a discretization using N points, quadrature nodes are generated in accordance with this form:

$${r}_{j} = cos ( π \frac{2 j + 1}{2 N} ) , j = 0 , … , N - 1 ,$$

and quadrature weights are generated in accordance with this form:

$${w}_{j} = \frac{2}{N} ( 1 - 2 {\sum }_{j = 1}^{[ N / 2 ]} \frac{1}{\text{?}} cos ( \text{?} {x}_{j} ) ) , j = 0 , … , N - 1.$$

$$\text{?} \text{indicates text missing or illegible when filed}$$

where uᵢ, vⱼ above satisfy a Cartesian-product discretization {uᵢ=xᵢ|l=0, . . . , Nᵤ^{q}−1}×discretization {vⱼ=xⱼ|j=0, . . . , Nᵥ^{q}−1}.

Thus in step 612, Iᵢₙᵢₜᵢₐₗ^{q}(r) may be expressed as a large two dimensional matrix including all information for Iᵢₙᵢₜᵢₐₗ^{q}(r) for points r, both near and far-patch to the q^{th} patch. Having each initial surface field subcomponent Iᵢₙᵢₜᵢₐₗ^{q}(r), an initial total surface field component Iᵢₙᵢₜᵢₐₗ(r) is generated as a sum of each Iᵢₙᵢₜᵢₐₗ^{q}(r) as

$${I}_{intial} ( r ) = {\sum }_{q = 1}^{M} {I}_{initial}^{q} ( r )$$

Where Iᵢₙᵢₜᵢₐₗ(r) is a total initial surface field component, and per a description above, for an initial density guess, Iᵢₙᵢₜᵢₐₗ(r) is equal to I(r), which is equal to an operator applied to an initial guess density, φᵢₙᵢₜᵢₐₗ(u,v).

In step 614, residuals for a forward map are computed in accordance with the relationship (in an exemplary acoustic case):

residual=½φᵢₙᵢₜᵢₐₗ(r)+Iᵢₙᵢₜᵢₐₗ(r)+U^{inc}(r)

which is a measure of how much φ_{guess}(r) fails to satisfy the exact relationship:

½φ(r)+I(r)=−U^{inc}(r)

which is satisfied by a true density φ(r). One of skill upon reading this disclosure will readily understand alternative forms of these relationships for an initial guess for determining a density in other applications, e.g., EM, elastics, electrostatic fields, and the like.

Having residuals obtained in step 614, a residual tolerance parameter is accessed at step 616 to determine whether residuals obtained in step 614 satisfy a residual tolerance parameter. A residual is defined at each point on a surface, an exact true density would obtain a residual that is zero over each point on a surface. But it is expected that an initial density guess residual will be non-zero. To determine whether a residual satisfies a residual tolerance parameter, a norm of the residual is generated. A norm may be a Euclidean norm or an infinity norm or other norms. In a preferred embodiment a norm is a Euclidean norm. One of skill in the art reading this disclosure will appreciate a norm may be readily obtained using known techniques. When a norm is less than a residual tolerance parameter, a residual tolerance is satisfied. When a norm is greater than or equal to a residual tolerance parameter, a residual tolerance is not satisfied, and an improved guess may be generated. In some alternative embodiments, a residual tolerance may be satisfied when a norm is less than or equal to a residual tolerance parameter and is not satisfied when a norm is greater than a residual tolerance parameter.

When a residual tolerance not satisfied in step 616, an improved guess, φ_{improved}(r), is obtained in step 618. A solution approximation 640, comprising an initial guess and a residual value associated with a residual associated with a density guess are provided in step 618 to a suitable linear system engine which generates an improved density guess, φ_{improved}(r). One of skill will appreciate there are many suitable linear system engines. In a preferred embodiment, a linear system engine employs an iterative approach for obtaining numerical solutions to nonsymmetrical systems of linear equations to obtain approximations that satisfy a minimum residual Euclidean norm condition, based on an initial guess and each subsequent iterative guess leading up to a present guess. In embodiments, a linear system engine employs a generalized minimal residual method (GMRES), for solving systems in a form Ax=b, such as ½φ(r)+I(r)=−U^{inc}(r), and the like, where ½φ(r)+I(r) is a forward map in an acoustic case. One will appreciate other suitable linear system engines performing different methods could be used, such as Jacobi iterations, bi-conjugate gradient iterations, and the like.

Having obtained, φ_{improved}(r), this process 612, 614, 616, 618 repeats, with φᵢₙᵢₜᵢₐₗ(r) substituted by φ_{improved}(r), to generate a new φ_{improved}(r), and this process repeats until a residual value satisfying a residual tolerance value is obtained. When it is obtained, a resulting φ_{improved}(r) is called φ_{final}(r), an accurate approximation of a true surface density experienced by a real world physical body subject to a real world incident field U^{inc}.

At step 620, having an accurate surface density solution φ_{final}(r), U^{scat} may be determined at any point r away from scattering surface Γ. When a point, r, away from scattering surface Γ by a distance greater than a proximity parameter, a suitable quadrature method may be employed to determine U^{scat}(r). One will appreciate that, having accurate densities upon a surface Γ, any suitable quadrature method may be employed to determine U^{scat} away from scattering surface Γ. In embodiments, a quadrature engine performs Fejér's quadrature method. When a point, r, is near a scattering surface, i.e. a distance less than a proximity parameter, a near-patch integration method as described above in step 606 is employed to determine U^{scat}(r), where a point away from the surface is treated as an observation point and a projection node is generated on each patch within a distance to the point away from the surface less than a proximity parameter.

In a case where a physical object includes an edge, e.g., at an edge of a wing, at an edge of cube, at an edge of a thin disc (which may be modeled as an infinitely thin disc, an example of an open surface), or the like, an additional mesh deformation may first be performed in order to mitigate singularities arising in known simulation techniques associated with an edge of an open surface. This is different than, but related to, the change of variables used in near and self-patch cases as described in step 606. When an edge is present, i.e. a surface is an open surface, an edge deformation is applied and each subsequent step proceeds as described above, with respect to the approximation meshes (e.g, Chebyshev meshes) but based on edge deformed approximation meshes instead of approximation meshes. Edge deformation is performed in accordance with a change of variables. An edge deformation change of variables has derivatives that vanish at an edge or at edges and operates on parametrization variables (s,t). In embodiments, an edge deformation change of variables is in accordance with these relationships:

$$s = {η}_{s}^{q} ( u ) = \{ \begin{matrix}u , & No edge on s \\ - 1 + \frac{1}{π} w ( π [ u + 1 ] ) , & Edges at s = \pm 1 \\ - 1 + \frac{2}{π} w ( \frac{π}{2} [ u + 1 ] ) , & Edge at s = - 1 only \\ - 3 + \frac{2}{π} w ( π + \frac{π}{2} [ u + 1 ] ) , & Edge at s = 1 only\end{matrix} \\ t = {η}_{t}^{q} ( v ) = \{ \begin{matrix}v , & No edge on t \\ - 1 + \frac{1}{π} w ( π [ v + 1 ] ) , & Edges at t = \pm 1 \\ - 1 + \frac{2}{π} w ( \frac{π}{2} [ v + 1 ] ) , & Edge at t = - 1 only \\ - 3 + \frac{2}{π} w ( π + \frac{π}{2} [ v + 1 ] ) , & Edge at t = 1 only\end{matrix} \\ where \text{:} \\ w ( τ ) = 2 π \frac{{[ v ( τ ) ]}^{p}}{{[ v ( τ ) ]}^{p} + {[ v ( 2 π - τ ) ]}^{p}} , 0 \leq τ \leq 2 π , \\ v ( τ ) = ( \frac{1}{p} - \frac{1}{2} ) {( \frac{π - τ}{π} )}^{3} + \frac{1}{p} ( \frac{τ - π}{π} ) + \frac{1}{2} .$$

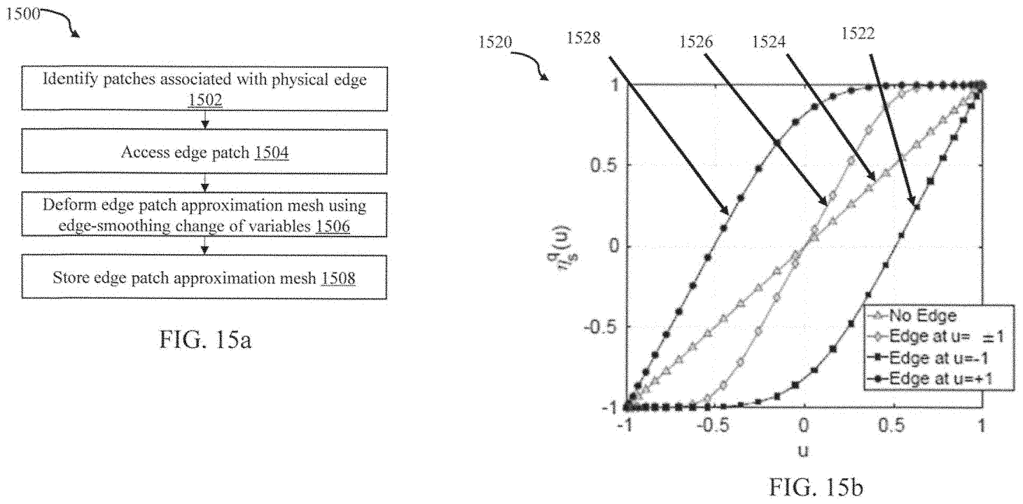

This change of variables is depicted in FIG. 15b, for ηₛ^{q}, and one will recognize from the expression above that a same depiction would result for ηₜ^{q} with a substitution of t for s and v for u. One will also appreciate from the expressions above that where a patch does not include an edge, no deformation occurs from an edge deformation change of variables. In embodiments, an edge deformation change of variables may be optional when an edge is detected, or it may always be performed. As will be appreciated when a patch does not include an edge, s takes u and t takes v, and because each exists in [−1,1]² no deformation occurs in non-edge cases.

One will appreciate that in the expression above, p, dictates an order of approximation accuracy and may be adjusted. A resulting error can be estimated as a product of a fixed number and the p^{th} power of the mesh size. In embodiments, p is predetermined, but in other embodiments p may be supplied by a user. Values of p as low as p=2 are often found to be adequately useful, for accuracies of the order of 1%, but values of p of the orders of four to six or above can enable significantly faster convergence and lower computing costs for higher accuracies (as demonstrated e.g. in FIG. 46b).

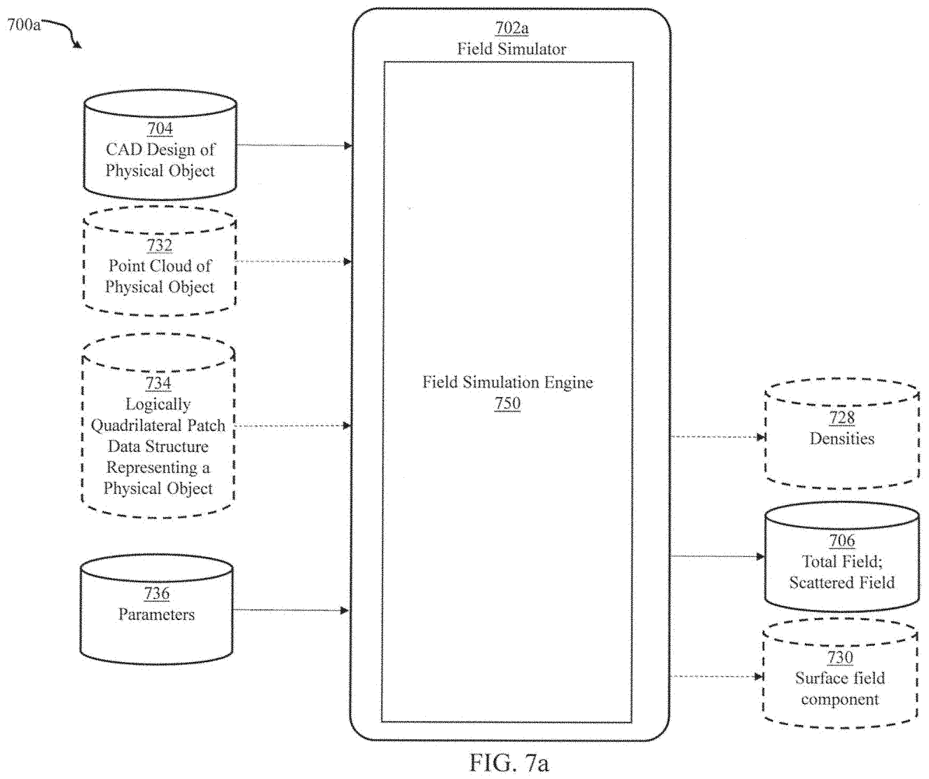

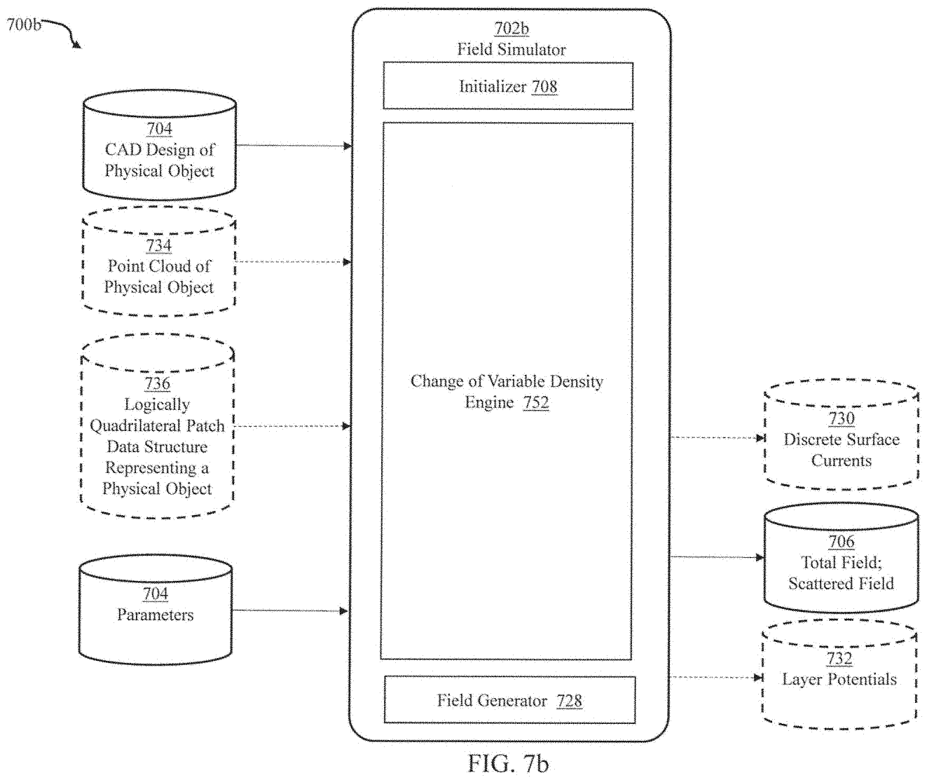

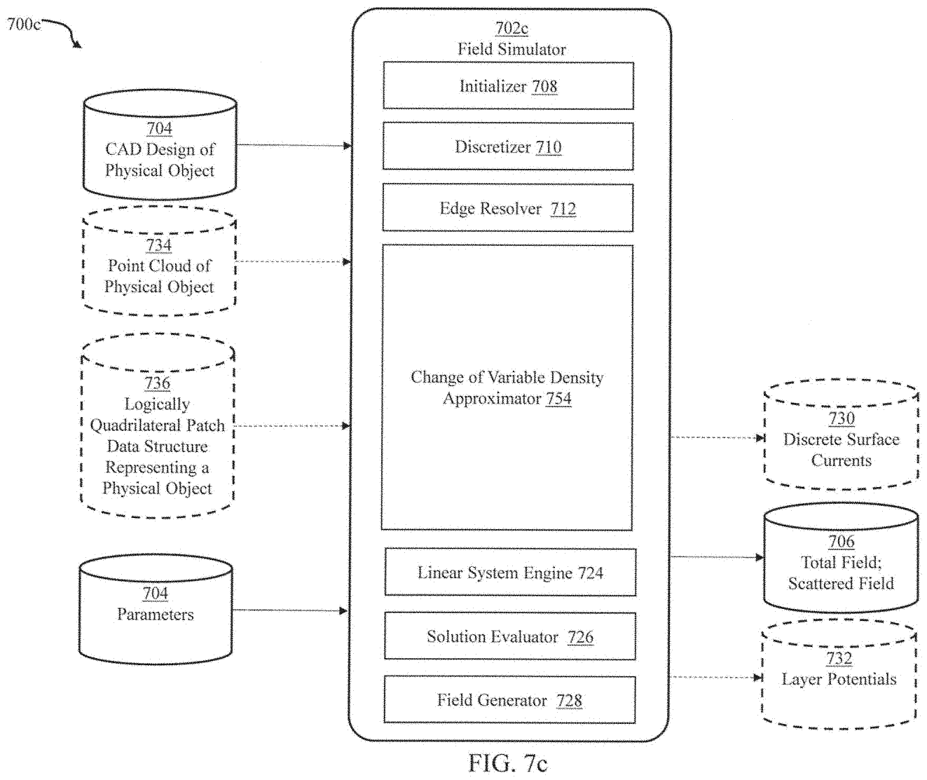

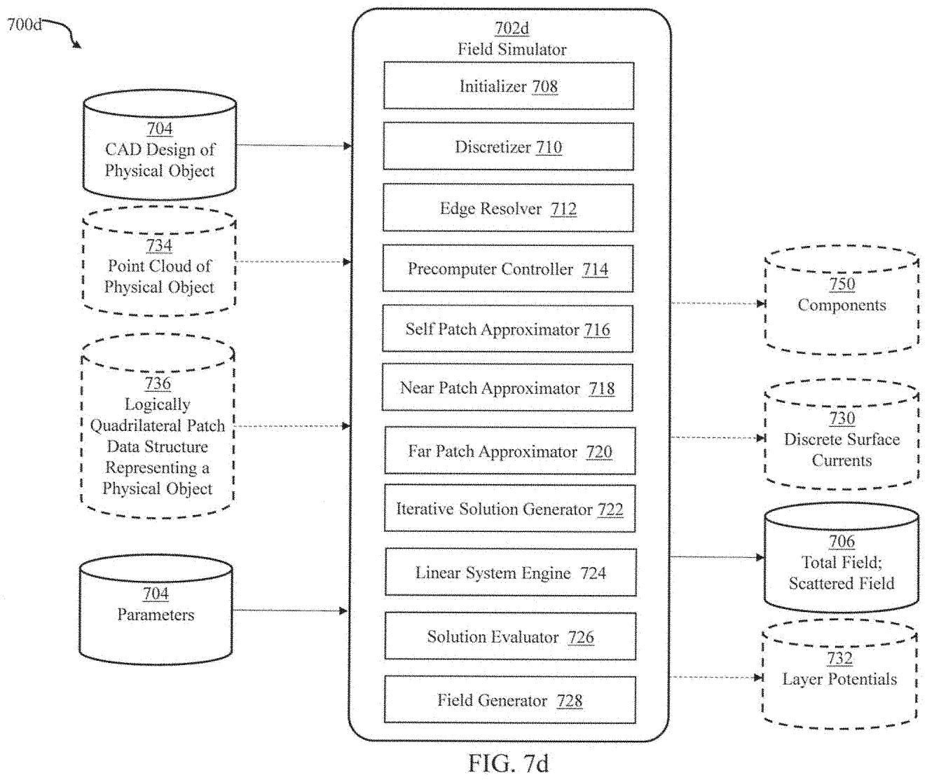

FIGS. 7a-7d illustrate interrelated embodiments of field simulator systems in accordance with aspects of this disclosure. In embodiments, a field simulator, e.g. 702a-d, includes a set of computer readable instructions which may be executed by a general purpose computer, thereby configuring such a computer into a field simulator 702. One of skill in the art will readily appreciate that embodiments of instructions in accordance with this disclosure may take many forms in many languages. Any particular embodiment of instructions in accordance with this disclosure may be written in a single language or in a variety of languages, as is left to a designer based on design considerations specific to an application. One of skill will further appreciate that upon reading this disclosure, generating instructions embodying aspects of this disclosure is within a skill level of one of skill in the art.

FIG. 7a illustrates a field simulator 702a in accordance with this disclosure. A field simulator 702a is a device having a field simulation engine 750. A field simulator 702 may receive or access a CAD design for a physical object 704. Alternatively, field simulator 702 may access, retrieve, or receive a point cloud of a physical object 732, or a logically quadrilateral patch data structure representing a physical object 734. Data structure 734 may have been previously generated and stored by a field simulator 702, or any suitable process. A field simulation engine 750 generates a total field including a scattered field 706 scattered by a physical objected (e.g., represented by 704, 732, 734) based on parameters 736 which may also be accessed or retrieved by field simulator 702. Once generated a total field or scattered field 706 may be stored in a memory, which may be transitory or non-transitory. Like field simulator 502, field simulator 702 may provide a total field including a scattered field 706 to a downstream system, which may be a subsequent simulator, or may provide a total field including a scattered field 706 to a CAD tool, or may display a illustrative representation of total field or scattered field (e.g., as shown in FIGS. 4, 36, 37, 38, 39, 40). In each case, a total field including a scattered field 706, downstream processes may modify a CAD design based on a simulated total field including scattered field 706 or simulate additional aspects of a design (e.g, a downstream system may be a current simulator simulating effects of an electric field upon a circuit within a scattered field). In embodiments, only a scattered field is provided and in other embodiments only a total field (a superposition of a scattered field and an incident field) is provided. Optionally a field simulator may output a set of discrete surface currents, or densities, 728. In other embodiments, a field simulator may output a surface field component 730. In each case, an output of a total field or scattered field 706, surface field components 730, or densities 728, one will appreciate that a form of output, e.g. a particular output data structure, may be determined as needed by a particular application.

A field simulation engine 750 in accordance with this disclosure may be embodied in a single set of instructions or in multiple sets of instructions each respectively describing different aspects of this invention. In embodiments, field simulator 702 includes one or more processors coupled to one or more memories and a non-transitory data storage having instructions thereon, which when executed by one or more processors execute instructions causing the one or more processors to instruct field simulator 702 to perform operations of a field simulation engine 750. In embodiments, a first field simulation engine 750 is configured to generate a scattered field by performing process 600. In alternative embodiments a field simulation engine is configured to generate scattered fields from CAD data, e.g., by performing one or more processes 1100, 1500 1200, 1600, 1800, 2100, 2500, 2600, 2700, 2800, 2900, 3000a, 3000b, 3100, 3200. In embodiments, a field simulation engine 750 is an inclusive field simulation engine configured to perform all processes 1100, 1200, 1500, 1600, 1800, 2100, 2500,2600,2700,2800,2900.

In interrelated embodiments a field simulator 702b in accordance with this disclosure includes an initializer 708, a change of variables density engine 752 and a field generator 728. In embodiments, an initializer 708 is configured to perform aspects of process 600 or process 1100. In embodiments, change of variables density engine 752 is configured to perform aspects of process 600 or at least one or more of processes 1200, 1500, 1600, 1800, 2100, 2500, 2600, 2700, 2800. And in embodiments a field generator is configured to generate a scattered field from a final density provided by, e.g., a change of variables density engine, by performing process 2900. In embodiments, a change of variables density engine is a first change of variables density engine that is configured to perform operation 3000a. In embodiments, field generator 728 is configured to perform at least aspects of process 600 or process 2900. In embodiments field generator 728 is a field generator engine configured to perform process 2900.

In interrelated embodiments, a field simulator 702c in accordance with this disclosure includes an initializer 708, as described above, a discretizer 710, an edge resolver 712, a change of variables density approximator 754, a linear system engine 724, a solution evaluator 726, and a field generator 728, as described above. In embodiments, a discretizer 710 is configured to discretize and parametrize CAD surfaces by performing aspects of process 600 or process 1200. In embodiments, a discretizer 710 is a discretizer engine configured to perform process 1200. In embodiments, an edge-resolver 712 is configured to detect an edge and perform edge deformation by, e.g., performing aspects of process 600 or process 1500. In embodiments an edge-resolver 712 is an edge resolver engine configured to perform process 1500. In embodiments, a change of variables density approximator 754 is configured to generate an initial guess in accordance with this disclosure by performing aspects of process 600 or at least one or more one or more of processes 1600, 1800, 2100, 2500, 2600, 2700. In embodiments, a change of variables density approximator 754 is an inclusive change of variables density operator configured to perform all of processes 1600, 1800, 2100, 2500, 2600, 2700. In embodiments, a linear system engine 724 is configured to generate an improved guess from either an initial guess or a subsequent improved guess, e.g., by performing at least aspects of process 600 or process 2700. In embodiments, a linear system engine 724 is a linear system generator configured to perform process 2700. In embodiments, a solution evaluator 726 is configured generate a residual and test a residual by, e.g., performing at least aspects of process 600 or process 2800. In embodiments, a solution evaluator 726 is a solution evaluator engine configured to perform process 2800.

In interrelated embodiments, a field simulator 702d in accordance with this disclosure includes an initializer 708, as described above, a discretizer 710, as described above, an edge resolver 712, as described above, a precomputer controller 714, a self-patch approximator 716, a near-patch approximator 718, a far patch approximator 720, an iterative solution generator 722, a linear system engine 724, as described above, a solution evaluator 726, as described above, and a field generator, as described above. In embodiments, a pre-computer controller 714 is configured to coordinate precomputation of various values and store those values in a memory. A pre-computer controller 714 may interact with a self-patch approximator 716, a near-patch approximator 718, or a far-patch approximator 720, to generate values for approximators, values for single-dimension function approximators, or values for approximator weights and to store. In embodiments, a pre-computer controller 714 obtains self-patch approximators and self-patch approximator weights and stores them in memory. In embodiments, a pre-computer controller 714 obtains near-patch approximators and near patch approximator weights and stores them in memory. In embodiments, pre-computer controller 714 is configured to perform aspects of process 600 or process 1600. In embodiments, a pre-computer controller 714 is a pre-computer controller engine configured to perform process 1600. In embodiments, self-patch approximator 716 is configured to generate self-patch approximators and to store them in a memory. In embodiments, self-patch approximator 716 is further configured to generate self-patch approximator weights and store them in memory. In embodiments, self-patch approximator 716 is configured perform aspects of process 600 or process 1800. In embodiments, a self-patch approximator 716 is a self-patch approximator engine configured to perform process 1800. In embodiments, near-patch approximator 718 is configured to generate near-patch approximators and to store them in a memory. In embodiments, near-patch approximator 718 is further configured to generate near-patch approximator weights and store them in memory. In embodiments, near-patch approximator 718 is configured perform aspects of process 600 or process 2100. In embodiments, a near-patch approximator 718 is a near-patch approximator engine configured to perform process 2100. In embodiment an approximator engine includes both a self-patch approximator 716 and a near-patch approximator 718 and is configured to perform at least process 3000b. In embodiments, a far-patch approximator 720 is configured to generate far-patch approximations based on a suitable quadrature technique by performing aspects of process 600 or process 2500. In embodiments, a far-patch approximator 720 is a far-patch approximator engine configured to perform process 2500. In embodiments, a iterative solution generator 722 is configured to assemble either a surface field component based on an initial density guess or a surface field component based on an improved density guess after iterations of a linear-system engine fail to satisfy a residual tolerance. In embodiments iterative solution generator 722 is configured to perform aspects of process 600 or processes 2600a or 2600b. In embodiments, iterative solution generator 722 is an iterative solution generator engine configured to perform processes 2600a and 2600b.

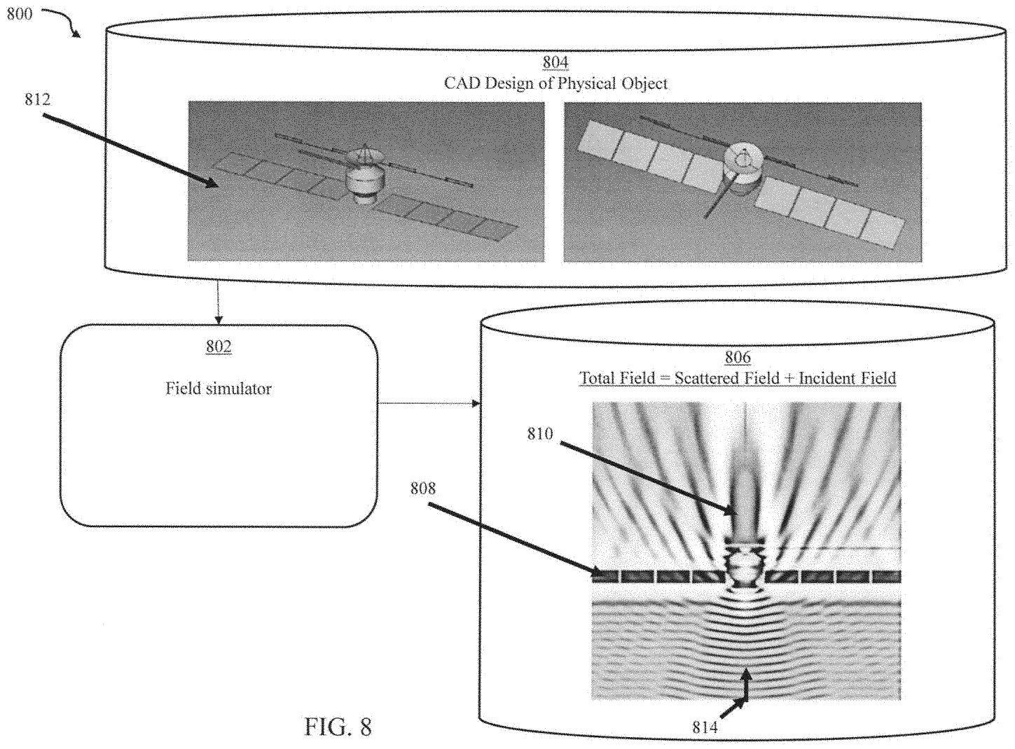

FIG. 8 illustrates aspects of a field simulators in accordance with this disclosure. In embodiments, a field simulator 802 accesses, retrieves, receives, or is supplied a CAD design of a physical object 804. As depicted a physical object is a satellite 812 comprising multiple antennas (i.e., sources of EM waves). Afield simulator 802 generates a total field 810 arising from physical object 812 as represented by a logical representation 808 of surfaces of physical object. As depicted an incident field arrives from a direction illustrated by arrow 814.

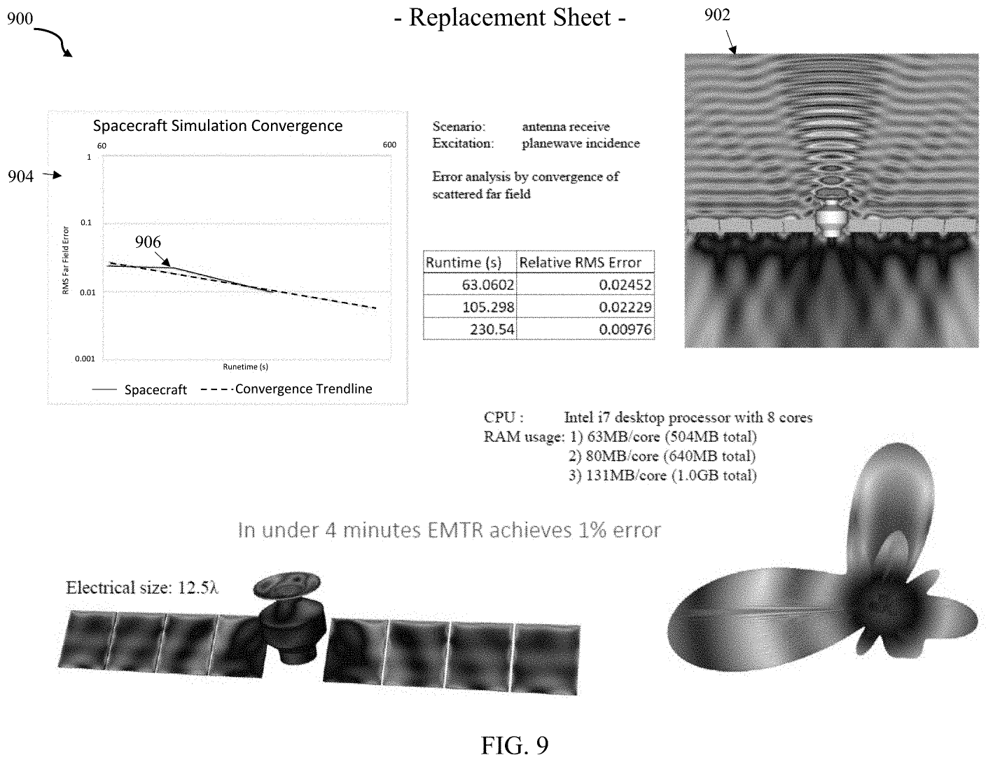

FIG. 9 illustrates objective measurements and illustrations results obtained using an embodiment in accordance with this disclosure referred to as EMTR. As illustrated in illustration 902 an antenna receives an excitation in a form of a plane wave, and a scattered field is generated using an Intel i7 desktop processor with 8 cores in three runs. In a first run, lasting 63.0602 seconds, an RMS Error of 0.02452 relative to a baseline run is obtained using 63 MB of memory per core for a total of 504 MB total memory. In a second run, lasting 105.298 seconds, an RMS Error of 0.02229 relative to a baseline run is obtained using 80 MB/core for a total of 640 MB total memory. In a third run, lasting 230.54 seconds, an RMS error of 0.00976 relative to a baseline run is obtained using 131 MB/core for a total of 1 GB of memory. In each case, a baseline run was performed over 35 minutes using a fine-mesh simulation method provided by a leading alternative solution. As shown in plot 904, RMS error over time for far field simulations 906 is plotted showing an RMS of 0.01 attained after approximately 330 seconds. Each run was accomplished using an electrical size of 12.5 times a wavelength or 12.5λ.

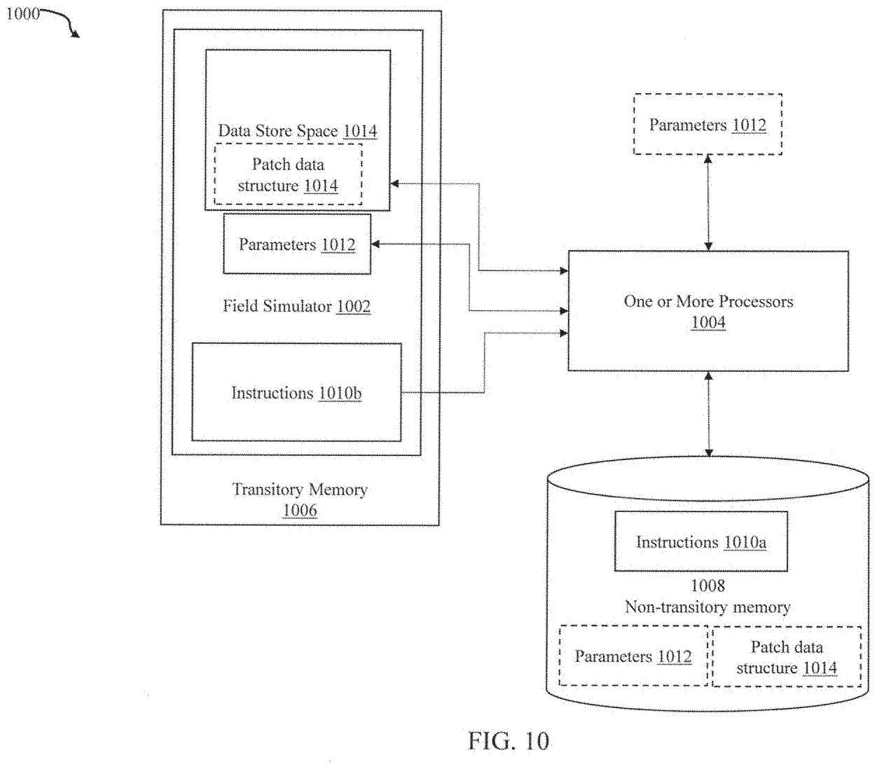

FIG. 10 illustrates various aspects of a field simulator, e.g. 502, 702a, 702b, 702c, 702d. A processing system 1000 includes one or more processors 1004 operatively coupled to a memory 1006, which may be a RAM, a cache, a network memory, a shared memory, or a distributed memory, or other transitory memory structure. One or more processors 1004 is also operatively coupled to a non-transitory data structure having instructions 1010a stored thereon. One or more processors may load instructions 1010a into memory to obtain instructions 1010b, stored in a memory space allocated to field simulator 1002, which may be all of instructions 1010a or a portion of instructions 1010a, such that one or more processors 1004 retrieve, from non-transitory memory, and load aspects of instruction 1010a into instructions 1010b stored in memory 1006 as needed. One or more processors 1004 may also obtain parameters 1012, e.g, from non-transitory memory 1008, from a user or the like, and store them in memory space 1002. Memory space 1002 may also include various data store space 1014 for holding various intermediate data used during execution of instructions 1010a. Memory space 1002 may also store, e.g., patch data structure 1014. Similarly non-transitory memory 1008 may store data structures generated during execution of instructions 1010a, e.g., patch data structure 1014 may also be stored in non-transitory memory 1008.

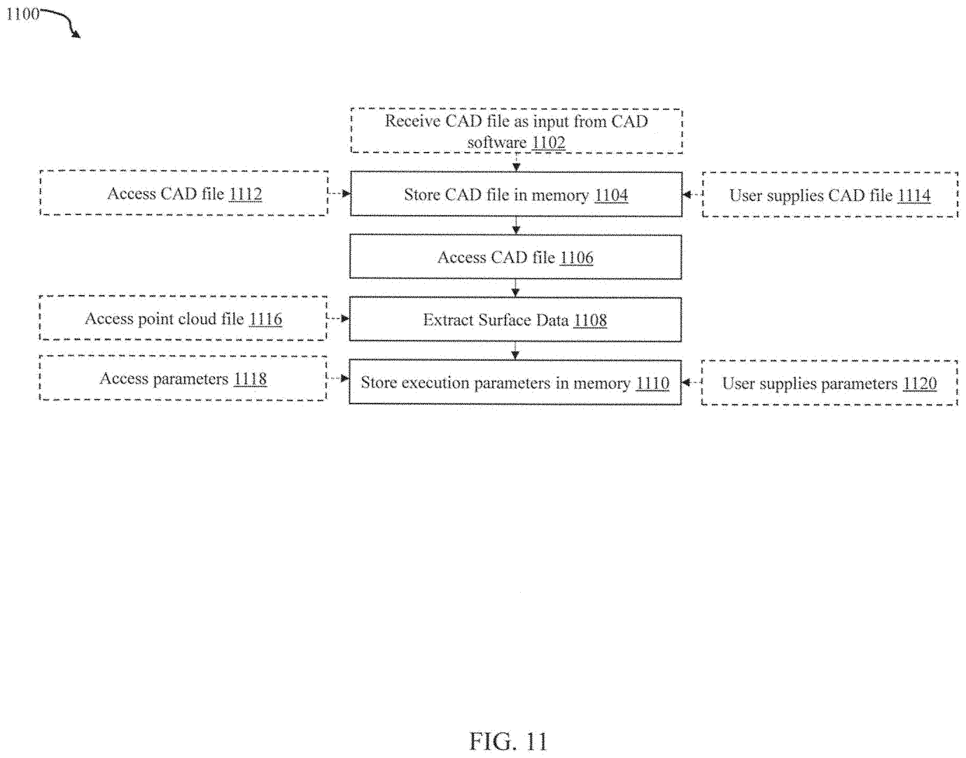

FIG. 11 illustrates an exemplary process 1100 in accordance with this disclosure. In optional step 1002, a CAD file may be received as input from a CAD software tool. A CAD software tool may be retrieved from storage or accessed, in step 1106, by a field simulator in accordance with this disclosure. In step 1108, surface data, e.g. CAD patch data, materials data, curvature data, or the like, is extracted and may be stored in data. In step 1110, various execution parameters may be stored in memory, e.g., memory 1006 or 1008. Execution parameters, or run parameters, may include node number parameters, order parameters, proximity tolerance parameters, residual tolerance parameters. Such parameters may be accessed in step 1118, e.g., from memory, from a configuration file, from a database, or the like. Alternatively, execution parameters may be supplied by a user in step 1120, e.g., via a user interface. Also, rather than receiving a CAD file, e.g., directly from a CAD tool, a CAD file may alternatively be accessed in step 1112, or a user may supply a CAD file in step 1114.

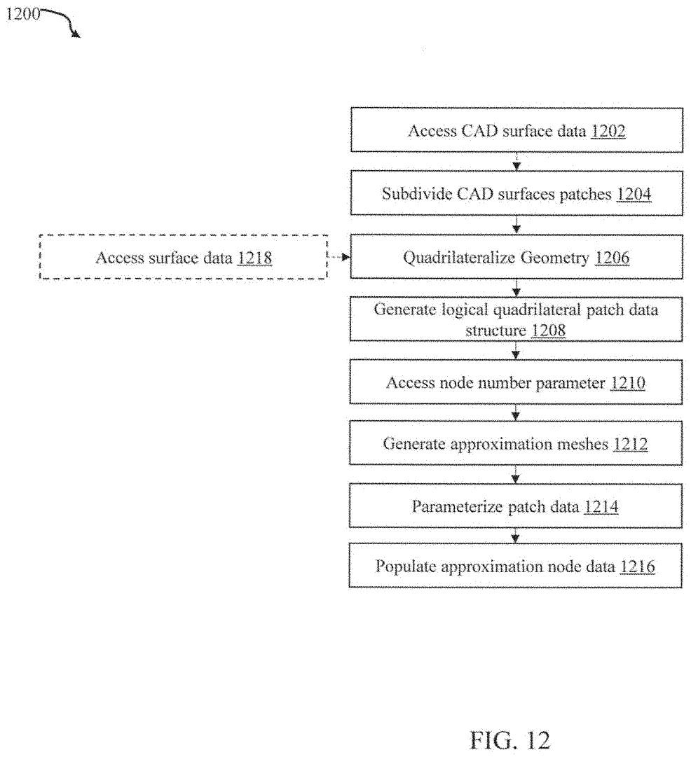

FIG. 12 illustrates an exemplary process 1200 in accordance with this disclosure. In step 1202 CAD surface data is accessed. CAD surface patches may be further divided in step 1204 to obtain additional CAD surface patches. This may be desirable if CAD surface patches are not logically quadrilateral, or in order to improve efficiency of simulation as discussed further below. In step 1206, patches that are not logically quadrilateral may be logically quadrilateralized into LQ patches. Also, rather than operate on a CAD surface, other surface data may be accessed directly in step 1218, e.g. surface data generated from a three dimensional scanner or a point cloud. In either case, in step 1206, LQ patches are generated. In step 1208, a patch data structure is generated to include various data associated with each LQ patch. Such data may include various data obtained from, e.g., a CAD file. In embodiments a patch data structure is configured to store data such as field subcomponents, values of first derivatives and second derivatives of changes of variables, Jacobian, coordinates, parameters approximation weights, approximators. In step 1210 a node number parameter is accessed, and in step 1212 approximation meshes are generated for each LQ patch and stored, e.g., in a patch data structure. In step 1214, each LQ patch is parametrized and parametrization data may be generated for each approximation node in each approximation mesh and stored in step 1216, e.g., in a patch data structure, thereby populating approximation node data.

FIG. 13 illustrates aspects 1300 of patches in accordance with this disclosure. A physical object 1302 is represented in a CAD data structure as a set of non-overlapping patches 1304, 1306, 13014. Patch structure 1308 is an exemplary smooth mapping and dividing of CAD patch 1304 into a set of LQ patches, each having four sides. Observe in patch structure 1308 various spaces, e.g., 1316 and 1318, respectively corresponding to CAD patches 1306 and 1314, resulting from a smooth mapping and subdividing process in accordance with this disclosure. Having been smooth mapped and divided, discretized patch structure 1310 illustrates each LQ patch of patch structure 1308 is then discretized by generating a set of approximation meshes corresponding to each LQ patch in patch structure 1308. Structure 1312, for illustrative purposes, illustrates how each discretized LQ patch in structure 1310 could be mapped back onto a surface of a physical object 1302 described by a CAD design file.

FIG. 1400 illustrates an approximation mesh 1400 in accordance with this disclosure. An approximation mesh is defined for (s,t)∈[−1,1]², and is defined by two orthogonal single dimensional meshes giving rise to orthogonal sets of lines, e.g., 1402a, 1402b in an s direction and 1404a, 1404b in a t direction, defining intersections of orthogonal lines, 1406, which are referred to as approximation nodes, and are identifiable by an s,t pair (or u,v after a change of variables). As depicted approximation mesh 1400 is a Chebyshev mesh, which is used in a preferred embodiment. Alternative, different approximation meshes may be used including equi-spaced meshes, Gauss meshes, Gauss-Legendre, or the like.

FIG. 15a illustrates an exemplary process 1500 in accordance with this disclosure. In step 1502, an LQ patch lying on an edge of a physical object is identified. In embodiments, edges are determined by examining curvature or derivatives of curvature at points on a surface associated with each LQ to identify an edge, like an edge of a wing, an edge of a cube, or an edge of a thin disc. Having identified an edge, a corresponding LQ reference patch is accessed at 1504, and an edge deformation change of variables is performed at 1506. In embodiments an edge deformation is carried out upon each reference patch, where an edge deformation is a process that determines for each LQ patch whether an edge is present. In embodiments, LQ patches must be generated such that an edge of a physical object falls on an edge of an LQ patch. An edge deformation process may then perform a change of variables that does not deform patches having no edges, while performing an edge smoothing change of variables on each edge of each LQ patch lying on an edge of a physical object, i.e. a LQ patch may include more than one edge. An edge smoothing change of variables is one which has a vanishing derivative as it approaches an LQ patch edge corresponding to a physical object edge. In step 1508, each edge patch approximation mesh is stored. FIG. 15b illustrates a plot 1520 showing aspects of an edge deformation process applying an edge deformation change of variables in accordance with an edge deformation process described in relation to step 620 above. FIG. 15b plots u vs. ηₛ^{q}(u), thus, illustrates a one-dimensional mapping, a plot of v vs. ηₜ^{q}(v), would appear the same. Line 1522 illustrates results of an exemplary edge deformation change of variables when an edge lies at u=−1. Line 1524 illustrates results of an exemplary edge deformation change of variables when no edge is present at either u=+1 or u=−1. Line 1526 illustrates results of an exemplar edge deformation change of variables when an edge lies at both u=+1 and u=−1. Line 1528 illustrates results of an exemplar edge deformation change of variables when an edge lies at u=+1.

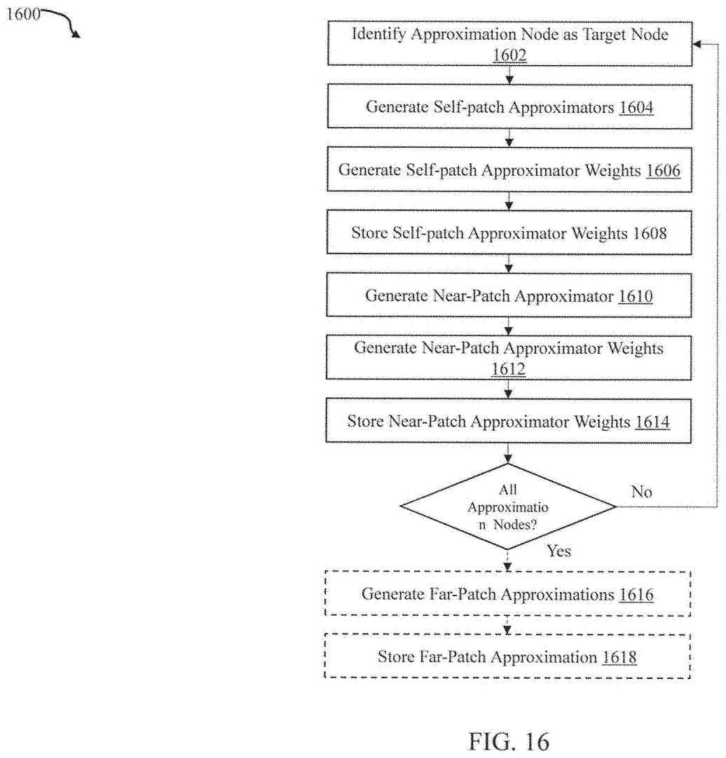

FIG. 16 illustrates an exemplary process 1600 in accordance with this disclosure. In step 1602 a target node, or observation node, is identified, e.g., in a q^{th} patch. In step 1604, in reference to a target node, self-patch approximators are generated in accordance with this disclosure. In step 1606, approximator weights are generated based on each self-patch approximator, and in step 1608 each self-patch approximator weight is stored. Optionally each self-patch approximator may also be stored. In step 1610, for qth patch near a target node, near-patch approximators are generated in accordance with this disclosure, and near patch approximator weights are generated in step 1612. Each near patch approximator is stored in step 1614. Optionally, each near-patch approximator may also be stored. Steps 1610, 1612, and 1614 may be repeated for each patch near a target node. Steps 1602, 1604, 1606, 1608, 1610, 1612, 1614 are repeated for each approximation node until each approximation node in each qth patch (i.e. over an entire surface) is treated as a target node. Optionally, far-patch approximations may also be generated in step 1616 and stored in step 1618.

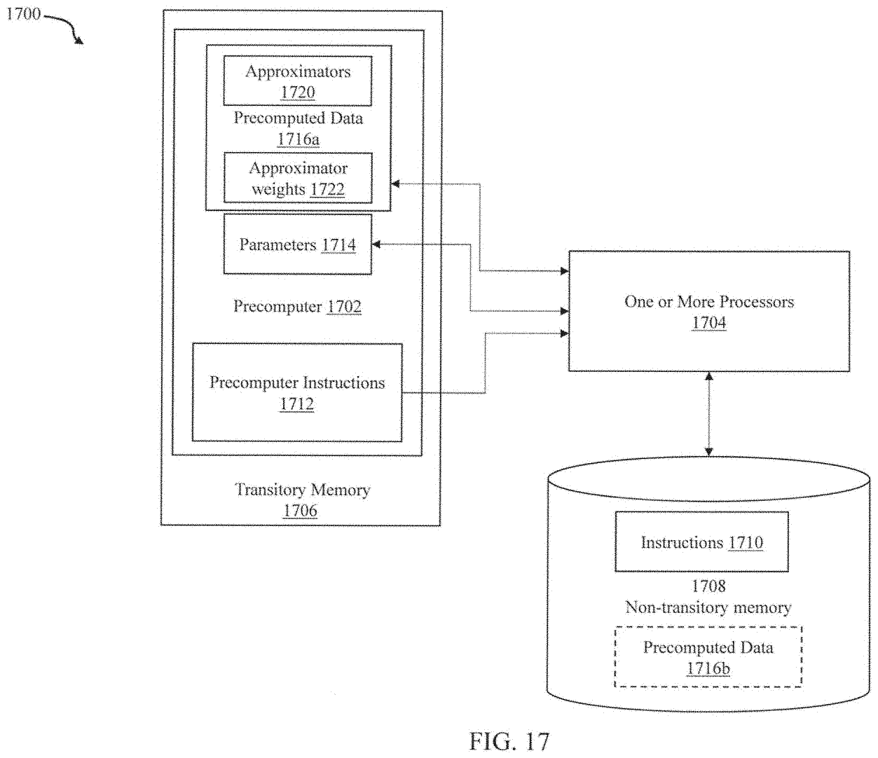

FIG. 17 illustrates aspects of a precomputer process, which precomputes various values for use in generating an initial surface field subcomponent and improved surface field subcomponents in accordance with this disclosure. A precomputer system includes a memory space 1702 allocated to a precomputer that includes precomputer instructions 1712 loaded into transitory memory 1706 by one or more processors 1704. Precomputer instruction 1712 may be a portion of instructions 1710, e.g., which may be an embodiment of a field simulator. e.g. 502, 702a, 702b, 702c, 702d. Executing precomputer instructions 1712, one or more processors 1704 may generate precomputed data 1716a, 1716b, which may be respectively stored in transitory memory 1706 or non-transitory memory 1708. Exemplary precomputer instructions 1712 may execute process 1600 for example. Precomputer instruction 1712 may include instructions that call on one or more other processes to perform various aspects of FIG. 16, or precomputer instructions may include for performing, e.g., generating self-patch approximators and near-patch approximators. One of skill will appreciate that the specific organization of instructions between different software modules carrying out processes in accordance with this disclosure is within the capability of one of ordinary skill.

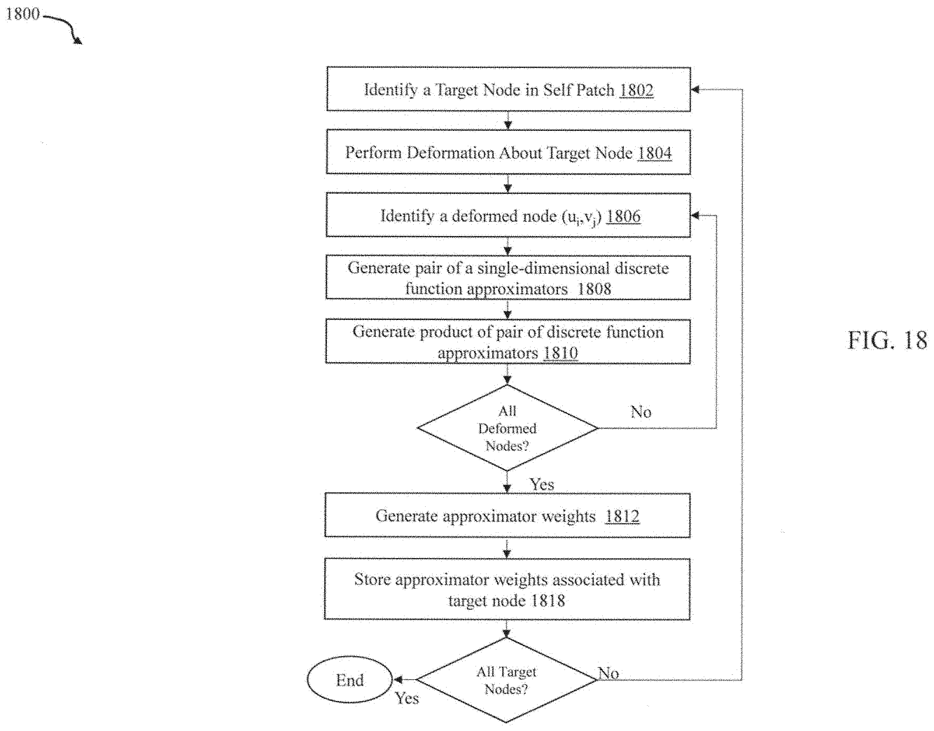

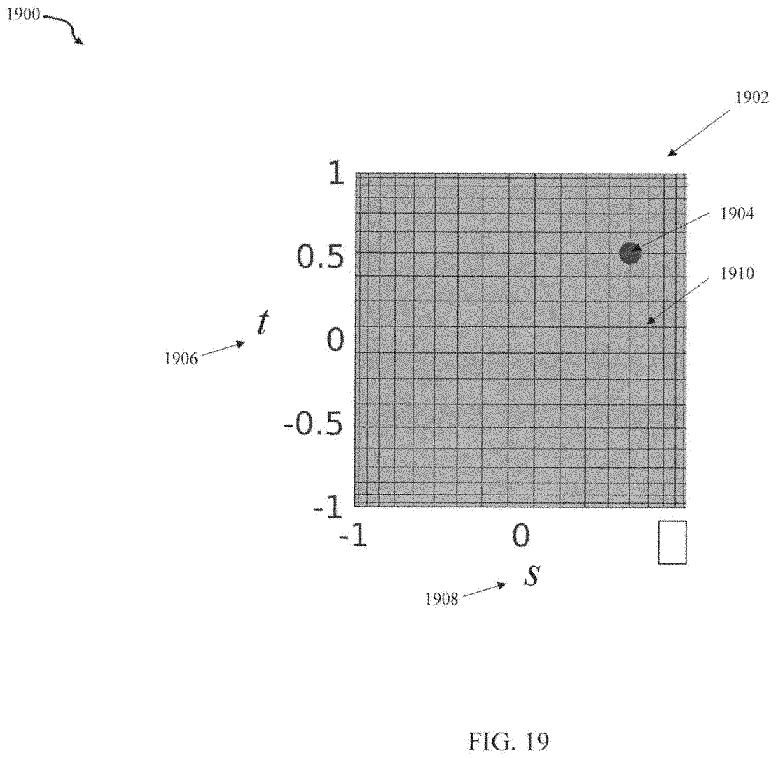

FIG. 18 illustrates an exemplary process in accordance with this disclosure. In step 1802, a target node is identified, e.g., a target node 1904 on reference patch 1902 as illustrated in FIG. 19 illustrating aspects of an approximation mesh 1910 in accordance with this disclosure. Reference patch 1902 is a Chebyshev patch including a Chebyshev mesh 1910 for illustrative purposes. In step 1804 a deformation is carried out about a target node, e.g., as illustrated in FIG. 20 showing a target node 2006b in a reference patch 2010 after a deformation according to a deformation change of variables is performed to obtain a deformed mesh having nodes defined in u,v. FIG. 20 is discussed further below. In step 1806, a deformed node uᵢ, vⱼ. e.g., deformed node 2016, is identified, and a pair of single-dimension discrete function approximators, e.g., Tₘ(u)Tₙ(v), is generated at 1808, and a product of single-dimension discrete function approximators, i.e. a self-patch approximator, is generated in 1810 and stored in a memory. These steps 1806, 1808, 1810 are performed for each deformed node, i.e. for each uᵢ,vⱼ pair in a deformed mesh associated with a respective target point. In step 1812, self-patch approximator weights as generated for each self-patch approximator generated with respect to a target node, and each such approximator weight is stored in step 1818. These steps 1802, 1804, 1806, 1808, 1810, 1812, 1818 are repeated for each approximation node in each qth patch. In embodiments, this may be done in a single process for all approximation nodes, or may be done in separate steps for each qth patch, as one of skill will appreciate upon reading this disclosure.

FIG. 19 illustrates aspects 1900 of an approximation patch 1902 defined over s 1908 and t 1906. Approximation patch 1902 as illustrated is a Chebshev patch, but alternatively may be any suitable mesh, e.g., equi-spaced meshes, Gauss meshes, Gauss-Legendre, or the like. While illustrated on s,t∈[−1,1]², one will appreciate upon reading this disclosure that had an edge deformation procedure been performed in accordance with an edge deformation as described with reference to FIG. 15b, assuming approximation patch 1902 does not lie on an edge, approximation patch would appear the same while being defined on u,v∈[−1,1]².

FIG. 20 illustrates various aspects 2000 of techniques in accordance with this disclosure. A three dimensional spherical physical object 2002, has been divided into six surface patches 2002a, 2002b, 2002c, 2002d, 2002e, 2002f. For illustrative purposes, approximation meshes have been drawn on surface patches 2002b, 2002c, 2002d, 2002e (2002f is not visible). And a deformation mesh is illustrated on 2002a, showing target point 2006a. Surface patch 2002a corresponds to reference patch 2010 defined on u,v∈[−1,1]². Target point 2006a corresponds to target node 2006b in reference patch 2010. A deformation change of variables has been carried out about target node 2006b, and for illustrative purposes this is also illustrated on surface patch 2002a. A deformation change of variables in a self-patch case may be based on a sin h function, a piecewise polynomial function whose derivatives vanish at a target point, or any suitable function that vanishes exponentially at a target point. In a preferred embodiment, as illustrated, a rectangular-polar change of variables is performed as a deformation change of variables. As illustrated in FIG. 20 a deformation change of variables is performed using a rectangular-polar change of variables, examples of a deformation change of variables are deformation change of variables 2012 and deformation change of variables 2014. Each of deformation change of variables 2012 and 2014 is a polar-rectangular change of variables.

A rectangular-polar change of variables may be constructed on a basis of a one-dimensional change of variables satisfying the following relationships:

$${ξ}_{α} ( τ ) = \{ \begin{matrix}α + ( \frac{sgn ( τ ) - α}{π} ) w ( π [ τ ] ) , & for α \neq 1 , \\ α - ( \frac{1 + α}{π} ) w ( π \vert \frac{τ - 1}{2} \vert ) , & for α = 1 , \\ α + ( \frac{1 + α}{π} ) w ( π \vert \frac{τ + 1}{2} \vert ) , & for α = - 1.\end{matrix} \\ where \\ w ( τ ) = 2 π \frac{{[ v ( τ ) ]}^{p}}{{[ v ( τ ) ]}^{p} + {[ v ( 2 π - τ ) ]}^{p}} , 0 \leq τ \leq 2 π , \\ v ( τ ) = ( \frac{1}{p} - \frac{1}{2} ) {( \frac{π - τ}{π} )}^{3} + \frac{1}{p} ( \frac{τ - π}{π} ) + \frac{1}{2} .$$

A rectangular-polar change of variables in accordance with the above relationships is referred to as a principle rectangular-polar change of variables.

One will appreciate that in the expression above, p, dictates an order of approximation accuracy and may be adjusted. A resulting error can be estimated as a product of a fixed number and the p^{th} power of the mesh size. In embodiments, p is predetermined, but in other embodiments p may be supplied by a user. Values of p as low as p=2 are often found to be adequately useful, for accuracies of the order of 1%, but values of p of the orders of four to six or above can enable significantly faster convergence and lower computing costs for higher accuracies (as demonstrated e.g. in FIG. 46b).

As noted, function ω(τ) may alternatively be sin h function, a piecewise polynomial function whose derivatives vanish at a target point, or any suitable function that vanishes exponentially at a target point. In a preferred embodiment relationships based on ω(τ) above is used. This change of variables is preferred, because employing Fejér's first quadrature rule now yields:

$${β}_{n , m}^{q , 𝓁} \approx \text{?} {H}^{q} ( {r}_{𝓁} , {u}_{i}^{q , 𝓁} , {v}_{j}^{q , 𝓁} ) {J}^{q} ( {u}_{i}^{q , 𝓁} , {v}_{j}^{q , 𝓁} ) {T}_{n} ( {u}_{i}^{q , 𝓁} ) {T}_{m} ( {v}_{j}^{q , 𝓁} ) {μ}_{i}^{u , q , 𝓁} {μ}_{j}^{v , q , 𝓁} {w}_{i} {w}_{j}$$

$$where$$

$${u}_{i}^{q , 𝓁} = ξπ \text{?} ( {x}_{i} ) , for i = 1 , … , {N}_{β}^{u} , \\ {v}_{j}^{q , 𝓁} = ξπ \text{?} ( {x}_{j} ) , for j = 1 , … , {N}_{β}^{v} , \\ \text{?} \text{indicates text missing or illegible when filed}$$

are the new quadrature points, and where

$${μ}_{i}^{u , q , 𝓁} = \frac{d \text{?}}{d τ} ( {x}_{i} ) , for i = 1 , … , {N}_{β}^{u} , \\ {μ}_{j}^{v , q , 𝓁} = \frac{d \text{?}}{d τ} ( {x}_{j} ) , for j = 1 , … , {N}_{β}^{v} , \\ \text{?} \text{indicates text missing or illegible when filed}$$

denote the corresponding change-of-variable weights. This is also advantageous over alternatives, because using sufficiently large numbers of discretization points, e.g., large N_{β}^{u} and N_{β}^{v}, along the u, v directions to accurately resolve I^{q}(r), all singular and near-singular problems may be treated with high-accuracy under discretizations that are not excessively fine. It will be appreciated that a change of variables as describe in relation to FIG. 20 may be employed for self-patch and near-patch cases in process 600. As can be seen in reference patch 2010, a deformation approximations change of variables in accordance with this disclosure causes deformation nodes to bunch towards target node 2006b as can be seen by the tight bunching of lines 2018 and 2020.

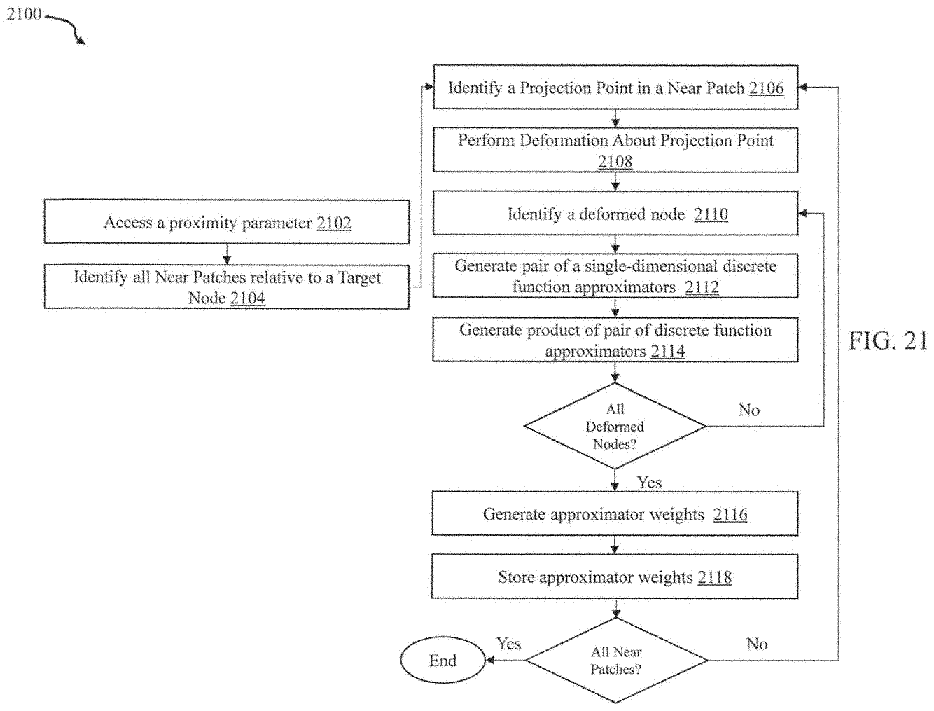

FIG. 21 illustrates an exemplary process in accordance with this disclosure. At step 2102 a proximity parameter is accessed, and in step 2104 all near patches relative to a target node are identified in step 2104. FIG. 22 illustrates aspects of a near patch. For an observation point 2204, or target point, associated with a point on a surface of a physical object, e.g, wing 2202, a self-patch refers to a patch in which a target point is found. A proximity parameter is a distance characterizing near patches and far patches. Any patch, other than a self-patch, e.g., 2206, that lies within a proximity parameter value distance from a target point, e.g., 2204 is a near-patch. For example, in FIG. 22, relative to target point 2204, patches 2210 and 2212 are near-patches, 2206 is a self-patch and all other patches are far patches, e.g., patches 2218, 2220. For illustrative purposes, a proximity parameter exceeds distance 2214, which is sufficiently small to be less than a proximity parameter.

In step 2106 a projection point is identified in a near-patch relative to a target node. FIG. 22 illustrates two projection points 2212 and 2216 each lying in a respective near-patch 2208 and 2210. FIG. 22 further illustrates that a near patch need not be adjacent to a target node self-patch, rather, FIG. 22 illustrates a cross section of a three dimensional object, e.g., a wing, and near patch 2212 lies on an opposite side of wing 2202 from target point 2204. FIG. 23 further illustrates a process of locating a near patch 2308 relative to a target node 2304, located in patch 2302, where line 2306 is intended to illustrate a proximity parameter value in all directions about target node 2304 such that any other patch that falls within a distance defined by a proximity parameter value is a near patch, e.g., near-patch 2308. For purely illustrative purpose near patch 2308 is outlined in a dotted line. A projection node may be identified, as discussed above in reference to process 600, by any suitable minimization process. In embodiments Newton's method may be used, and in a preferred embodiment a golden section search algorithm is employed to locate a projection node in projection patch.

In step 2108 a near-patch deformation is performed about a projection node in accordance with this disclosure to obtain a near-patch deformed mesh in a reference patch associated with a surface patch near a target point. A near-patch deformation may be performed according to any suitable method, and is preferably a same deformation as applied in a self-patch case as described above in reference to FIG. 18. Aspects 2400 of a near-patch deformation about a projection node are illustrated in FIG. 24. For a target point 2402, a near patch 2404a is identified corresponding to a near-patch reference patch 2404b. Projection node 2406 lies in reference patch 2404b, and a near-patch deformation is illustrated in orthogonal lines about projection node 2406b, e.g., lines 2408 and 2410. In a preferred embodiment a near-patch deformation is performed by a near-patch change of variables, which is preferably a rectangular-polar change of variables in accordance with this disclosure, as discussed above in reference to FIG. 20. A near-patch deformation change of variables in a near-patch case may be based on a sin h function, a piecewise polynomial function whose derivatives vanish at a target point, or any suitable function that vanishes exponentially at a target point. In a preferred embodiment, as illustrated, a rectangular-polar change of variables is performed as a near-patch deformation change of variables. In preferred embodiments a near-patch change of variables is a same rectangular-polar change of variables as used in a self-patch case.

In step 2110 a deformed node is identified, e.g, 2420, and in step 2112 a pair of near-patch single-dimension discrete function approximators, e.g., Tₘ(u)Tₙ(v). In step 2114, a product of near-patch single-dimension discrete function approximators, i.e. a near-patch approximator, is generated in and stored in a memory. These steps 2110, 2112, 2114 are performed for each deformed node about a project node, i.e. for each uᵢ,vⱼ pair in a near-patch deformed mesh associated with a respective projection node. In step 2116, near-patch approximator weights are generated for each near-patch approximator generated with respect to a project node, and each such near-patch approximator weight is stored in step 2118. These steps 2106, 2108, 2110, 2112, 2114, 2116, 2118 are repeated for a projection node in each near patch relative to a target point in a q^{th} patch. In embodiments, this may be done in a single process for all approximation nodes, or may be done in separate steps for each qth patch, as one of skill will appreciate upon reading this disclosure.

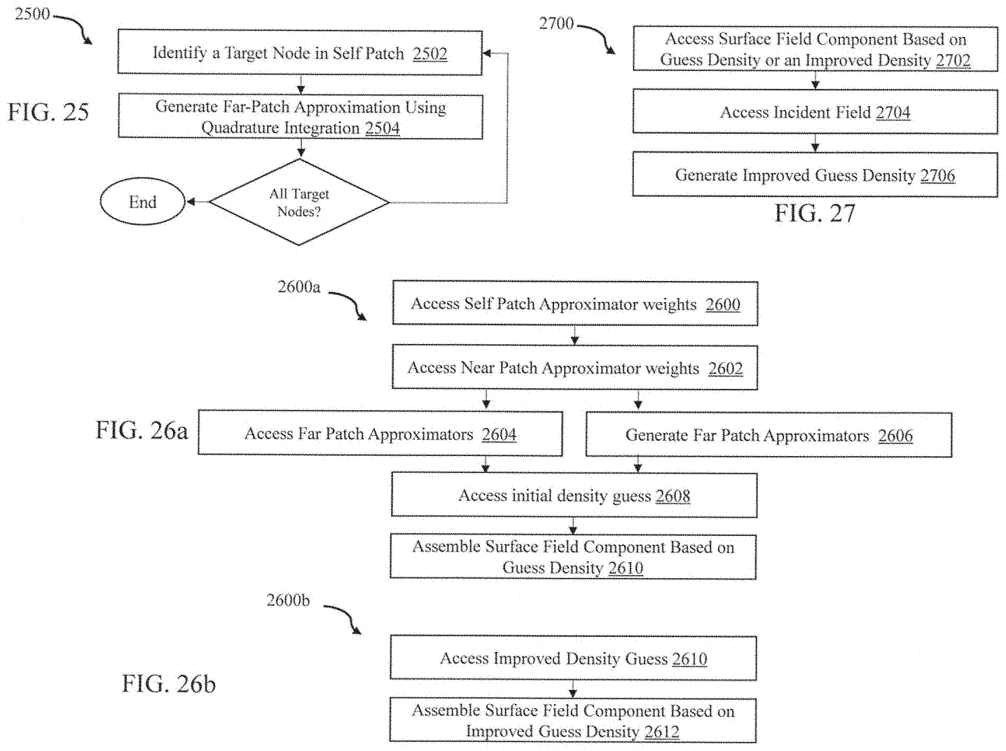

FIG. 25 illustrates an exemplary process in accordance with this disclosure. In step 2502 a target node is identified. In step 2504 a far-patch approximation is generated relative to a target node using a suitable quadrature integration method. Far field contributions to I^{q}(r) may be generated using a suitable quadrature technique to obtain far-patch contributions satisfying

$${l}^{q} = ( \text{?} ) \approx {\sum }_{j = 0}^{N \text{?} - 1} {\sum }_{i = 0}^{N \text{?} - 1} {H}^{q} ( r , {u}_{i} , {v}_{j} ) {J}^{q} ( {u}_{i} , {v}_{j} ) \frac{d \text{?}}{du} \frac{d \text{?}}{dv} {w}_{i} {w}_{j} {ϕ}^{q} ( {u}_{i} , {v}_{j} )$$

$$\text{?} \text{indicates text missing or illegible when filed}$$

where φ^{q}(ui, vj) is φᵢₙᵢₜᵢₐₗ^{q}(ui, vj). That is a guess density for ui, vj. For a far point, points in set Ω_{q}^{f}, far from an observation point r in a qth patch, an integrand containing a Green function is smooth and thus approximators and approximator weights are not required. Thus, such an integral can be can be accurately evaluated utilizing any suitable high-order quadrature rule. In a preferred embodiment Fejér's first quadrature rule is utilized to generate far-field contributions, because Fejér's effectively exploits a discrete orthogonality property satisfied by Chebyshev polynomials in a Chebyshev mesh, and Fejér's also allows straightforward computation of two-dimensional Chebyshev transforms relied upon in a preferred embodiment of self-patch and near-patch techniques described above. Thus, in embodiments a set of quadrature nodes and weights are generated in accordance with relationships as follows:
for a discretization using N points, quadrature nodes are generated in accordance with this form:

$${x}_{j} = cos ( π \frac{2 j + 1}{2 N} ) , j = 0 , … , N - 1 ,$$

and quadrature weights are generated in accordance with this form:

$${w}_{j} = \frac{2}{N} ( 1 - 2 {\sum }_{\text{?} = 1}^{[ N / 2 ]} \frac{1}{\text{?}} cos ( \text{?} π \frac{2 j + 1}{N} ) ) , j = 0 , … , N - 1 , \\ \text{?} \text{indicates text missing or illegible when filed}$$

where uᵢ, vⱼ above satisfy a Cartesian-product discretization {uᵢ=xᵢ|i=0, . . . , Nᵤ^{q}−1}×discretization {vⱼ=xⱼ|j=0, . . . , Nᵥ^{q}−1}. Alternatively, a product as follows may be precomputed and stored, but need not be (i.e., it may be generated when assembling an initial guess):

$${\sum }_{j = 0}^{N \text{?} - 1} {\sum }_{i = 0}^{N \text{?} - 1} {H}^{q} ( r , {u}_{i} , {v}_{j} ) {J}^{q} ( {u}_{i} , {v}_{j} ) \frac{d \text{?}}{du} \frac{d \text{?}}{dv} {w}_{i} {w}_{j}$$

$$\text{?} \text{indicates text missing or illegible when filed}$$

for each combination of r, ui, vj. This product may be referred to as a far-patch approximator weight.

FIG. 26a illustrates exemplary processes 2600a for generating an initial surface field component in accordance with this disclosure. In step 2600 self-patch approximator weights may be accessed. In step 2602 near-patch approximator weights may be accessed. In step 2604 far patch approximator weights may be accessed, or alternatively in step 2606 far patch approximators may be generated. In step 2608 an initial density guess is accessed, and a surface field component is generated based on near-patch approximator weights, self-patch approximator weights, far-patch approximator weights, and an initial guess.

FIG. 26b illustrates exemplary processes 2600b for generating an improved surface field component in accordance with this disclosure. In step 2610 an improved density guess 2610, e.g., one generated by a linear system engine based on an initial guess, or e.g., generated based on a previous improved density guess, and in step 2612 an improved surface field component is assembled based on an improved density guess.

FIG. 27 illustrates an exemplary process 2700 in accordance with this disclosure. Having a surface field component assembled using an initial guess density or an improved guess density stored in a memory, in step 2702 a surface field component is accessed. In step 2704 an incident field is accessed and in step 2706 an improved density guess is generated 2706, e.g., using a linear system engine. In embodiments, a linear system engine is any suitable linear system engine; in a preferred embodiment a linear system engine is GMRES or an equivalent (as discussed above).

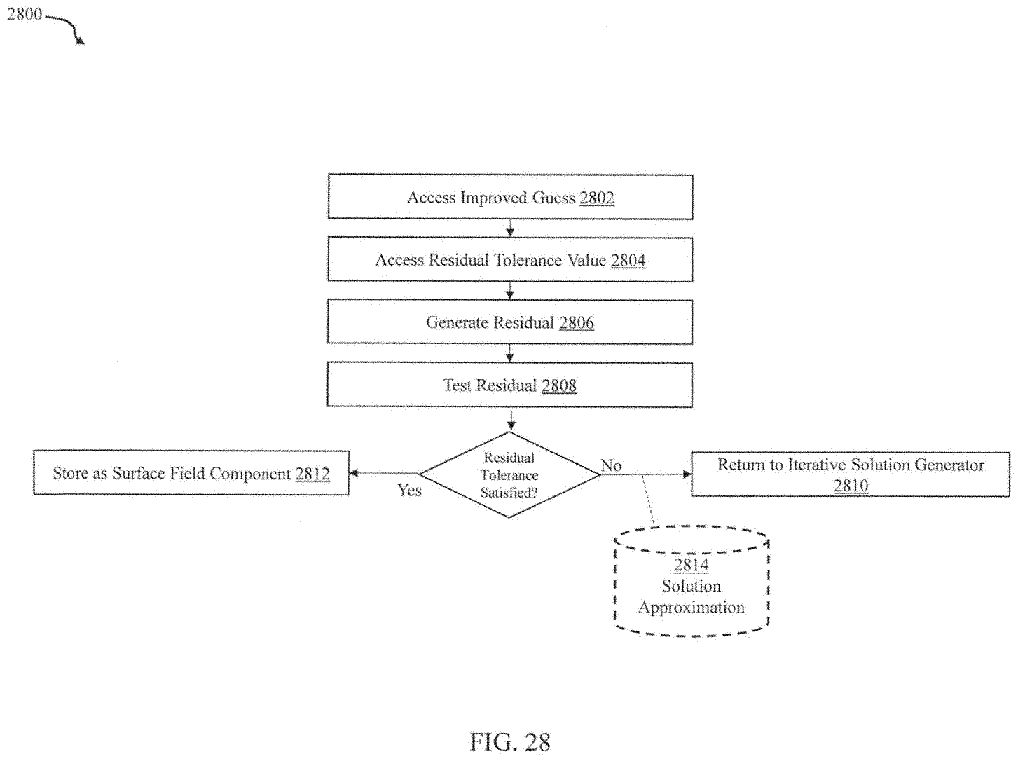

FIG. 28 illustrates an exemplary process 2800 in accordance with this disclosure. An improved guess is accessed in step 2802. A residual tolerance parameter value is accessed in step 2804. In step 2806, a residual is generated in a form Ax-B. In embodiments a norm is generated as previously discussed. And in step 2808 a residual is tested, e.g., against a residual tolerance parameter value. If a residual does not satisfy a residual tolerance parameter, an improved guess is returned, as solution approximation 2814, to obtain a new guess, e.g., by returning to an iterative solution generator in step 2810. If a residual does satisfy a residual tolerance parameter, in 2812, an improved guess is stored as an accurate approximation of densities φ(r), for r on a scattering surface. Optionally a surface field component may also be stored in step 2812. Each return to iterative solution generate results in an iterative solution surface field component based on an improved density. Thus, process 2800 repeats until an iterative solution satisfies the residual tolerance.

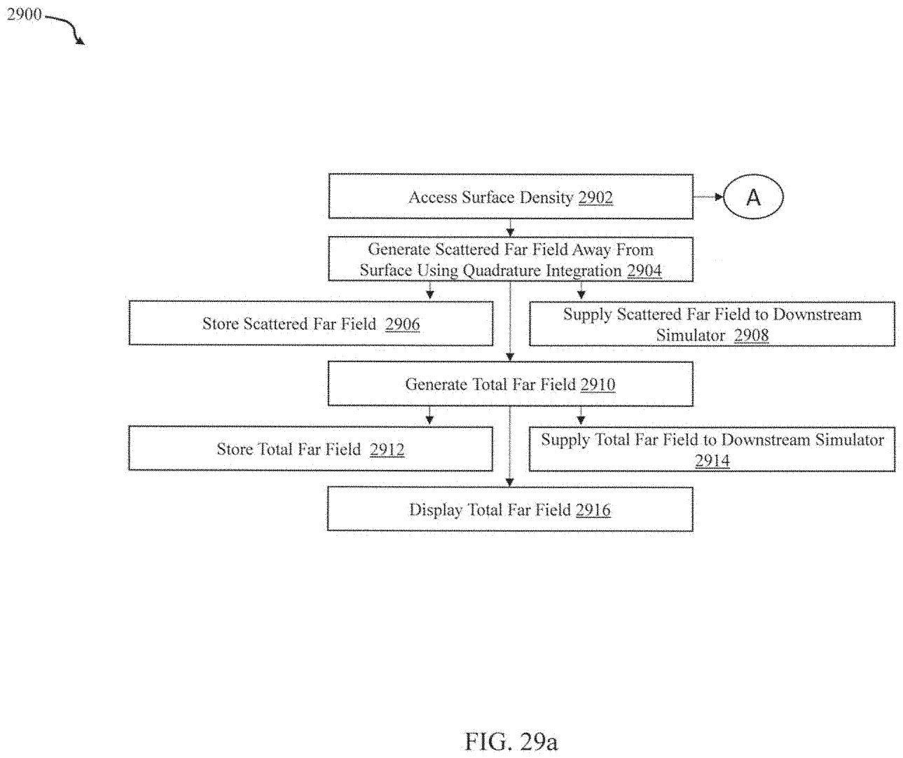

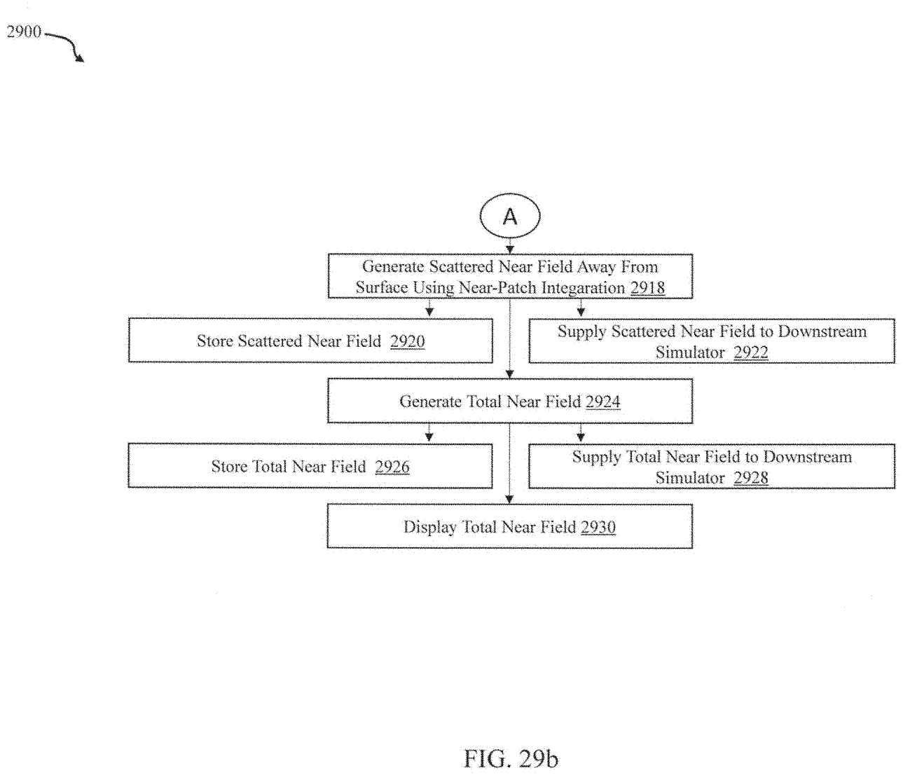

FIGS. 29a and 29b illustrate an exemplary process 2900. In step 2902 accurate surface densities are accessed. In step 2904 a scattered surface is generated in a far field away from a scattering object surface using a suitable quadrature technique. In embodiments Fejér's first rule quadrature is used. One of skill will appreciate that any suitable quadrature technique may be employed to generate a far field scattered field. In embodiments, at 2906 scattered far fields may be stored. In embodiments scattered far fields may be provide to downstream simulators in step 2908. In step 2910, a total far field is generated also using a suitable quadrature technique. In step 2912, a total far field is stored, or in step 2914 a total far field is supplied to a downstream simulator. Optionally a total far field may be displayed on a user interface in step 2916. In step 2918, a near scattered field may be generated using near-patch integration for a point r not on a surface but sufficiently close to a surface. In such a case a projection node is identified on a scattering object closest to near point r away from a surface, and near field contributions are generated in a same manner as described in reference to FIGS. 21-24, where r is away from a surface rather than in a q^{th} patch. In step 2920, a near scattered field is stored. In step 2922 a near scattered field is supplied to a downstream simulator. In step 2924 a total near field is generated. In step 2926 a total near field is stored, and in step 2928 a total near field is supplied to a downstream simulator. In step 2930, a total near field is displayed to a user, e.g., via a display.

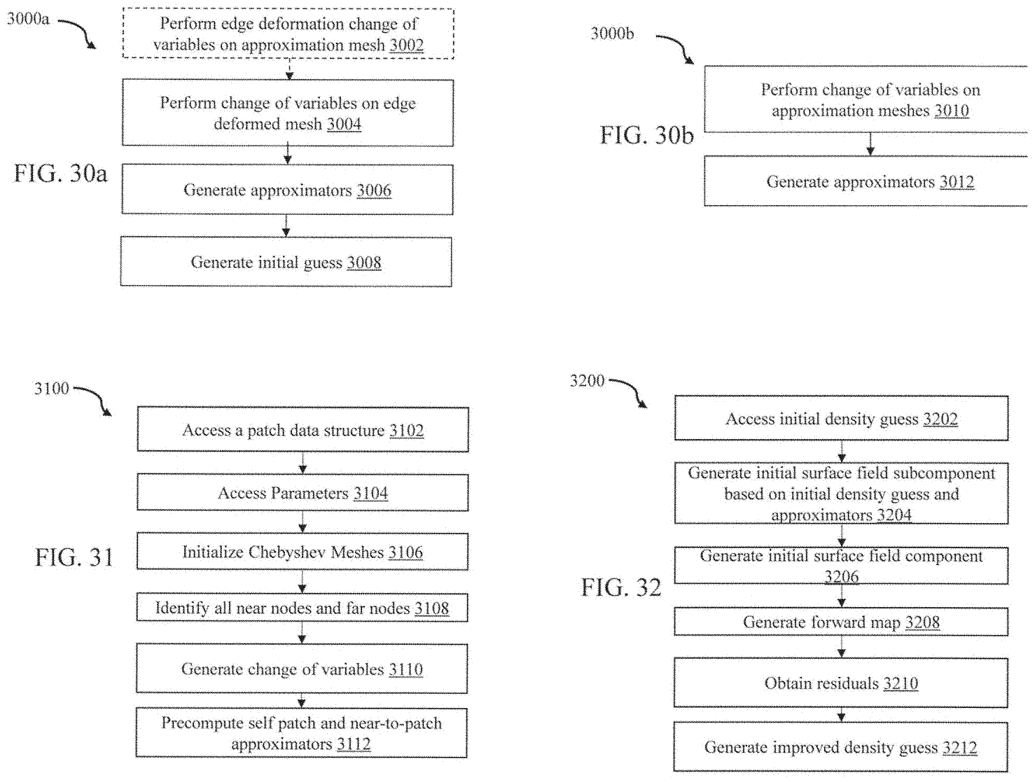

FIG. 30a illustrates an exemplary process 3000a in accordance with this disclosure. In step 3002 an edge deformation change of variables is performed on an approximation mesh. In embodiments, an edge deformation change of variables is an edge smoothing change of variables for patch edges associated with an edge of a physical object, and an approximation mesh is a Chebyshev mesh. In steps 3004 a deformation change of variables is performed on an edge deformed mesh. In embodiments, a deformation change of variables is a rectangular-polar change of variables. In step 3006, approximators are generated. In embodiments, approximators are generated based on pairs of Chebyshev polynomials. In step 3008, an initial guess is generated for densities, based on approximators.

FIG. 30b illustrates an exemplary process 3000b in accordance with this disclosure. In step 3010 a change of variables is performed on an approximation mesh, where the change of variables is a rectangular polar-change of variables and an approximation mesh is a Chebyshev mesh. In step 3012, approximators are generated based on Chebyshev polynomials.

FIG. 31 illustrates an exemplary process 3100 in accordance with this disclosure. In step 3102 a patch data structure is accessed. In step 3104 execution parameters are accessed. In step 3106. Chebyshev meshes are generated for each patch based on a discretization parameter of the execution parameters. In step 3108 a set of all near nodes and all far nodes is identified based on a proximity parameter value of the execution parameters. In step 3110 a change of variables is applied to a Chebyshev mesh. In step 3112, all self-patch approximators and all near-patch approximators associated with each approximation nodes in each Chebyshev mesh are precomputed (i.e. generated and stored).

FIG. 32 illustrates an exemplary process 3200 in accordance with this disclosure. In step 3202 an initial density guess is accessed. In step 3204 an initial surface field subcomponent is generated based on an initial density guess and approximators. In step 3206, an initial surface field component is generated. In step 3208 a forward map is generated based on an initial surface field component. In step 3210 a residual is generated, and in step 3212 when a residual fails to satisfy a residual tolerance value, an improved density guess 3212 is generated.

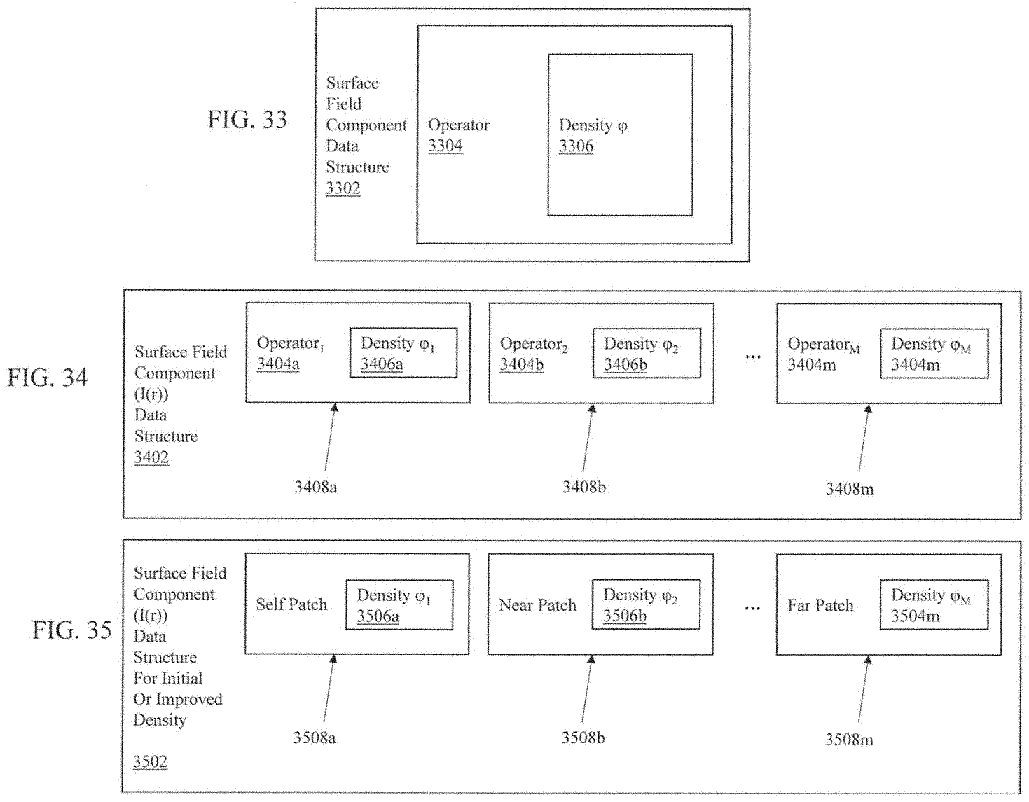

FIG. 33 illustrates a surface field component data structure 3302, which includes an integral operator 3304 applied to a density 3306. FIG. 34 further illustrates aspects of a surface field component data structure 3402. A surface field component data structure comprises surface field subcomponent data structures, e.g., 3408a, 3408b, . . . 3408m, each of which comprises an operator 3404a, 3404b, . . . 3404m applied to density 3406a, 3406b, . . . , 3406m. A surface field component data structure corresponding to a particular r, e.g., 3402, may be a sum of entries of a vector having M entries. One of skill will appreciate an alternative vector may correspond to a particular q^{th} patch, in which case will be a vector having entries corresponding to various points r on a surface. Alternatively, a surface field component data structure could be a matrix in q and r. One will appreciate upon reading this disclosure that there are many ways a surface field component data structure may be organized in accordance with this disclosure.

FIG. 35 illustrates an exemplary case of a surface field component data structure 3502 illustrating that various operators applied to densities correspond to self-patch cases 3508a, near-patch cases 3508b, and far-patch cases 3580m.

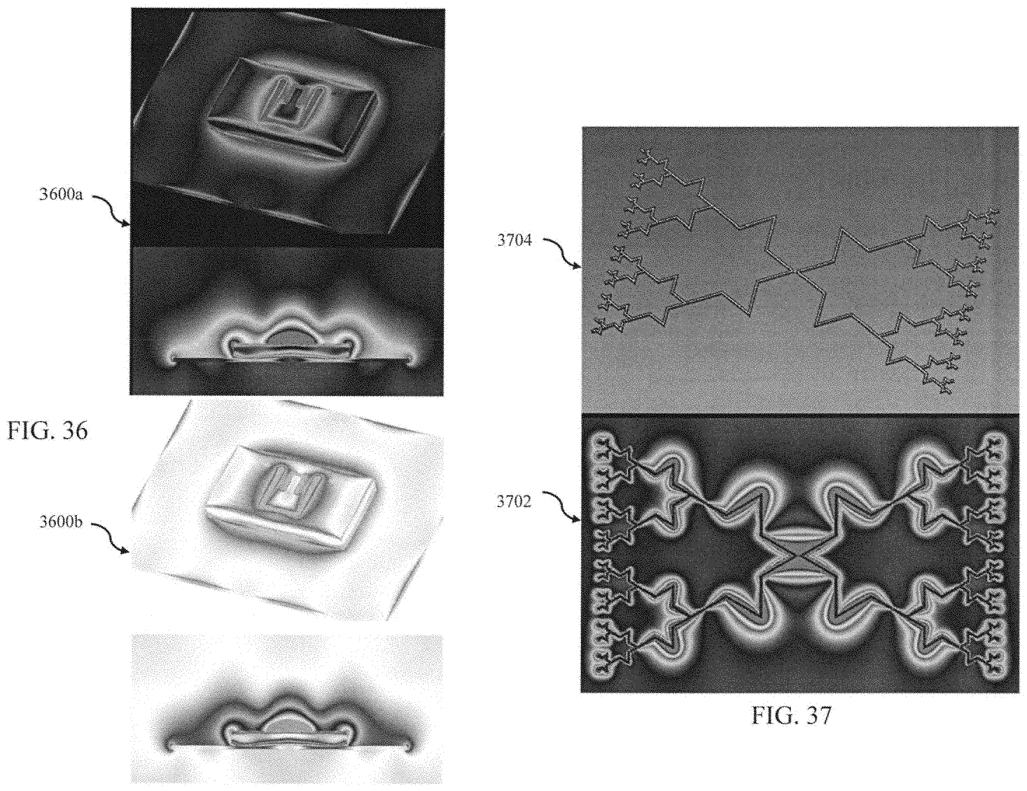

FIG. 36 illustrates exemplary total EM fields 3600a, 3600b arising from a patch antenna as generated in accordance with this disclosure. Illustrations here are shown in normal 3600a and inverted 3600b color scheme for exemplary purposes as one may color scheme may be reproduced in a better form than another.

FIG. 37 illustrates exemplary total EM fields 3702 arising from a strip antenna 3704 as generated in accordance with this disclosure.

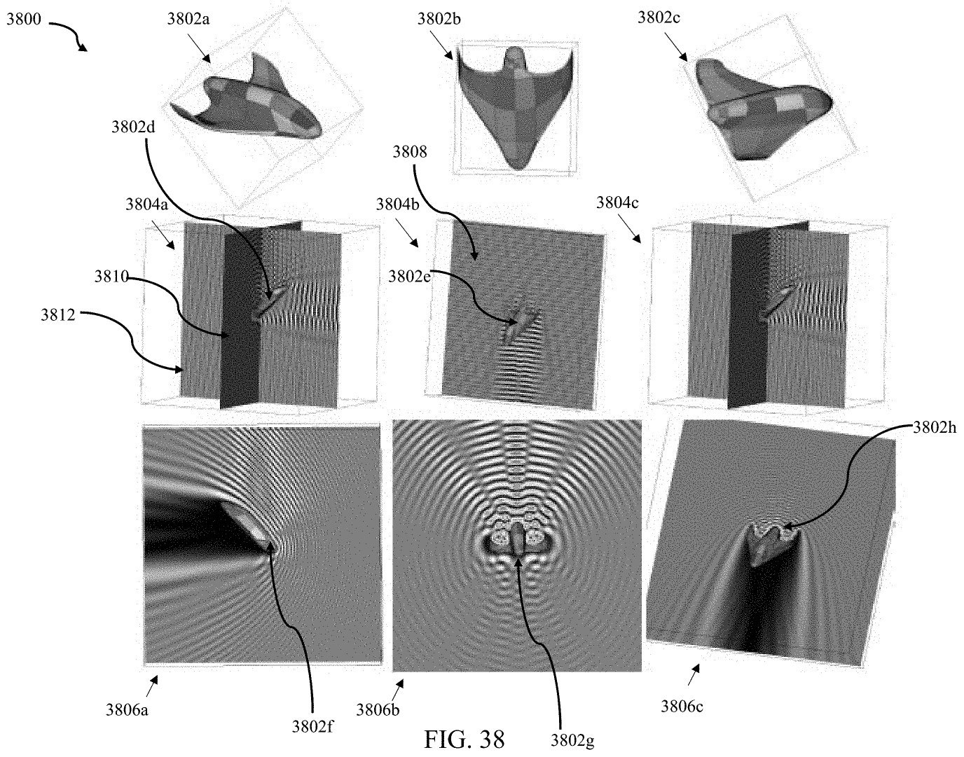

FIG. 38 illustrates various vies of a scattered and total acoustic field arising from an incident field striking a glider 3802, shown in various views 3802a, 3802b, 3802c, 3802d, 3802e, 3802f, 3802g, 3802h, Illustrations 3804a, 3804b, 3804c illustrate views of a total field, in multiple planes 3810 and 3812. Illustrations 3806a, 3806b, 3806c illustrate views of a scattered acoustic field.

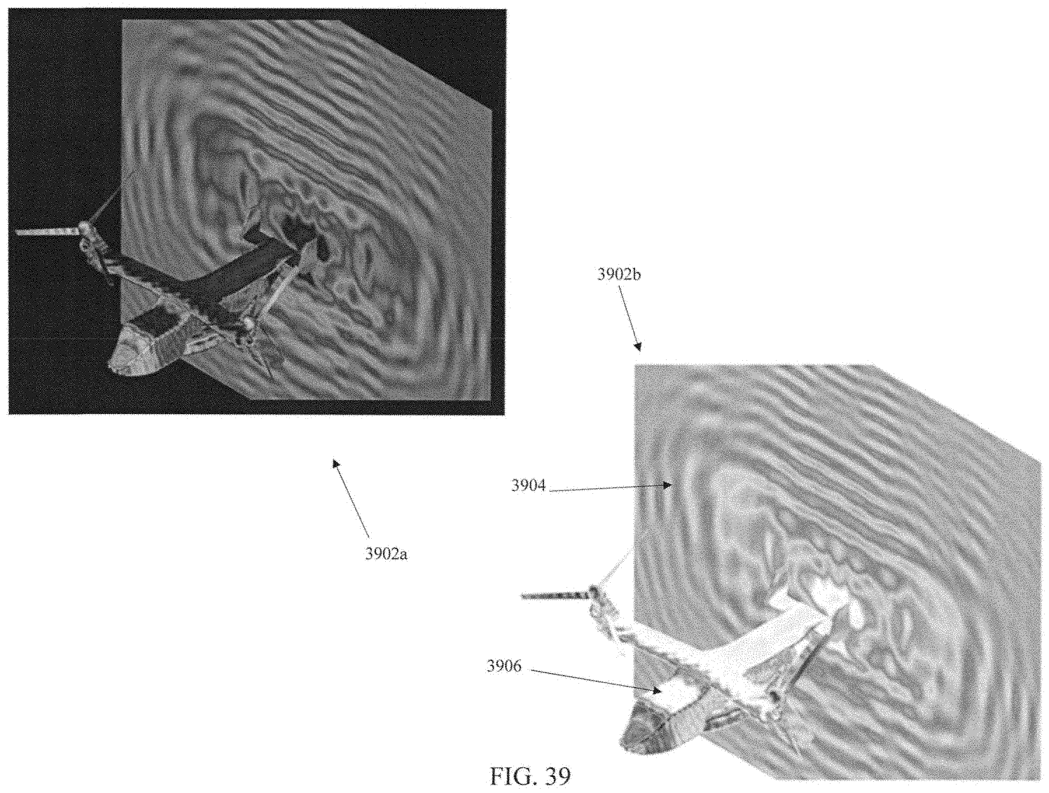

FIG. 39 illustrates an exemplary total EM field 3904 generated as a superposition of a scattered field arising from an incident field scattered by an aircraft 3906 as generated in accordance with this disclosure. Illustrations 3902a and 3902b are shown in normal and inverted color schemes for exemplary purposes as one may color scheme may be reproduced in a better form than another.

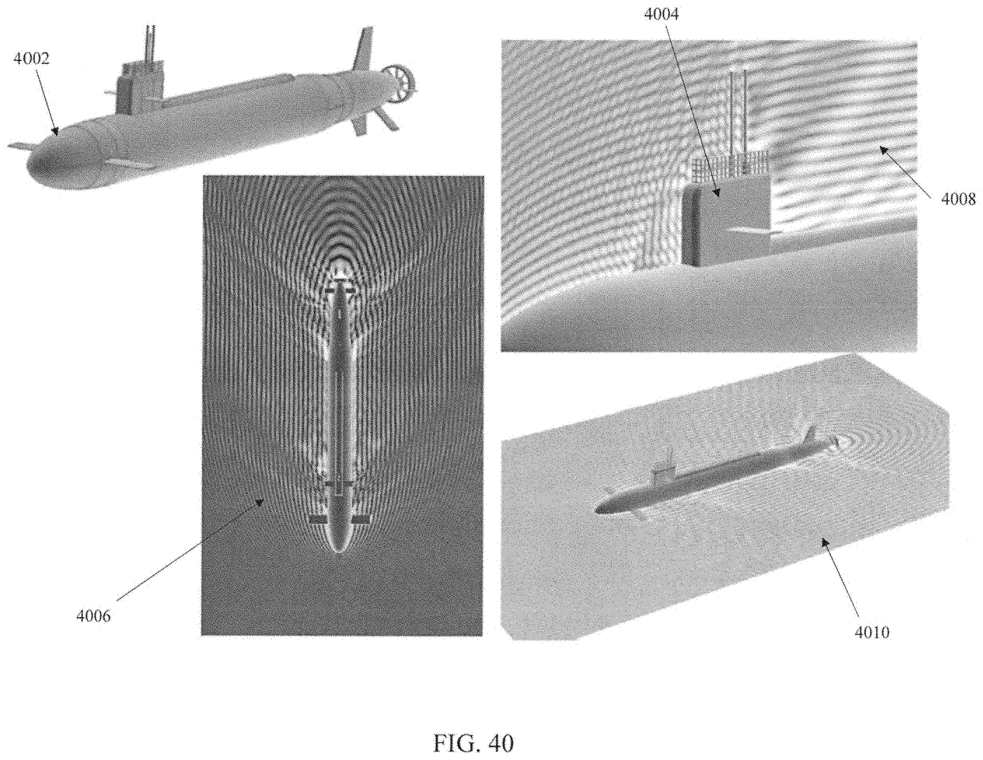

FIG. 40 illustrates an exemplary aspects 4006, 4008, 4010 of a total acoustic field generated as a superposition of a scattered field arising from an incident field scattered by a submarine 4002 and its conning tower 4004 as generated in accordance with this disclosure. Illustrations 3902a and 3902b are shown in normal and inverted color schemes for exemplary purposes as one may color scheme may be reproduced in a better form than another.

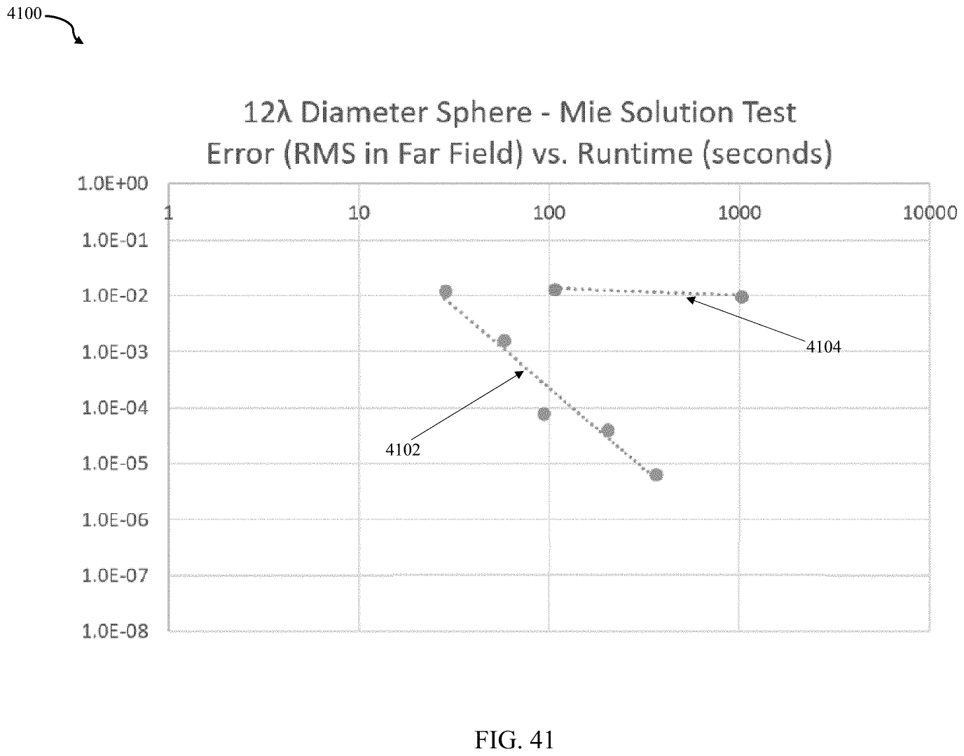

FIGS. 41-43 illustrate comparative statistics obtained running a same simulations in accordance with this disclosure and a leading field simulator. Results 4102, 4202, and 4302 correspond to performance of a simulator in accordance with the present disclosure. Results 4104, 4204, and 4304 correspond to results obtained by a leading simulator on the market. It is readily seen comparing 4102 and 4104 or 4302 and 4304 that simulations in accordance with this disclosure are capable of accuracies orders of magnitude higher than a leading simulator obtained in substantially less time. It is also apparent comparing 4202 and 4204 that simulations in accordance with this disclosure obtain errors orders of magnitude lower than a leading simulator using substantially less memory.

As costs of the non-adjacent interactions (far-patch cases) arises trivially from a double sum, it may be accelerated by means of either an equivalent source scheme or by a fast multipole (FMM) approach. In measuring computational costs, therefore, we focus on singular and near singular cases (i.e. difficult cases). For the purposes of our computing-time estimates, let N denote the maximum of the one dimensional discretization sizes Nᵤ^{q} and Nᵤ^{q} over all patches (1<q<M), and let N′_{close} denote the maximum, over all the patches, of the numbers of points that are close to the patch, but which are not contained in the q^{th} patch. Additionally, let N_{β}^{u}=N_{β}^{v}=N_{β} denote the number of quadrature points used for singular precomputations. With these notations we obtain the following estimates in terms of the bounded integer values N (in the range of one to a few tens); the (large, proportional to the square of the frequency, for large frequencies) number M of patches, and the related bounded parameters N (of the order of one to a few hundreds): cost of precomputations: O(MN_{β}²(N²+N′_{close})) operations; cost of forward map: Chebyshev transform (partial summation): O(MN³); singular and near-singular interactions O(MN²(N²+N′_{close})); non-adjacent interactions O((M−1)²N⁴) (or M^{α}N⁴ with α significantly smaller than two if adequate acceleration algorithms are utilized.

Each patch requires creation and storage of a set of self-interaction weights at a total storage cost of O(MN⁴) double-precision complex-valued numbers. Additional weights also need to be stored for N′_{close} near-singular points for each patch, and are dependent on the target point, then the total storage for the singular and near-singular weights is O(MN⁴+MN²N′_{close}).

In order to eliminate the need to evaluate and store a large number of weights that result as N is increased, it is possible to instead increase the number of patches M which causes the necessary number of weights to grow only linearly. In these regards it is useful to consider the following rule of thumb: in practice, as soon as the wavelength is accurately resolved by the single-patch algorithm, due to the spectral accuracy of Fejér's a first quadrature, only a few additional points per patch are needed to produce accuracies of the order of several digits. In view of the estimates in this and the previous section, parameter selections can easily be made by seeking to optimize the overall computing time given the desired accuracy and available memory.

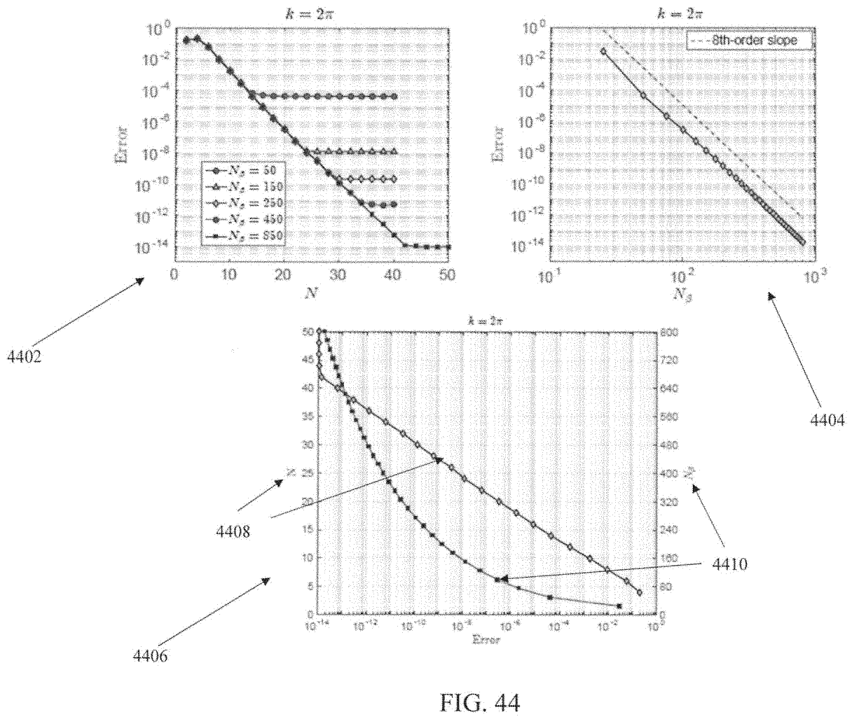

The results illustrated in FIGS. 44-49 were obtained in an embodiment programmed in FORTRAN and parallelized using OpenMP. The runs were performed on a single node of a dual socket Dell R420 with two Intel Xenon E5-2670 v3 2.3 GHz, 128 GB of RAM. Unless otherwise stated all runs were computed using 24 cores. FIG. 44 illustrates certain results of these runs. Plots 4402, 4404, 4406 illustrate convergence results for combined field formulations and demonstrate that the method is capable of obtaining accuracies close to machine precision. Plots 4402, 4404, 4406 show convergence on a forward map of combined field formulations for a unit sphere and wavenumber k=2π. Plot 4402 illustrates error as the number of points per patch per dimension is increased for different values of N_{β}. Plot 4404 illustrates error as a function of N_{β}. And plot 4406 illustrates values of N 4408 and N_{β} 4410 needed to achieve a given error.

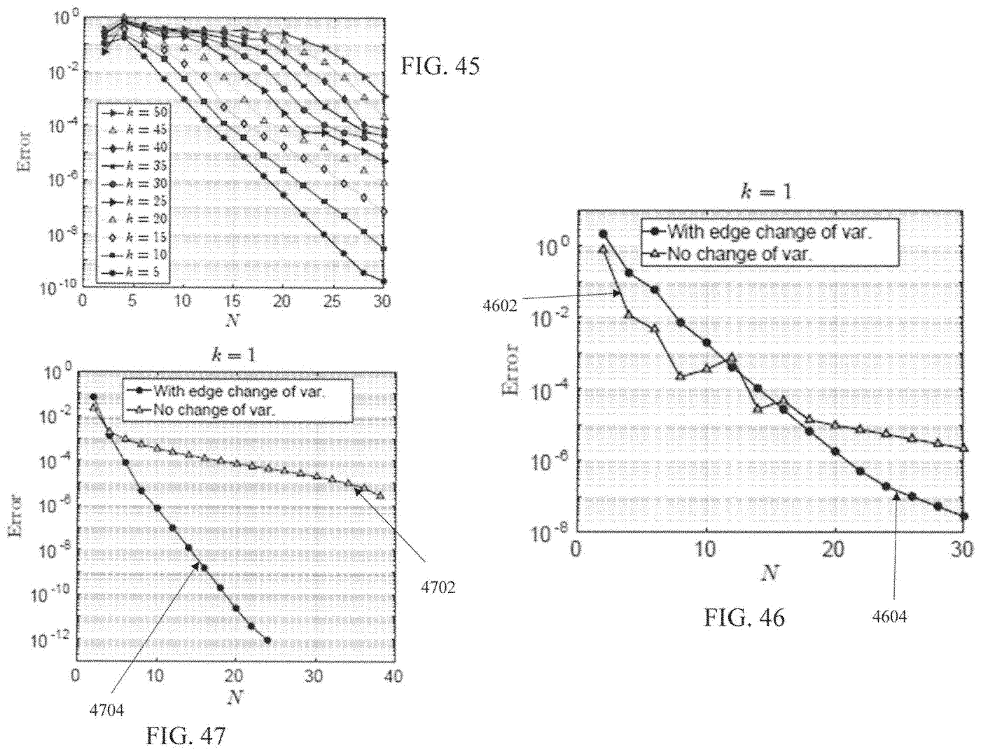

FIG. 45 illustrates error in a forward map of combined field formulations for a unit sphere and for different wavenumbers as a number of points per patch increases, while keeping a number of patches fixed. A value of N_{β}=250 was used to guarantee that error in singular precomputations is less than a wavelength discretization error. FIGS. 46 and 47 illustrate a benefit of an edge deformation change of variables technique in accordance with this disclosure. FIG. 46 shows maximum (absolute) far-field error for a problem of scattering by a cube of size 2×2×2 and with k=1, showing results without use of an edge change of variables (4602) and including an edge deformation with p=2 (4604). FIG. 47 shows maximum value of the far field error for the problem of scattering by a disk of radius 1 and k=1. The plot shows both the curve excluding changes of variables (4702) and including a p=4 change of variables (4704). The maximum value of the far field for the reference solution equals 0.7284.

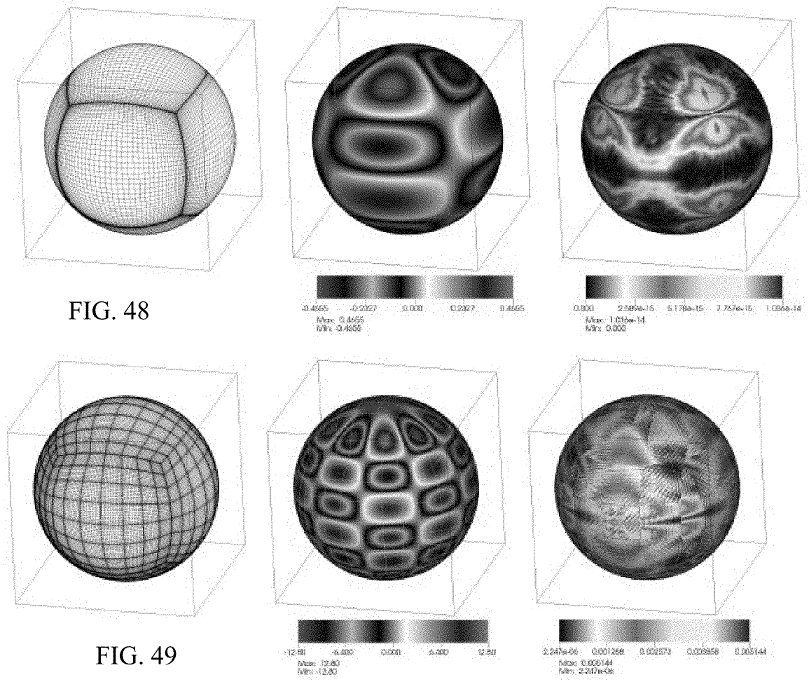

FIG. 48 illustrates from left to right approximation meshes, pointwise error for a spherical harmonic density (5,2) using a mesh of N=50 and N_{β}=850, the error is essentially uniform and accuracies are close to machine precision. FIG. 49 illustrates from left to right approximation meshes, pointwise error for a spherical harmonic density (10,5). FIG. 49 show patch splitting strategy for high frequencies. In FIG. 49, k=100 which corresponds to scattering by a sphere 31.8λ in diameter, and 6×8×8 patches (8×8 subpatches in each one of 6 initial patches with N=14.

Table 1 below is a chart of errors in a forward map (relative to a maximum forward map value) of a combined field operator for various patch splitting configurations and a spherical harmonic density (5,2). For results in Table 1, k=100, a sphere of diameter 31.8λ was used, and at all times reported for precomputations and forward map were obtained using 24 computing cores. At this frequency, N=16 suffices to produce an accuracy of 0.08% on a basis of six 5×5 patches.

| | | | Points | | Time | | Time | | |
|---|---|---|---|---|---|---|---|---|---|
| N | N_{β} | Patches | per λ | Unknowns | (prec.) | | (1 iter.) | | Error |
| 8 | 50 | 6 × 5 × 5 | 1.7 | 9600 | 1.39 | s | 0.18 | s | 71.3% |
| 12 | 60 | 6 × 5 × 5 | 2.6 | 21600 | 3.40 | s | 0.83 | s | 2.16% |
| 16 | 80 | 6 × 5 × 5 | 3.5 | 38400 | 9.26 | s | 2.41 | s | 0.0814% |
| 8 | 50 | 6 × 10 × 10 | 3.5 | 38400 | 16.74 | s | 2.78 | s | 0.336% |
| 12 | 70 | 6 × 10 × 10 | 5.2 | 86400 | 47.26 | s | 13.01 | s | 0.0238% |
| 16 | 90 | 6 × 10 × 10 | 6.9 | 153600 | 126.09 | s | 40.29 | s | 0.000355% |

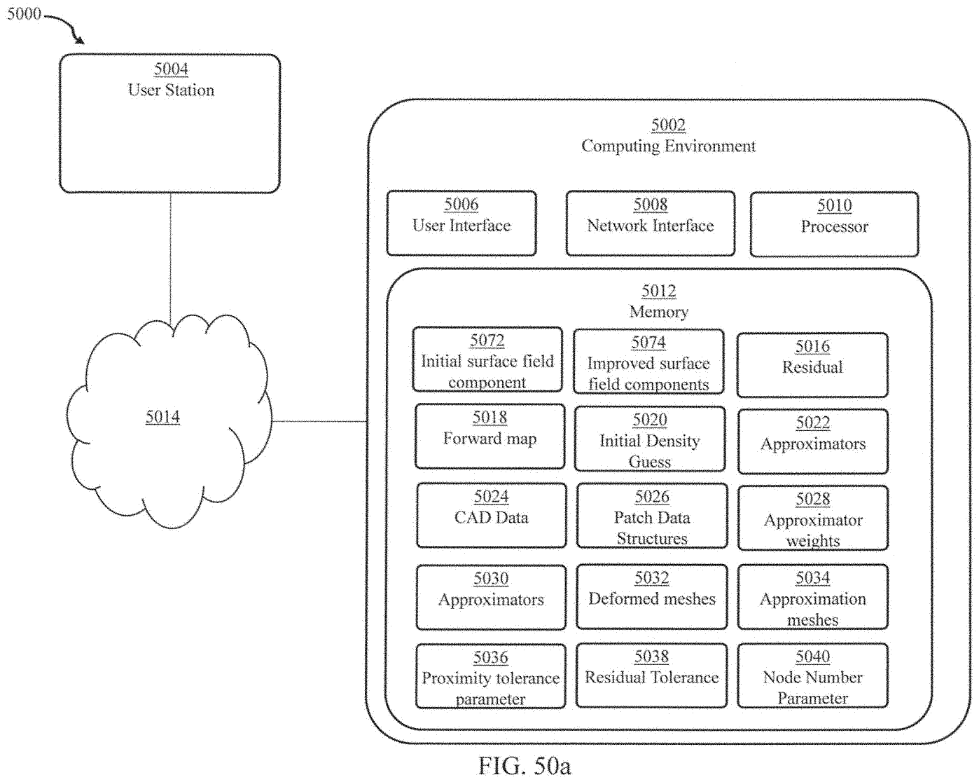

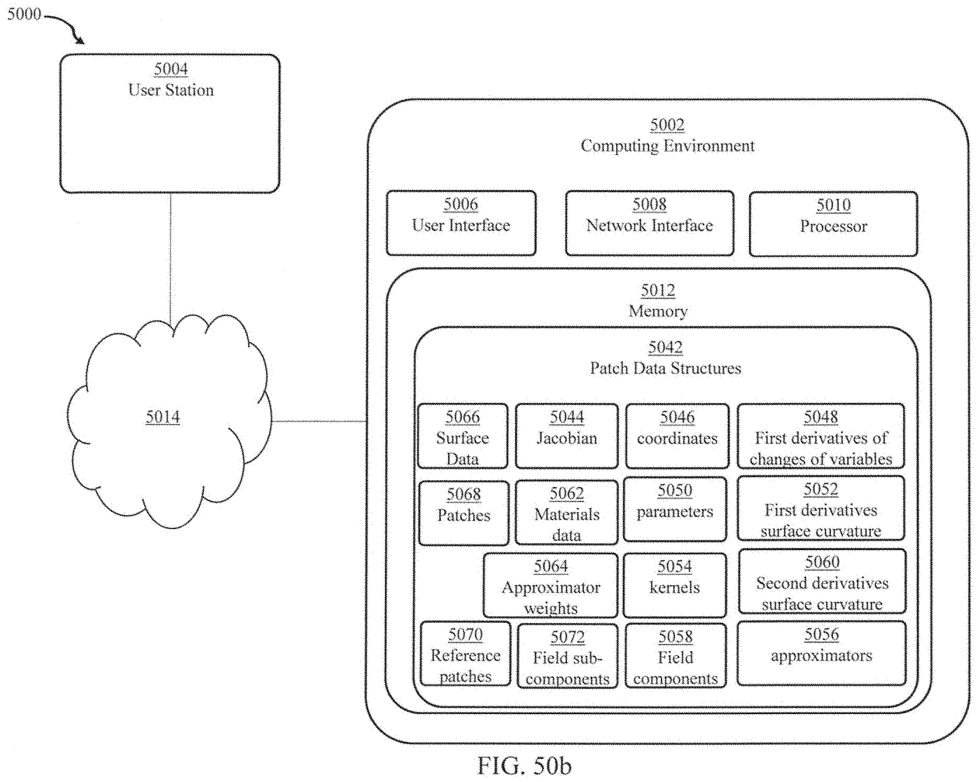

FIGS. 50a and 50b illustrate aspects 5000 of a computing environment in accordance with this disclosure. A computing environment 4902, e.g. a desktop, a server, a mobile device, may be accessed over a network 5014 using a user station 5004 which may be a laptop, a desktop, a mobile device, or the like. Alternatively, a user may use a user interface 5006, which may include a display, a keyboard, a mouse and other various I/O devices as are well known to all humans. A network interface 5008 may provide network connectivity to network 5014. A computing environment 5002 includes one or more processors 5010 coupled to memory 5012 which may include a combination of both transitory or non-transitory memory. One will appreciate that data may move to and from transitory and non-transitory memories on an as needed basis. A memory may store various aspects of a field simulator in accordance with this disclosure. Memory 5012 may store integral operators applied to guesses or approximators 5016, forward maps 5018, initial guesses 5020, approximators 5022, CAD data 4024, patch data structures 5026, approximator weights 5028, approximators 4030, deformed meshes 5032, approximation meshes 5034, proximity parameter values 5036, residual tolerance values 4038, node number parameters 5040, an exemplary patch data structure 5042 includes Jacobian data 5044, coordinates data 5046, first derivatives of changes of variables 5048, first derivatives of surface curvatures 5052, kernels 5054, approximators 5056, field subcomponents 5072 or field components 5058, second derivatives of surface curvatures 5060, materials data 5062, approximator weights 5064, surface data 5066, patch data 5068, reference patches 5070, initial surface field components 5072, and improved surface field components 5074.

1. An apparatus for simulating a physical response of a physical object to an incident field based on a computer-readable representation of the physical object, the apparatus comprising:
one or more processors; and
one or more memories operatively coupled to at least one of the one or more processors and having instructions stored thereon that, when executed by at least one of the one or more processors, cause at least one of the one or more processors to:
access a patch data structure describing a surface of a scattering object, the patch data structure comprising a plurality of logically quadrilateral patches;
parameterize the plurality of logically quadrilateral patches by generating parametrization data for each of the plurality of logically quadrilateral patches, the parametrization data generated at a set of approximation nodes associated with the plurality of logically quadrilateral patches;
generate a set of products of one-dimensional discrete function approximators, each product of one-dimensional discrete function approximators corresponding to an approximation node of the set of approximation nodes;
generate a set of all self-patch field subcomponents based on the set of products;
generate a plurality of vectors based on the parametrization data and a plurality of self-patch surface field subcomponents of the set of all self-patch surface field subcomponents, each of the plurality of vectors describing a respective surface field subcomponent associated with a respective logically quadrilateral patch of the plurality of quadrilateral patches;
generate, based on the plurality of vectors, a scattered field, and
at least one of modifying the computer-readable representation based on the scattered field to obtain an enhanced computer-readable representation having a desired scattered field, wherein a physical object is created or modified in accordance with the enhanced computer-readable representation; or providing the scattered field to a downstream simulator engine configured to perform a simulation based on the scattered field.

2. The apparatus of claim 1, wherein the instructions are further configured to cause the one or more processors to generate a set of all near-patch field subcomponents based on the set of products.

3. The apparatus of claim 2, wherein the instructions are further configured to cause the one or more processors to generate the set of products as a first sub-set of products associated with self-patch deformed nodes and a second sub-set of products associated with near-patch deformed nodes associated with at least one projection node.

4. The apparatus of claim 3, wherein the self-patch deformed nodes are generated by applying a rectangular-polar change of variables to a first subset of the set of approximation nodes associated with self-patch approximation nodes; and the near-patch deformed nodes are generated by applying the rectangular polar change of variables to a second subset of the set of approximation nodes associated with near-patch approximation nodes.

5. (canceled)

6. (canceled)

7. (canceled)

8. (canceled)

9. (canceled)

10. (canceled)

11. (canceled)

12. The apparatus of claim 1, wherein each vector of the plurality of vectors is further based on an acoustic kernel, an electro-magnetic kernel, an elastic kernel, or an electrostatic kernel, further wherein the incident field is an acoustic field, an electro-magnetic field, an elastic field, or an electrostatic field, further wherein the incident field originates from one or more locations located either away from the scattering object or on the surface of the scattering object.

13. (canceled)

14. (canceled)

15. The apparatus of claim 1, wherein the instructions are further configured to cause the one or more processors to access a computer aided design (CAD) file describing the scattering object as a three-dimensional object having a three-dimensional surface; and
generate the patch data structure describing the surface of the scattering object from the CAD file by dividing the three-dimensional surface of the scattering object into the set of logically quadrilateral patches; and
storing the set of logically quadrilateral patches as the patch data structure in memory, wherein causing the at least one processor to parameterize the logically quadrilateral patches includes, for each respective logically quadrilateral patch, generating a respective set of parametrization functions and storing the respective set of parametrization functions in the patch data structure.

16. (canceled)

17. (canceled)

18. (canceled)

19. (canceled)

20. (canceled)

21. (canceled)

22. An apparatus for simulating a physical response of a physical object to an incident field based on a computer-readable representation of the physical object, the apparatus comprising:
one or more processors; and
one or more memories operatively coupled to at least one of the one or more processors and having instructions stored thereon that, when executed by at least one of the one or more processors, cause at least one of the one or more processors to:
access a patch data structure describing a surface of a scattering object, the patch data structure comprising more than one logically quadrilateral patches including a first patch, a second patch, and a third patch;
access an incident field, a residual tolerance parameter, a proximity parameter, and a node numbers parameter;
initialize a first mesh associated with the first patch, a second mesh associated with the second patch, and a third mesh associated with the third patch;
determine, for a first node in the first mesh, that the second patch is a near patch based on the proximity parameter, the first approximation node in the first approximation mesh corresponding to a parametrization of the first point in the first patch;
determine, for the first approximation node in the first mesh, a projection node in the second mesh;
generate a self-patch contribution to a surface field component by at least:
deforming, around the first approximation node in the first mesh, the first mesh by performing a first change of variables to obtain a first deformed mesh;
generate for at least one first deformed node in the first deformed mesh a first respective product of discrete function approximators; and
generate a near-patch contribution to the surface field component by at least:
deforming, around the projection node in the second mesh, the second mesh by performing a second change of variables to obtain a second deformed mesh;
generate for at least one second deformed node in the second deformed mesh a second respective product of discrete function approximators; and
generate a far-patch contribution to the surface field component by integrating over the third patch;
generate a plurality of surface field subcomponent approximation vectors based on the self-patch contribution, the near-patch contribution, and the far patch contribution;
generate a surface field component based at least on surface field subcomponent approximation vectors;
generate, when surface field component satisfies the residual tolerance, a scattered field based on a final density associated with a satisfied residual tolerance; and
store the scattered field in a non-transitory data structure.

23. The apparatus of claim 22, wherein the instructions are further configured to cause the at least one processor to:
generate, when surface field component does not satisfy the residual tolerance, a second surface field component, wherein generating the first surface field component and the second surface field component includes providing, to a linear solver, density approximation vectors and the incident field.

24. (canceled)

25. The apparatus of claim 22, wherein initializing a first mesh associated with the first patch includes storing, in a data structure configured to contain or reference approximation node data, for each approximation node of the first mesh comprising: coordinates, parametrization values, a normal vector, a surface element, a coordinate derivative, a tangential vector, and a determinant.

26. The apparatus of claim 25, wherein the parametrization values are values defined within the first mesh and the second mesh and the third mesh by performing a mapping to a unit square.

27. (canceled)

28. (canceled)

29. The apparatus of claim 28, wherein each approximation node in the first mesh represent the intersection of two orthogonal single dimensional approximation meshes.

30. The apparatus of claim 29, wherein the single dimensional approximation meshes are Chebyshev meshes.

31. The apparatus of claim 29, wherein generating the first mesh includes creating a mesh data structure configured to contain or reference a number of density approximations, each respective density approximation of the number of density approximations associated with a respective one of the approximation nodes in the first mesh, wherein a first surface field component approximation of the number of density approximations is an approximation at the respective approximation node of either (i) a current density or (ii) an acoustic density; and storing the data structure in transitory or non-transitory memory.

32. The apparatus of claim 22, wherein deforming, around the projection node in the second mesh includes performing a rectangular-polar change of variables at a near node, relative to an approximation node in the first mesh, to obtain a rectangular-polar parameter associated with the near node.

33. The apparatus of claim 22, wherein the first change of variables is a rectangular-polar change of variables composed of a first one-dimensional change of variables along a first parametrization direction and a second one-dimensional change of variables along a second parametrization direction.

34. The apparatus of claim 22, wherein the instructions are configured to cause the at least one of the one or more processors to perform, when the first patch lies on an edge of the scattering structure, an edge-smoothing deformation on the first mesh to obtain a edge-deformed first mesh, further wherein deforming, around the first approximation node in the first mesh, the first mesh by performing the first change of variables to obtain a first deformed mesh includes performing the first change of variables on the edge-deformed first mesh.

35. (canceled)

36. (canceled)

37. (canceled)

38. (canceled)

39. (canceled)

40. The apparatus of claim 22, wherein the instructions are configured to cause the at least one of the one or more processors to perform a precompute operation that precomputes every product of one-dimensional discrete function approximators associated with all approximation nodes in the first approximation mesh and all projection nodes of the second approximation mesh.

41. (canceled)

42. (canceled)

43. (canceled)

44. (canceled)

45. (canceled)

46. The apparatus of claim 22, wherein the first mesh is a Chebyshev mesh, and the one-dimensional discrete function approximators are Chebyshev polynomials.

47. (canceled)

48. The apparatus of claim 22, wherein none of the more than one logically quadrilateral patches overlap another logically quadrilateral patches.

49. (canceled)

50. (canceled)

51. (canceled)

52. (canceled)

53. (canceled)

54. A computer implemented method for designing a computer model of a physical object, comprising:
accessing a cad data structure describing a first design of a physical object;
generating a set of reference patches comprising parametrization data, each reference patch of the set of reference patches corresponding to a surface patch of the cad data structure, the parametrization data logically associated with approximation nodes of an approximation mesh;
for an approximation node of the approximation nodes precompute self-patch approximators based on a deformation change of variables;
for an approximation node of the approximation nodes precompute near-patch approximators based on a deformation change of variables;
generate self-patch approximator weights as a product of self-patch approximators and a kernel function and a Jacobian associated with the approximation node;
store the near-patch and the self-patch approximator weights in a memory;
generate an initial surface field component by:
generating an initial density guess;
generating far-patch contributions;
accessing precomputed self-patch approximators and near-patch approximators from the memory;
generate, based on the initial surface field component, an improved surface field component including an improved density;
generate a residual of the improved surface field component based on an incident field; and
generate, when the residual satisfies a residual tolerance parameter, a scattered field simulation of the incident field being scattered by the physical object,
wherein the CAD data structure is modified based on the scattered field simulation to obtain a second design of the physical object.

55. (canceled)

56. (canceled)
